(19) United States
(12) Patent Application Publication
(10) Pub. No.: US 2019/0342606 A1
(43) Pub. Date: Nov. 7, 2019

(54) ELECTRONIC DEVICE AND SYSTEM INCLUDING THE SAME

(71) Applicant: SEMICONDUCTOR ENERGY LABORATORY CO., LTD., Atsugi-shi, Kanagawa-ken (JP)

(72) Inventor: Yoshiyuki KUROKAWA, Sagamihara, Kanagawa (JP)

(21) Appl. No.: 16/349,506

(22) PCT Filed: Nov. 27, 2017
(86) PCT No.: PCT/IB2017/057401

§ 371 Date: May 13, 2019

(30) Foreign Application Priority Data
Dec. 8, 2016 (JP) 2016-238443
Dec. 8, 2016 (JP) 2016-238445

(51) Int. Cl. H04N 21/438; H04N 19/172; H04N 19/423; H04N 19/52

(52) U.S. Cl. CPC H04N 21/4382; H04N 19/52; H04N 19/423; H04N 19/172

(57) ABSTRACT

An electronic device that efficiently compresses a large volume of data included in a broadcast signal and stores the compressed data is to be provided. The broadcast signal is decoded and decompressed through a tuner and a set top box (STB), and a signal (image data) that is decoded and decompressed is inputted to a video display device, so that an image based on the signal is displayed. As a unit for efficiently compressing and storing the image, an electronic device including an encoder, a decoder, and a memory device is used. An image data outputted from the tuner and the STB is compressed using the encoder, and the compressed data is stored in the memory device. To reproduce and display the image data. the compressed image data is decompressed by the decoder, and the decompressed image data is inputted to the video display device. For the compression of the image data in the encoder, an analog processing circuit included in the encoder or a semiconductor device in which a neural network is constructed is used.

### TECHNICAL FIELD

One embodiment of the present invention relates to an electronic device and a system including the electronic device.

Note that one embodiment of the present invention is not limited to the above technical field. The technical field of the invention disclosed in this specification and the like relates to an object, a method, or a manufacturing method. In addition, one embodiment of the present invention relates to a process, a machine, manufacture, or a composition of matter. Specifically, examples of the technical field of one embodiment of the present invention disclosed in this specification include a semiconductor device, a display device, a liquid crystal display device, a light-emitting device, a power storage device, an imaging device, a memory device, a processor, a converter, an encoder, a decoder, a tuner, an electronic device, a method for driving any of them, a method for manufacturing any of them, a method for testing any of them, and a system including any of them.

### BACKGROUND ART

As a screen of a television (TV) becomes larger, it is desired to be able to watch a high-definition image. For this reason, ultra-high definition TV (UHDTV) broadcast has been increasingly put into practical use. Japan, which has promoted UHDTV broadcast, started 4K broadcast services utilizing a communication satellite (CS) and an optical line in 2015. The test broadcast of UHDTV (4K and 8K) by a broadcast satellite (BS) will start in the future. Therefore, various electronic devices which correspond to 8K broadcast are developed (see Non-Patent Document 1). In practical 8K broadcasts, 4K broadcasts and 2K broadcasts (full-high vision broadcast) will be also employed.

A neural network is an information processing system modeled on a biological neural network. A computer having a higher performance than a conventional Neumann computer is expected to be provided by utilizing the neural network, and in these years, a variety of researches on a neural network formed over an electronic circuit have been carried out.

In the neural network, units which resemble neurons are connected to each other through units which resemble synapses. By changing the connection strength, a variety of input patterns are learned, and pattern recognition, associative storage, or the like can be performed at high speed. Furthermore, Non-Patent Document 2 discloses a technique relating to a chip having a self-learning function with the neural network.

### REFERENCE

### Non-Patent Document

[Non-Patent Document 1] S. Kawashima, et al., “13.3-In. 8K×4K 664-ppi OLED Display Using CAAC-OS FETs,” SID 2014 DIGEST, pp. 627-630.
[Non-Patent Document 2] Yutaka Arima et al., “A Self-Learning Neural Network Chip with 125 Neurons and 10K Self-Organization Synapses.” IEEE Journal of Solid-State Circuits, Vol. 26, No. 4, April 1991, pp. 607-611.

### DISCLOSURE OF INVENTION

As a video encoding method in 8K broadcast, a new standard of H.265|MPEG-H high efficiency video coding (HEVC) is employed. The resolution (the number of pixels in the horizontal and perpendicular directions) of an image in 8K broadcast is 7680×4320, which is 4 times and 16 times as high as those in 4K (3840×2160) broadcast and 2K (1920×1080) broadcast, respectively. Thus, a large volume of image data are required to be processed in 8K broadcast.

In order to transmit a large volume of image data for 8K broadcast in a limited broadcast band, compression (encoding) of the image data is important. An encoder enables the compression of image data by intra-frame prediction (acquisition of differential data between adjacent pixels), inter-frame prediction (acquisition of differential data in each pixel between frames), motion-compensated prediction (acquisition of differential data in each pixel between a predicted image of a moving object based on a predicted motion and an actual image of the object based on the actual motion), orthogonal transform (discrete cosine transform), encoding. or the like.

Highly efficient compression of image data is required to transmit broadcast signals in real time. That is, a highly efficient encoder is required to transmit a large volume of image data for 8K broadcast.

To view the 8K broadcast, a dedicated television device is necessary. Furthermore, to record the 8K broadcast, a dedicated memory device is necessary. In particular, when the 8K broadcast is recorded with a configuration in which image data that is decompressed (decoded) is stored in the memory device, a large volume of image data is processed, and accordingly a large amount of memory capacitance is needed. Moreover, even in a configuration in which image data that is compressed (encoded, i.e., not decoded) is stored in the memory device, there may be a large amount of data when encoding is insufficiently performed. Also in this case, a memory device with a large amount of memory capacitance is needed.

An object of one embodiment of the present invention is to provide a novel electronic device. Another object of one embodiment of the present invention is to provide a system including a novel electronic device.

Another object of one embodiment of the present invention is to provide a system in which a large volume of data is compressed and recorded. Another object of one embodiment of the present invention is to provide a method for compressing a large volume of data to record the data.

Note that the objects of one embodiment of the present invention are not limited to the above objects. The objects described above do not disturb the existence of other objects. The other objects are the ones that are not described above and will be described below. The other objects will be apparent from and can be derived from the description of the specification, the drawings, and the like by those skilled in the art. One embodiment of the present invention achieves at least one of the above objects and the other objects. One embodiment of the present invention does not necessarily achieve all the above objects and the other objects.

(1)

One embodiment of the present invention is an electronic device including an encoder and a memory device where the encoder is configured to receive an image data. where the image data includes a first frame image and a second frame image, where the first frame image includes a first region, and where the second frame image includes a second region. The encoder is configured to generate a first current on the basis of the first region, to generate a second current on the basis of the second region, to generate a differential current between the first current and the second current, to determine whether the first region and the second region match, are similar to, or mismatch each other on the basis of the differential current, to obtain a vector quantity between the first region and the second region when the first region and the second region match or are similar to each other, and to perform a motion-compensated prediction processing on the image data with use of the vector quantity to generate a compressed image data. The memory device is configured to store the compressed image data.

(2)

Another embodiment of the present invention is the electronic device according to (1), where the encoder includes a memory cell, a first circuit, a second circuit, and a first wiring. The memory cell is electrically connected to the first wiring. The first circuit is electrically connected to the first wiring. The second circuit is electrically connected to the first wiring. The first circuit is configured to supply a first current based on the first region to the first wiring and to supply a second current based on the second region to the first wiring. The memory cell is configured to hold a charge corresponding to the first current and to determine the first current flowing from the first wiring to the memory cell as a constant current on the basis of the amount of the charge held. The second current is configured to generate a differential current between the constant current and the second current.

(3)

Another embodiment of the present invention is the electronic device according to (2), where the memory cell includes a first transistor, a second transistor, a third transistor, and a capacitor. One of a source and a drain of the first transistor is electrically connected to one of a source and a drain of the second transistor and one of a source and a drain of the third transistor. The other of the source and the drain of the first transistor is electrically connected to a first electrode of the capacitor. A gate of the first transistor is electrically connected to the other of the source and the drain of the third transistor and a second electrode of the capacitor. The other of the source and the drain of the second transistor is electrically connected to the first wiring.

(4)

Another embodiment of the present invention is the electronic device according to (3). where at least one of the first to third transistors includes an oxide semiconductor in a channel formation region.

(5)

Another embodiment of the present invention is the electronic device according to (3) or (4), where the second circuit includes a fourth transistor, a fifth transistor, a sixth transistor. One of a source and a drain of the fourth transistor is electrically connected to one of a source and a drain of the fifth transistor, one of a source and a drain of the sixth transistor, and a gate of the sixth transistor. The other of the source and the drain of the fourth transistor is electrically connected to the first wiring. The other of the source and the drain of the fifth transistor is electrically connected to the gate of the fifth transistor.

(6)

Another embodiment of the present invention is the electronic device according to (5). where the second circuit includes a seventh transistor, an eighth transistor, a ninth transistor, a tenth transistor, an eleventh transistor, a first comparator, a second comparator, and a first current mirror circuit. A non-inverting input terminal of the first comparator is electrically connected to the other of the source and the drain of the fifth transistor and one of a source and a drain of the seventh transistor. An output terminal of the first comparator is electrically connected to a gate of the seventh transistor and a gate of the eighth transistor. One of a source and a drain of the eighth transistor is electrically connected to an output terminal of the first current mirror circuit and one of a source and a drain of the eleventh transistor. A non-inverting input terminal of the second comparator is electrically connected to the other source and the drain of the sixth transistor and one of a source and a drain of the ninth transistor. An output terminal of the second comparator is electrically connected to a gate of the ninth transistor and a gate of the tenth transistor. One of a source and a drain of the tenth transistor is electrically connected to an input terminal of the first current mirror circuit. The seventh transistor and the eighth transistor are p-channel transistors. The ninth transistor, the tenth transistor, and the eleventh transistor are n-channel transistors.

(7)

Another embodiment of the present invention is the electronic device according to (5), where the second circuit includes a seventh transistor, an eighth transistor, a ninth transistor, a tenth transistor, an eleventh transistor, a first comparator, a second comparator, and a first current mirror circuit. A non-inverting input terminal of the first comparator is electrically connected to the other of the source and the drain of the fifth transistor and one of a source and a drain of the seventh transistor. An output terminal of the first comparator is electrically connected to a gate of the seventh transistor and a gate of the eighth transistor. A non-inverting input terminal of the second comparator is electrically connected to the other of the source and the drain of the sixth transistor and one of a source and a drain of the ninth transistor. An output terminal of the second comparator is electrically connected to a gate of the ninth transistor and a gate of the tenth transistor. One of a source and a drain of the tenth transistor is electrically connected to an output terminal of the first current mirror circuit and one of a source and a drain of the eleventh transistor. One of a source and a drain of the eighth transistor is electrically connected to an input terminal of the first current mirror circuit. The seventh transistor and the eighth transistor are p-channel transistors. The ninth transistor, the tenth transistor, and the eleventh transistor are n-channel transistors.

(8)

Another embodiment of the present invention is the electronic device according to any one of (2) to (7), where the first current includes a twelfth transistor, a second current mirror circuit, and a second wiring. An input terminal of the second current mirror circuit is electrically connected to one of a source and a drain of the twelfth transistor. An output terminal of the second current mirror circuit is electrically connected to the first wiring. A gate of the twelfth transistor is electrically connected to the second wiring. A potential based on the first region or the second region is inputted to the second wiring.

(9)

Another embodiment of the present invention is an electronic device including an encoder and a memory device. The encoder is configured to receive an image data. The image data includes a first frame image and a second frame image. The first frame image includes a first region, and the second frame image includes a second region. The encoder includes a semiconductor device where a neural network is formed. The neural network is configured to determine whether the first region and the second region match, are similar to, or mismatch each other. The encoder is configured to obtain a vector quantity between the first region and the second region when the first region and the second region match or are similar to each other, and to perform a motion-compensated prediction processing on the image data with use of the vector quantity to generate a compressed image data. The memory device is configured to store the compressed image data.

(10)

Another embodiment of the present invention is the electronic device according to (9), where the semiconductor device includes a first circuit, a second circuit, a third circuit, and a fourth circuit. The first circuit includes a first charge pump circuit, a second charge pump circuit, an analog memory, and a logic circuit. Each of the first charge pump circuit and the second charge pump circuit includes a first transistor. The first transistor includes an oxide semiconductor in a channel formation region. The logic circuit includes a first input terminal, a second input terminal, a first output terminal, and a second output terminal. The second circuit includes a third input terminal and a third output terminal. The second circuit is configured to output one of a potential corresponding to a current inputted to the third input terminal and a first input potential to the third output terminal. The third circuit includes a fourth input terminal and a fourth output terminal. The third circuit is configured to output one of a potential corresponding to a current inputted to the fourth input terminal and a second input potential to the fourth output terminal. The fourth circuit includes a fifth input terminal, a sixth input terminal, and a fifth output terminal. The fourth circuit is configured to output a current corresponding to a potential inputted to the fifth input terminal and a current corresponding to a potential inputted to the sixth input terminal to the fifth output terminal. The first input terminal is electrically connected to the fifth input terminal and the third output terminal. The second input terminal is electrically connected to the fourth output terminal. The first output terminal is electrically connected to the first charge pump circuit. The second output terminal is electrically connected to the second charge pump circuit. The analog memory is electrically connected to the first charge pump circuit, the second charge pump circuit, and a sixth input terminal. The fifth output terminal is electrically connected to the fourth input terminal.

(11)

Another embodiment of the present invention is the electronic device according to (10), where the fourth circuit includes a second transistor, a third transistor, a fourth transistor, a fifth transistor, and an inverter. A first terminal of the second transistor is electrically connected to a first terminal of the third transistor. A first terminal of the fourth transistor is electrically connected to a first terminal of the fifth transistor. A gate of the fifth transistor is electrically connected to an output terminal of the inverter. A gate of the third transistor is electrically connected to an input terminal of the inverter and the fifth input terminal. A gate of the fourth transistor is electrically connected to the sixth input terminal.

(12)

Another embodiment of the present invention is the electronic device according to (10) or (11), further including a fifth circuit. The fifth circuit includes a seventh input terminal, an eighth input terminal, and a sixth output terminal. The fifth circuit is configured to output a current corresponding to a potential inputted to the seventh input terminal and a current corresponding to a potential inputted to the eighth input terminal to the sixth output terminal. The seventh input terminal is electrically connected to the second input terminal and the fourth output terminal. The eighth input terminal is electrically connected to the sixth input terminal and the analog memory. The sixth output terminal is electrically connected to the third input terminal.

(13)

Another embodiment of the present invention is the electronic device according to any one of (10) to (12), where the second circuit includes a resistor, a comparator, a flip-flop circuit, and a selector. An output terminal of the flip-flop circuit is electrically connected to a first terminal of the selector. A non-inverting input terminal of the comparator is electrically connected to the resistor and the third input terminal. An output terminal of the comparator is electrically connected to a second terminal of the selector. An output terminal of the selector is electrically connected to the third output terminal.

(14)

Another embodiment of the present invention is the electronic device according to any one of (10) to (13), where the first transistor includes a back gate.

(15)

Another embodiment of the present invention is the electronic device according to any one of (10) to (14), further including a sixth transistor. A first terminal of the sixth transistor is electrically connected to the analog memory.

(16)

Another embodiment of the present invention is the electronic device according to any one of (1) to (15), further including a video display portion.

(17)

Another embodiment of the present invention is the electronic device according to (16), where the video display portion includes a first display region and a second display region. The first display region includes a reflective element, and the second display region includes a light-emitting element.

(18)

Another embodiment of the present invention is a system including the electronic device according to any one of (1) to (17), which includes an antenna, a tuner, and a set top box. The antenna is electrically connected to the tuner. The tuner is electrically connected to the set top box. The set top box is electrically connected to the electronic device. The antenna is configured to receive an airwave and convert the airwave into an electrical signal. The tuner is configured to demodulate a broadcast signal included in the electrical signal. The set top box is configured to decode and decompress an image data included in the broadcast signal and to transmit the image data to the electronic device.

According to one embodiment of the present invention, a novel electronic device can be provided. According to another embodiment of the present invention, a system including a novel electronic device can be provided.

According to another embodiment of the present invention, a system in which a large volume of data is compressed and recorded can be provided. According to another embodiment of the present invention, a method for compressing a large volume of data and recoding the data can be provided.

Note that the effects of one embodiment of the present invention are not limited to the above effects. The effects described above do not disturb the existence of other effects. The other effects are the ones that are not described above and will be described below. The other effects will be apparent from and can be derived from the description of the specification, the drawings, and the like by those skilled in the art. One embodiment of the present invention has at least one of the above effects and the other effects. Accordingly, one embodiment of the present invention does not have the aforementioned effects in some cases.

### BRIEF DESCRIPTION OF DRAWINGS

FIG. 1 is a block diagram illustrating a configuration example of an electronic device.

FIG. 2 is a block diagram illustrating a configuration example of an electronic device.

FIG. 3 is a block diagram illustrating an operation example of an electronic device.

FIG. 4 is a block diagram illustrating an operation example of an electronic device.

FIGS. 5A to 5F illustrate operation examples of the detection of motion.

FIG. 6 is a block diagram illustrating an example of a semiconductor device.

FIGS. 7A to 7D each illustrate an example of a circuit in a semiconductor device.

FIG. 8 illustrates an example of a circuit in a semiconductor device.

FIG. 9 illustrates an example of a circuit in a semiconductor device.

FIG. 10A is a flow chart showing operation of a semiconductor device, and FIGS. 10B and 10C are diagrams for supplemental explanation of the flow chart in FIG. 10A.

FIG. 11 is a timing chart showing operation of a semiconductor device.

FIG. 12 illustrates an example of a semiconductor device.

FIG. 13 illustrates an example of a semiconductor device.

FIG. 14 illustrates an example of a circuit in a semiconductor device.

FIG. 15 illustrates an example of a circuit in a semiconductor device.

FIG. 16 illustrates an example of a circuit in a semiconductor device.

FIG. 17 illustrates an example of a circuit in a semiconductor device.

FIG. 18 illustrates an example of a circuit in a semiconductor device.

FIG. 19 illustrates an example of a circuit in a semiconductor device.

FIG. 20 illustrates an example of a circuit in a semiconductor device.

FIG. 21 is a flow chart showing an operation example of a semiconductor device.

FIG. 22 is a flow chart showing an operation example of a semiconductor device.

FIG. 23 is a flow chart showing an operation example of a semiconductor device.

FIGS. 24A to 24C each illustrate a connection example of an electronic device and a peripheral device.

FIGS. 25A to 25C each illustrate a connection example of an electronic device and a peripheral device.

FIG. 26 is a block diagram illustrating a configuration example of an electronic device.

FIGS. 27A1, 27A2, 27B1, 27B2, 27C1. and 27C2 illustrate the processing of images displayed on a display region.

FIGS. 28A to 28D are schematic views illustrating structure examples of a display device.

FIGS. 29A to 29D are circuit diagrams and timing charts illustrating a structure example of a display device.

FIGS. 30A and 30B are perspective views illustrating an example of a display device.

FIGS. 31A and 31B illustrate a structure example of a pixel and light-transmitting and light-blocking portions of a pixel.

FIG. 32 is a cross-sectional view illustrating a structure example of a display device.

FIG. 33 is a cross-sectional view illustrating a structure example of a display device.

FIG. 34 is a cross-sectional view illustrating a structure example of a display device.

FIG. 35 illustrates a circuit configuration example ofa pixel.

FIG. 36 illustrates a circuit configuration example ofa pixel.

FIGS. 37A1, 37A2, and 37B are top views and a cross-sectional view illustrating a structure example of a pixel.

FIGS. 38A1, 38A2, and 38B are top views and a cross-sectional view illustrating a structure example of a pixel.

FIGS. 39A to 39C are a top view and cross-sectional views illustrating a structure example of a transistor.

FIGS. 40A to 40C are a top view and cross-sectional views illustrating a structure example of a transistor.

FIGS. 41A to 41C are a top view and cross-sectional views illustrating a structure example of a transistor.

FIGS. 42A and 42B are a circuit diagram illustrating a configuration example of a touch sensor unit and a top view illustrating an example of the appearance of the touch sensor unit.

### BEST MODE FOR CARRYING OUT THE INVENTION

In this specification and the like, a metal oxide means an oxide of metal in a broad sense. Metal oxides are classified into an oxide insulator, an oxide conductor (including a transparent oxide conductor), an oxide semiconductor (also simply referred to as an OS), and the like. For example, a metal oxide used in an active layer of a transistor is called an oxide semiconductor in some cases. That is to say, when a metal oxide is included in a channel formation region of a transistor that has at least one of an amplifying function, a rectifying function, and a switching function, the metal oxide can be called a metal oxide semiconductor, or OS for short. An OS FET (or an OS transistor) refers to a transistor including a metal oxide or an oxide semiconductor.

### Embodiment 1

In this embodiment, a structure of an electronic device of one embodiment of the present invention and structures of an encoder and a decoder included in the electronic device will be described.

<Electronic Device>

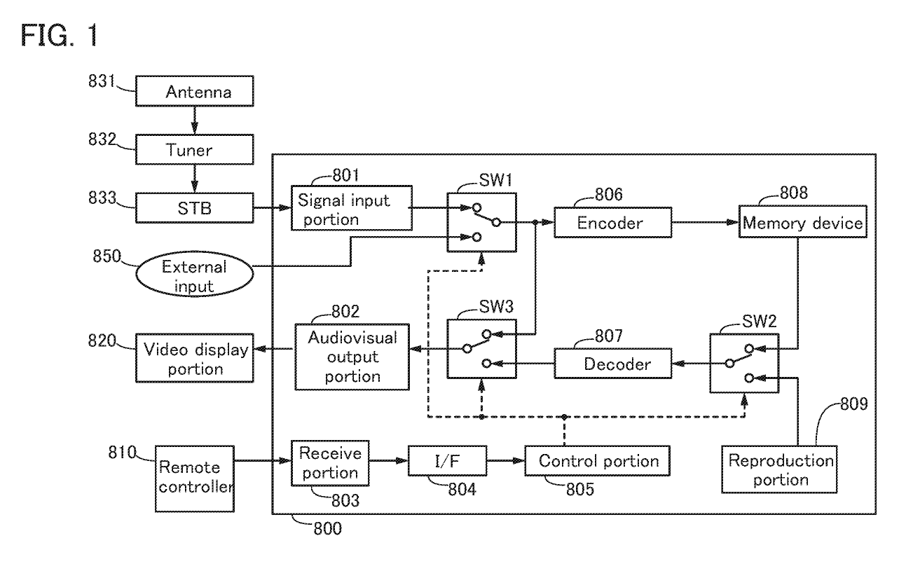

FIG. 1 shows a configuration example of an electronic device capable of recording 8K broadcast and its peripheral devices. An electronic device 800 includes a signal input portion 801, an audiovisual output portion 802, a receive portion 803, an interface (I/F) 804, a control portion 805, an encoder 806, a decoder 807, a memory device 808, a reproduction portion 809, and switches SW1 to SW3. Furthermore, this configuration example includes a remote controller 810, a video display portion 820, an antenna 831, a tuner 832, and a set top box (STB) 833 as peripheral devices of the electronic device 800.

The antenna 831 is electrically connected to the signal input portion 801 in the electronic device 800 via the tuner 832 and the STB 833. The video display portion 820 is electrically connected to the audiovisual output portion 802 in the electronic device 800. The remote controller 810 has a function of transmitting an infrared ray or a control signal such as an electric wave to the receive portion 803 in the electronic device 800.

The antenna 831 has a function of receiving airwaves from a satellite or a radio tower and converting the airwaves into an electric signal. The antenna 831 also has a function of transmitting the electric signal to the tuner.

The tuner 832 has a function of extracting a signal of a channel included in the electric signal and demodulating the signal to be a broadcast signal. In addition, the tuner 832 has a function of transmitting the broadcast signal to the STB 833.

The STB 833 has a function of converting the broadcast signal into data that can be viewed on the video display portion 820. For example, in the case where image data and audio data in the broadcast signal are compressed and encoded, the STB 833 decodes and decompresses the image data and the audio data. For example, in the case where a signal of a channel extracted by the tuner 832 is data broadcasting, the STB 833 adds data associated with a program a viewer is watching, besides the image data and the audio data. Examples of associated data include, in the case where the viewer is watching a news program, subtitles and figures informing the viewer of a weather forecast, an earthquake warning, or the like. Other examples of associated data include, in the case where the viewer is watching a quiz program in which the audience participates, questions and answer choices. The data converted by the STB 833 (the data is referred to as first data) is transmitted to the signal input portion 801 in the electronic device 800.

The signal input portion 801 has a function of receiving the first data transmitted from the STB 833. In other words, the signal input portion 801 functions as an interface for receiving the broadcast signal. Moreover, the signal input portion 801 has a function of transmitting the broadcast signal to a first input terminal of the switch SW1 in the electronic device 800.

Note that the electronic device 800 may deal with signals other than the airwaves received by the antenna 831. For example, signals of a cable broadcast or external media as an external input 850 are received, and image data and audio data of the signals are outputted to the video display portion 820 via the electronic device 800. The data inputted as the external input 850 (the data is referred to as second data) is transmitted to a second input terminal of the switch SW1 in the electronic device 800.

The switch SW1 has a function of making the output terminal electrically connected to one of the first input terminal and the second input terminal, on the basis of a control signal from the control portion 805. In other words, in the switch SW1, one of the first data and the second data is selected and outputted to the output terminal. The output terminal of the switch SW1 is electrically connected to the encoder 806 and a first input terminal of the switch SW3.

In the case where the first data or the second data is stored (recorded), the first or second data outputted from the output terminal of the switch SW1 is compressed by the encoder 806. The first and second data whose volumes are reduced by compression are referred to as first and second compressed data, respectively. The encoder 806 transmits the first or second compressed data to the memory device 808.

For the compression by the encoder 806, it is preferable to use a semiconductor device for the motion detection, which is described later.

Furthermore, the encoder 806 is preferably provided with a memory device that temporarily stores the broadcast signal. Unlike the compression performed before transmission of a broadcast signal from a satellite, a radio tower, or the like, which requires real-time processing, the compression in the encoder 806 can be performed while the broadcast signal is temporarily stored in a memory device for temporarily storing the broadcast signal when such a memory device is provided for the encoder 806. Thus, the encoder 806 can take time to perform the compression, so that the detection of motion, the inter-frame prediction, or the like can be conducted with high accuracy in some cases. Note that the encoder 806 will be described in detail later.

The memory device 808 has a function of storing the first compressed data and the second compressed data. Furthermore, the memory device 808 has a function of reading out the first or second compressed data to input the data to a first input terminal of the switch SW2. The first and second compressed data readout from the memory device 808 are referred to as first and second read data. respectively.

Examples of the memory device 808 include a hard disk drive (HDD) and a solid state drive (SSD). The memory device 808 may be a writing device for storage media, and examples of storage media include an optical disk and a video tape.

The reproduction portion 809 is a reading device for storage media and has a function of reading out the image data and audio data which have been compressed and stored in the storage media. The compressed image and audio data which are read out from the storage media are referred to as third read data. The reproduction portion 809 has a function of inputting the third read data to a second input terminal of the switch SW2. For specific examples of the storage media, the description of the memory device 808 is referred to.

The switch SW2 has a function of making an output terminal electrically connected to one of the first input terminal and the second input terminal, on the basis of a control signal from the control portion 805. In other words, the switch SW2 selects one of the data read out from the memory device 808 (the first or second read data) and the third read data read out from the storage media by the reproduction portion 809 and outputs the selected data to the output terminal. The output terminal of the switch SW2 is electrically connected to the decoder 807.

The compressed data (one of the first read data, the second read data, and the third read data) outputted from the output terminal from the switch SW2 is inputted to the decoder 807. The decoder 807 has a function of decoding and decompressing the compressed data. The first to third read data that are decoded and decompressed are respectively referred to as first to third internal reproduction data. The decoder 807 transmits the first to third internal reproduction data to a second input terminal of the switch SW3. Note that the decoder 807 will be later described in detail.

The switch SW3 has a function of making the output terminal electrically connected to one of the first input terminal and the second input terminal, on the basis of a control signal from the control portion 805. In other words, the switch SW3 selects one of the data of the broadcast signal from the outside (the first or second data) and the reproduction data read out from the inside (the first to third internal reproduction data) and then outputs the selected data to the output terminal. Note that the output terminal of the switch SW3 is electrically connected to the audiovisual output portion 802.

The audiovisual output portion 802 has a function of receiving one of data transmitted from the switch SW3. The data from the switch SW3 corresponds to data of the broadcast signal from the outside (the first or second data) or the reproduction data read out from the inside (the first to third internal reproduction data). In addition, the audiovisual output portion 802 has a function of transmitting the received data to the video display portion 820.

The video display portion 820 has a function of displaying the image data visually and reproducing the audio data, on the basis of the data of the broadcast signal from the outside (the first or second data) or the reproduction data read out from the inside (the first to third internal reproduction data). Examples of the video display portion 820 include electronic devices including a display device, specifically, a television device, a display, a personal computer (such as a desktop computer, a notebook computer or a tablet computer), and a portable information terminal such as a mobile phone or a smartphone. In particular, the above-described electronic device preferably has high definition, for example, 8K. 4K. or the like. A method for outputting the data of a broadcast signal from the outside (the first or second data) or the reproduction data read out from the inside (the first to third internal reproduction data) is not limited to that illustrated in the configuration in FIG. 1. For example, the image data may be transmitted to the above-described electronic device, and the audio data may be transmitted to another electronic device, for example, a speaker or the like.

For operation of the electronic device 800 by a user, the remote controller 810 can be used. The operation by a user enables the remote controller 810 to transmit a control signal to the electronic device 800. The control signal indicates, for example, a signal that selects data outputted through the audiovisual output portion. Here, the outputted data corresponds to the data of a broadcast signal from the outside (the first or second data) or the reproduction data read out from the inside (the first to third internal reproduction data). Alternatively, the control signal indicates, for example, a signal that stores the data of a broadcast signal from the outside (the first or second data). Alternatively, the control signal indicates, for example, a signal that conducts reproduction, rewind, fast-forward, and stop of data when the data indicates the reproduction data read out from the inside (the first to third internal reproduction data). As described above, examples of the control signal transmitted from the remote controller 810 include an infrared ray and an electric wave.

A method of operation of the electronic device 800 by a user is not limited to that illustrated in the configuration in FIG. 1. For example, a configuration which enables a user to operate the electronic device 800 directly with an input key or the like provided for the electronic device 800 may be employed.

The receive portion 803 included in the electronic device 800 has a function of receiving a control signal from the remote controller 810. The receive portion 803 which receives the control signal has a function of transmitting the control signal to the I/F 804.

The I/F 804 has a function of converting the control signal into an electric signal and transmitting the signal to the control portion 805.

The control portion 805 has a function of decrypting the electric signal transmitted from the I/F 804 and operating the switches SW1 to SW3 on the basis of the electric signal. In other words, the control portion 805 can select data outputted through the audiovisual output portion 802 or record the data of a broadcast signal from the outside. Furthermore, in the case where the reproduction data read out from the inside (the first to third internal reproduction data) is outputted through the audiovisual output portion 802, the control portion 805 may have a function of controlling the operation such as the reproduction, rewind, fast-forward, and stop of the reproduction data.

Although the above-described configuration of the electronic device 800 is described as an example of electronic devices, one embodiment of the present invention is not limited to the above configuration. Depending on circumstances or conditions, the components of the electronic device 800 or the connection between the components can be changed as appropriate. For example, the STB 833 may be included in the tuner 832. Alternatively, instead of being provided inside the electronic device 800, the memory device 808 may be provided separately as an external device.

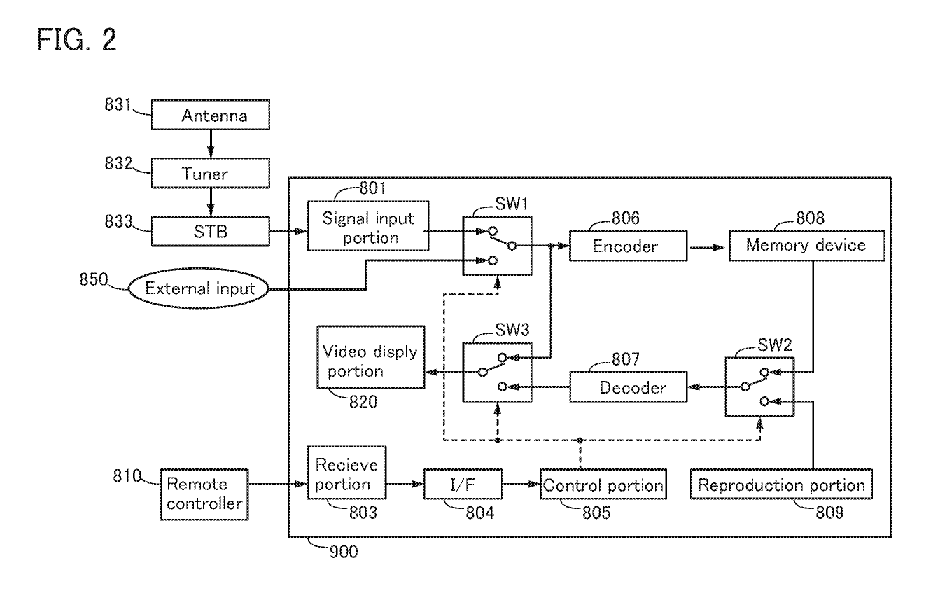

For example, an electronic device of one embodiment of the present invention may have a function of displaying an image and recording the image. FIG. 2 illustrates a configuration example of such a case. An electronic device 900 corresponds to a display device enabling the recording of the 8K broadcast. A difference from the electronic device 800 illustrated in FIG. 1 is that the audiovisual output portion 802 is not provided for the electronic device and the video display portion 820 is provided inside the electronic device. In other words, with use of the electronic device 900 illustrated in FIG. 2, an electronic device having a recoding function and a display device can be integrated.

<Encoder>

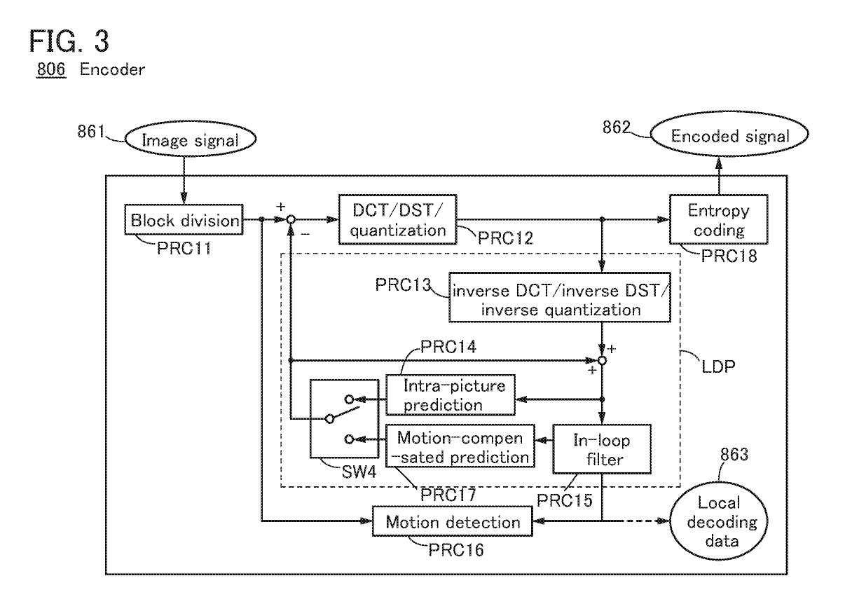

FIG. 3 is a block diagram illustrating the processing performed in the encoder 806 and the processing order.

The encoder 806 includes the following processing: block division PRC 11, DCT (discrete cosine transform)/DST (discrete sine transform)/quantization PRC 12, motion detection PRC 16, entropy coding PRC 18, and local decoding processing LDP. The local decoding processing LDP includes the following processing: inverse DCT/inverse DST/inverse quantization PRC 13, intra-picture prediction PRC 14, in-loop filter PRC 15, and motion-compensated prediction PRC 17. Furthermore, the encoder 806 includes a switch SW4, and the switch SW4 has a function of selecting one from two inputs depending on the content of processing and outputting the selected one.

In the encoder 806, the above processing is performed on an inputted image signal 861 to generate an encoded signal 862 and local decoded data 863. The encoding by the encoder 806 is specifically described below:

In the block division PRC 11, the image signal 861 inputted to the encoder 806 is divided, whereby block data is generated. Here the image signal 861 corresponds to the data of a broadcast signal from the outside (the first or second data). The block data functions as unit data for compression.

In the DCT/DST/quantization PRC 12, orthogonal transform such as discrete cosine transform or discrete sine transform is performed on the block data divided in the block division PRC 11. In addition, in the DCT/DST/quantization PRC 12, quantized data is generated on the basis of the block data on which the orthogonal transform is performed. The quantized data is data of discrete pixel values (for example, luminance or the like) included in the block data on which the orthogonal transform is performed.

In the entropy coding PRC 18, entropy coding is performed on the quantized data generated in the DCT/DST/quantization PRC 12 to generate the encoded signal 862. The entropy coding indicates processing for eliminating the redundancy using statistical properties. The encoded signal 862 generated in this processing corresponds to the first compressed data or the second compressed data described above.

After the entropy coding PRC 18 is performed, a difference between the block data and the local decoding data 863 subjected to the local decoding processing LDP is obtained, and the DCT/DST/quantization PRC 12 is performed on the difference, so that the compressibility of the image signal 861 can be increased.

Now, the local decoding processing LDP is described. In the local decoding processing LDP, correction by the intra-picture prediction (also referred to as intra-prediction or inter-frame prediction in some cases) or correction by the motion-compensated prediction (also referred to as inter-frame prediction in some cases) is performed on the quantized data generated in the DCT/DST/quantization PRC 12. The local decoding processing LDP includes the inverse DCT/inverse DST/inverse quantization PRC 13, the intra-picture prediction PRC 14, the in-loop filter PRC 15, and the motion-compensated prediction PRC 17 as described above.

In the inverse DCT/inverse DST/inverse quantization PRC 13, inverse quantization is performed on the quantized data generated in the DCT/DST/quantization PRC 12, and inverse orthogonal transform such as inverse discrete cosine transform or the inverse discrete sine transform is performed on the data, so that inverse quantized data is generated.

In the intra-picture prediction PRC 14, a pixel value of one pixel is determined by making an inference from a pixel value of an adjacent pixel on the basis of the inverse quantized data generated in the inverse DCT/inverse DST/inverse quantization PRC 13. Note that this processing is effective, for example, in the case where the pixel data changes gradually in a frame.

In the in-loop filter PRC 15 (referred to as de-blocking filter in some cases), the inverse quantized data generated in the inverse DCT/inverse DST/inverse quantization PRC 13 is filtered. When the inverse quantized data is filtered, block noise which is caused by the block division PRC 11 or the like and included in the inverse quantized data can be removed. The block noise indicates a phenomenon in which discontinuous images occur at boundaries between blocked images in the image data subjected to the block division PRC 11 or the like (i.e., a phenomenon in which part of regions is seen as a mosaic pattern). The inverse quantized data from which the block noise is removed is called the local decoding data 863. The in-loop filter PRC 15 is effective in the case where the movement of an object included in a displayed image is detected with high accuracy in the motion detection PRC 16 described later. However, the encoder 806 may have a configuration without the in-loop filter PRC 15.

In the motion detection PRC 16, the movement of an object included in a displayed image is detected from the block data generated in the block division PRC 11 and the local decoding data 863 generated in the in-loop filter PRC 15 (or the inverse quantized data generated in the inverse DCT/inverse DST/inverse quantization PRC 13). In the case where the movement of an object is detected by this processing, the amount of movement is obtained as a vector quantity, and the motion-compensated prediction PRC 17 can be performed with the vector quantity.

In the motion-compensated prediction PRC 17, an image expressing the object after the movement is generated, as an image displayed in a subsequent frame, from the local decoding data 863 generated in the in-loop filter PRC 15 (or the inverse quantized data generated in the inverse DCT/inverse DST/inverse quantization PRC 13). on the basis of the vector quantity (the amount of movement) of the object obtained in the motion detection PRC 16 and an image displayed in the previous frame.

In particular, in the case where the motion-compensated prediction PRC 17 is performed, it is preferable to use a semiconductor device including an analog processing circuit or a semiconductor device in which a neural network is constructed, described in Embodiment 2, for comparison of images and pattern extraction necessary for the processing.

Note that the intra-picture prediction PRC 14 or the motion-compensated prediction PRC 17 is performed repeatedly. By the switch SW4, one of the correction by the intra-picture prediction PRC 14 and the correction by the motion-compensated prediction PRC 17 is selected, and the inverse quantized data generated in the inverse DCT/inverse DST/inverse quantization PRC 13 is corrected.

The local decoding data 863 obtained by the correction loop by either the intra-picture prediction PRC 14 or the motion-compensated prediction PRC 17 is used for difference calculation of the block data outputted from the block division PRC 11. In other words, the correction is performed on the block data. The block data subjected to the correction (difference data) is quantized by the DCT/DST/quantization PRC 12.

<Decoder>

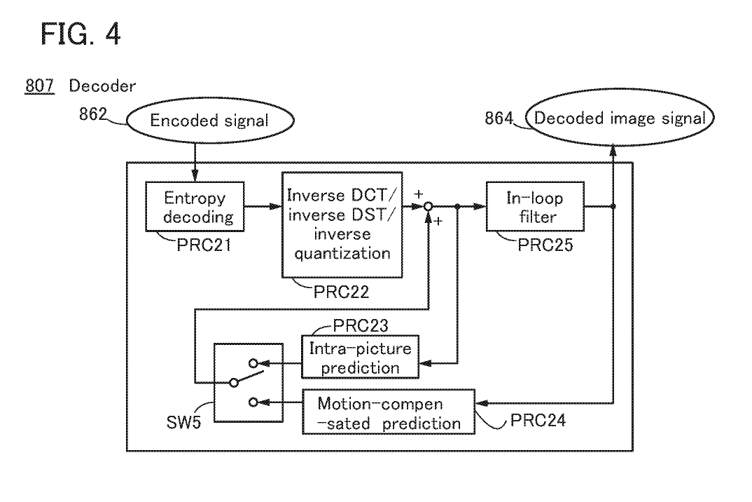

FIG. 4 is a block diagram illustrating the processing performed in the decoder 807 and the processing order.

The decoder 807 includes the following processing: entropy decoding PRC 21, inverse discrete cosine transform (inverse DCT)/inverse discrete sine transform (inverse DSTY/inverse quantization PRC 22, intra-picture prediction PRC 23, motion-compensated prediction PRC 24, and in-loop filter PRC 25. Furthermore, the decoder 807 includes a switch SW5, and the switch SW5 has a function of selecting one from two inputs depending on the content of processing and outputting the selected one.

In the decoder 807, a decoded image signal 864 is generated from the inputted encoded signal 862 by the above processing. The decoding by the decoder 807 is specifically described below.

In the entropy decoding PRC 21, the encoded signal 862 (the compressed data, i.e., one of the first to third read data) inputted to the decoder 807 is converted into entropy decoding data.

In the inverse DCT/inverse DST/inverse quantization PRC 22, inverse quantization and inverse orthogonal transform such as inverse discrete cosine transform or inverse discrete sine transform are performed on the entropy decoding data generated in the entropy decoding PRC 21, so that inverse quantized data is generated.

In the in-loop filter PRC 25, the inverse quantized data generated in the inverse DCT/inverse DST/inverse quantization PRC 22 is filtered to form the decoded image signal 864 (one of first to third internal reproduction data).

In the case where the decoded image signal 864 is corrected by the intra-picture prediction, the intra-picture prediction PRC 23 is performed on the inverse quantized data generated in the inverse DCT/inverse DST/inverse quantization PRC 22. For the intra-picture prediction PRC 23, the description of the intra-picture prediction PRC 14 is referred to.

In the case where the decoded image signal 864 is corrected by the motion-compensated prediction, the motion-compensated prediction PRC 24 is performed on the decoded image signal 864. For the motion-compensated prediction PRC 24, the description of the motion-compensated prediction PRC 17 is referred to.

In particular, in the case where the motion-compensated prediction PRC 24 is performed, it is preferable to use a semiconductor device including an analog processing circuit or a semiconductor device in which a neural network is constructed, described in Embodiment 2, for comparison of images and pattern extraction necessary for the processing.

Note that the intra-picture prediction PRC 23 or the motion-compensated prediction PRC 24 is performed repeatedly. By the switch SW5, one of correction by the intra-picture prediction PRC 23 and correction by the motion-compensated prediction PRC 24 is selected, and the inverse quantized data generated in the inverse DCT/inverse DST/inverse quantization PRC 22 is corrected. In the case where the correction is repeated, the processing in the intra-picture prediction PRC 23 or the processing in the in-loop filter PRC 25 and the motion-compensated prediction PRC 24 is performed. When the correction is completed, the decoded image signal 864 is generated on the basis of the corrected inverse quantized data in the in-loop filter PRC 25, and the decoded image signal 864 is outputted from the decoder 807.

When the encoder 806 and the decoder 807 which enable the above processing operation are provided in the electronic device 800, data can be written at high speed and data comparison can be performed efficiently in the electronic device 800.

This embodiment can be combined with any of the other embodiments in this specification as appropriate.

### Embodiment 2

In this embodiment, a configuration of circuit (semiconductor device) for performing the motion detection PRC 16 and the motion-compensated prediction PRC 17 by the encoder described in Embodiment 1 will be described.

<Example of Object Motion Detection>

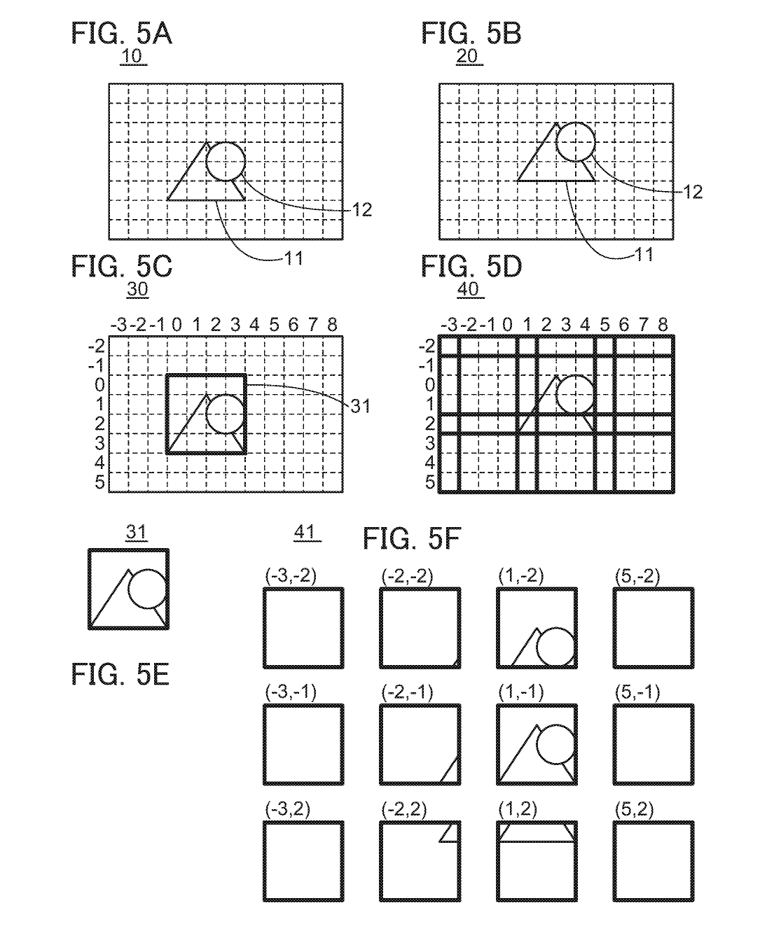

First, an example of a method for detecting a motion of an object included in a displayed image will be described with reference to FIGS. 5A to 5F.

FIGS. 5A to 5F illustrate an algorithm for detecting an object motion in image data.

FIG. 5A shows image data 10 that has a triangle 11 and a circular 12. FIG. 5B shows image data 20 where the triangle 11 and the circle 12 of the image data 10 are moved to the upper right.

Image data 30 in FIG. 5C shows operation by which a region 31 including the triangle 11 and the circle 12 is extracted from the image data 10. In the image data 30, a cell at the upper left corner of the extracted region 31 is regarded as a reference point (0, 0), and numbers indicating positions in the right/left direction and the upper/lower direction are added to the image data 10. The extracted region 31 of FIG. 5C is shown in FIG. 5E.

Image data 40 in FIG. 5D shows operation by which a plurality of regions 41 are extracted from the image data 20. The numbers indicating positions in the right/left direction and the upper/lower direction given to the image data 30 are added to the image data 20, which is the image data 40. On the basis of the image data 30 and 40, which position the region 31 moves to can be expressed by a displacement (a motion vector). FIG. 5F shows some of the extracted regions 41.

After the operation of extracting the plurality of regions 41, the regions 41 are sequentially compared with the region 31 to detect a motion of the objects. This comparing operation determines that the region 41 with a motion vector (1, −1) corresponds to the region 31, and that the regions 41 except the one with the motion vector (1, −1) do not correspond to the region 31. Accordingly, the motion vector (1, −1) from the region 31 to the region 41 can be obtained.

In this specification, the data of the region 31 is described as first data in some cases, and the data of one of the plurality of regions 41 is described as second data in some cases.

Although the extraction, comparison, and detection are performed based on the regions each formed of 4×4 cells in FIGS. 5A to 5F, the size of the regions in the present operation example is not limited thereto. The size of the regions may be changed as appropriate in accordance with the size of image data to be extracted. For example, extraction, comparison, and detection may be performed based on the regions each formed of 3×5 cells. There is no limitation on the number of pixels forming a cell; for example, one cell used for forming a region may be formed of 10×10 pixels, or be one pixel. Alternatively. one cell used for forming a region may be formed of 5×10 pixels.

Depending on the video content, image data contained in the region 31 may be changed. For example, the triangle 11 or the circle 12 in the region 31 may be scaled up or down in the image data 40. Alternatively, the triangle 11 or the circle 12 in the region 31 may be rotated in the image data 40. In that case, an effective detection way is as follows: how much degree each of the plurality of regions 41 corresponds to the region 31 is calculated in an analog value (hereinafter referred to as the correspondence degree in some cases) and a displacement (motion vector) of the region 41 with the maximum correspondence degree is obtained. To achieve this, it is preferable that whether or not the region 31 and any of the plurality of regions 41 are identical be determined by characteristics extraction or the like. Motion-compensated prediction becomes possible when image data where the region 31 moves in the motion vector direction is generated from the image data of the region 31 and a difference between the generated data and the plurality of regions 41 is obtained. When the moving amount of the image data of the region 31 is not coincident with an integral multiple of the pixel pitch, the correspondence degree may be detected in an analog value on the basis of comparison between the region 31 and the plurality of regions 41 so that a displacement with the maximum correspondence degree is predicted and detected as a displacement (motion vector) of the objects.

<Configuration Example 1 of Semiconductor Device>

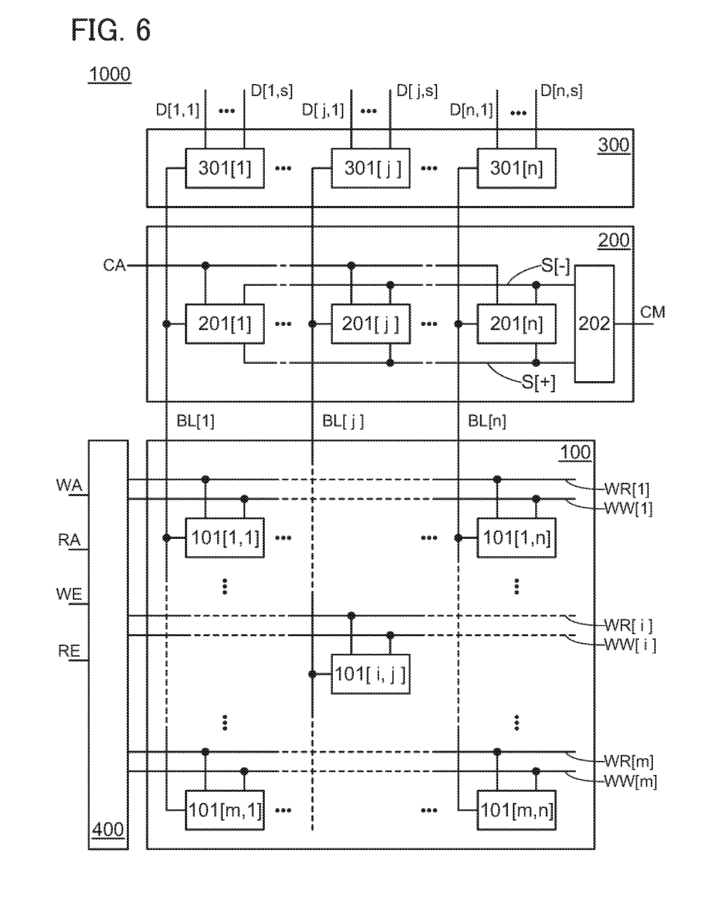

FIG. 6 illustrates an example of a semiconductor device that performs the above-described motion detection. A semiconductor device 1000 includes a memory cell array 100, an analog processing circuit 200, a writing circuit 300, and a row driver 400. The memory cell array 100 is electrically connected to the row driver 400, and the writing circuit 300 is electrically connected to the memory cell array 100 through the analog processing circuit 200.

The memory cell array 100 includes memory cells 101[1, 1] to 101[m, n]. Specifically, m x n memory cells 101 are arranged in total in a matrix of m rows by n columns (m and n are each an integer of 1 or greater). The memory cell 101[i, j] (i is an integer greater than or equal to 1 and less than or equal to m, and j is an integer greater than or equal to 1 and less than or equal to n) is electrically connected to the row driver 400 through a wiring WR[i] and a wiring WW[i], and is electrically connected to the analog processing circuit 200 and the writing circuit 300 through a wiring BL[j].

The analog processing circuit 200 includes rectifier circuits 201[1] to 201[n] and a comparison circuit 202. The rectifier circuit 201 [j] is electrically connected to the wiring BL[j], a wiring CA, a wiring S[+], and a wiring S[−]. The comparison circuit 202 is electrically connected to a wiring CM, the wiring S[+], and the wiring S[−].

The writing circuit 300 includes current supply circuits 301[1] to 301[n]. The current supply circuit 301 [j] is electrically connected to the wiring BL[j] and wirings D[j, 1] to D[j, s] (s is an integer of 1 or greater).

The row driver 400 is electrically connected to a wiring WA. a wiring RA, a wiring WE, and a wiring RE.

In FIG. 6, only the memory cells 101[1, 1], 101[m, 1], 101[1, n], 101[m, n], and 101[i, j], the rectifier circuits 201[1], 201[n], and 201[j], the current supply circuits 301[1], 301[n], and 301[j], the row driver 400. and the wirings WR[1], WR[m], WR[i], WW[1], WW[m], WW[i], BL[1], BL[n], BL[j], D[1, 1], D[1, s], D[n, 1], D[n, s], D[j, 1], D[j, s], WA, RA, WE, RE, CA. CM, S[+], and S[−] are described, and description of the other circuits, wirings, and numerals and symbols are omitted.

<<Memory Cell 101>>

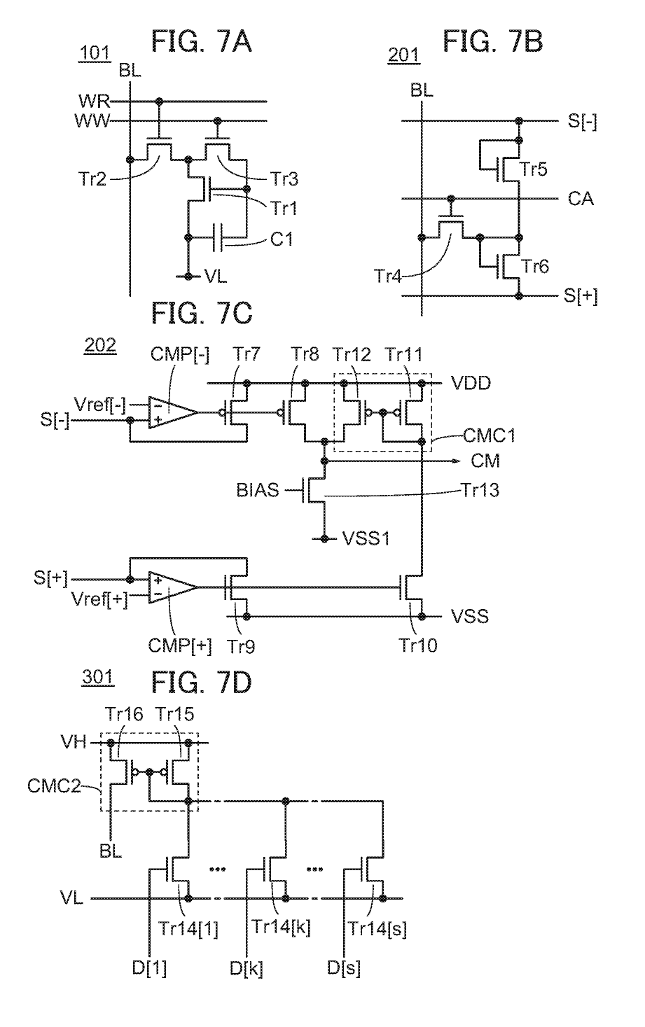

Next, a circuit configuration of the memory cells 101[1, 1] to 101[m, n] is described with reference to FIG. 7A.

A memory cell 101 in FIG. 7A shows a circuit configuration of each of the memory cells 101[1, 1] to 101[m, n], and includes transistors Tr1 to Tr3 and a capacitor C1. Note that the transistors Tr1 to Tr3 are n-channel transistors.

A wiring BL corresponds to any one of the wirings BL[1] to BL[n] in FIG. 6, a wiring WW corresponds to any one of the wirings WW[1] to WW[m] in FIG. 6, and a wiring WR corresponds to any one of the wirings WR[1] to WR[m] in FIG. 6.

One of a source and a drain of the transistor Tr1 is electrically connected to one of a source and a drain of the transistor Tr2 and one of a source and a drain of the transistor Tr3. The other of the source and the drain of the transistor Tr1 is electrically connected to a first terminal of the capacitor C1 and a wiring VL. A gate of the transistor Tr1 is electrically connected to a second terminal of the capacitor C1 and the other of the source and the drain of the transistor Tr3. The other of the source and the drain of the transistor Tr2 is electrically connected to the wiring BL, and a gate of the transistor Tr2 is electrically connected to the wiring WR. A gate of the transistor Tr3 is electrically connected to the wiring WW. The wiring VL supplies a potential lower than a potential of a wiring VH that is described later.

The transistors Tr1 to Tr3 are preferably OS transistors described in Embodiment 6. OS transistors have an extremely low off-state current, and thus deterioration of data stored in the second terminal side of the capacitor C1 due to a leakage current can be suppressed.

<<Rectifier Circuit 201>>

A circuit configuration of the rectifier circuits 201[1] to 201[n] is described with reference to FIG. 7B.

A rectifier circuit 201 in FIG. 7B shows a circuit configuration of any one of the rectifier circuits 201[1] to 201[n], and includes transistors Tr4 to Tr6. Note that the transistors Tr4 to Tr6 are n-channel transistors.

A wiring BL corresponds to any one of the wirings BL[I] to BL[n] in FIG. 6. The wiring S[+] and the wiring S[−] are electrically connected to the comparison circuit 202 described later.

One of a source and a drain of the transistor Tr4 is electrically connected to one of a source and a drain of the transistor Tr5, one of a source and a drain of the transistor Tr6, and a gate of the transistor Tr6. The other of the source and the drain of the transistor Tr4 is electrically connected to the wiring BL. A gate of the transistor Tr4 is electrically connected to the wiring CA. The other of the source and the drain of the transistor Tr5 is electrically connected to a gate of the transistor Tr5 and the wiring S[−]. The other of the source and the drain of the transistor Tr6 is electrically connected to the wiring S[+].

<<Comparison Circuit 202>>

A circuit configuration of the comparison circuit 202 is described with reference to FIG. 7C.

The comparison circuit 202 in FIG. 7C includes transistors Tr7 to Tr13, a comparator CMP[−], and a comparator CMP[+]. The transistors Tr7, Tr8, Tr11, and Tr12 are p-channel transistors while the transistors Tr9, Tr10. and Tr13 are n-channel transistors.

An inverting input terminal of the comparator CMP[−] is electrically connected to a wiring Vref[−]. A non-inverting input terminal of the comparator CMP[−] is electrically connected to one of a source and a drain of the transistor Tr7 and the wiring S[−]. An output terminal of the comparator CMP[−] is electrically connected to a gate of the transistor Tr7 and a gate of the transistor Tr8.

An inverting input terminal of the comparator CMP[+] is electrically connected to a wiring Vref[+]. A non-inverting input terminal of the comparator CMP[+] is electrically connected to one of a source and a drain of the transistor Tr9 and the wiring S[+]. An output terminal of the comparator CMP[+] is electrically connected to a gate of the transistor Tr9 and a gate of the transistor Tr10.

The other of the source and the drain of the transistor Tr7 is electrically connected to a wiring VDD. One of a source and a drain of the transistor Tr8 is electrically connected to one of a source and a drain of the transistor Tr12, one of a source and a drain of the transistor Tr13, and the wiring CM. The other of the source and the drain of the transistor Tr8 is electrically connected to the wiring VDD. The other of the source and the drain of the transistor Tr12 is electrically connected to the wiring VDD. A gate of the transistor Tr12 is electrically connected to a gate of the transistor Tr11, one of a source and a drain of the transistor Tr11, and one of a source and a drain of the transistor Tr10. The other of the source and the drain of the transistor Tr11 is electrically connected to the wiring VDD. The other of the source and the drain of the transistor Tr9 and the other of the source and the drain of the transistor Tr10 are electrically connected to a wiring VSS. The other of the source and the drain of the transistor Tr13 is electrically connected to a wiring VSS1, and a gate of the transistor Tr13 is electrically connected to a wiring BIAS.

The wiring VDD supplies a high-level potential, the wiring VSS supplies a potential lower than the potential of the wiring VDD (hereinafter such a low potential may be referred to as a low-level potential), and the wiring VSS1 supplies a potential lower than the potential of the wiring VDD. Note that the potential of the wiring VSS may be lower or higher than the potential of the wiring VSS1. Alternatively, the potential of the wiring VSS may be the same as the potential of the wiring VSS1.

The comparison circuit 202 supplies the wiring CM with a potential higher than a low-level potential when a current flows in at least one of the wirings S[−] and S[+] (the operation of the comparison circuit 202 is detailed later). The potential outputted to the wiring CM is heightened with an increase in the amount of a current flowing in the wiring S[−] or S[+].

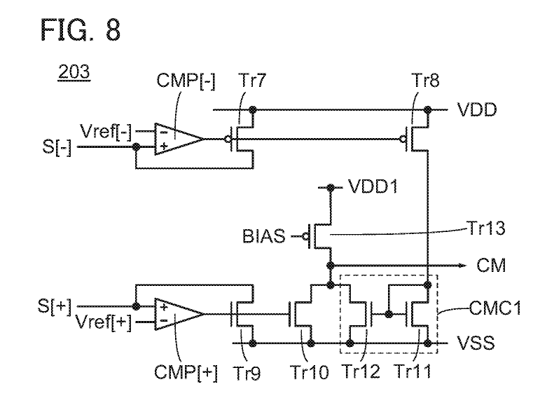

The circuit configuration of the comparison circuit 202 is not limited to one in FIG. 7C. For example, it may have a circuit configuration of a comparison circuit 203 in FIG. 8.

The comparison circuit 203 includes the transistors Tr7 to Tr13, the comparator CMP[−], and the comparator CMP[+]. The transistors Tr7, Tr8, and Tr13 are p-channel transistors while the transistors Tr9 to Tr12 are n-channel transistors.

The inverting input terminal of the comparator CMP[−] is electrically connected to the wiring Vref[−]. The non-inverting input terminal of the comparator CMP[−] is electrically connected to one of the source and the drain of the transistor Tr7 and the wiring S[−]. The output terminal of the comparator CMP[−] is electrically connected to the gate of the transistor Tr7 and the gate of the transistor Tr8.

The inverting input terminal of the comparator CMP[+] is electrically connected to the wiring Vref[+]. The non-inverting input terminal of the comparator CMP[+] is electrically connected to one of the source and the drain of the transistor Tr9 and the wiring S[+]. The output terminal of the comparator CMP[+] is electrically connected to the gate of the transistor Tr9 and the gate of the transistor Tr10.

The wiring Vref[−] supplies a reference potential to the inverting input terminal of the comparator CMP[−], and the wiring Vref[+] supplies a reference potential to the inverting input terminal of the comparator CMP[+].

The other of the source and the drain of the transistor Tr9 is electrically connected to the wiring VSS. One of the source and the drain of the transistor Tr10 is electrically connected to one of the source and the drain of the transistor Tr12, one of the source and the drain of the transistor Tr13, and the wiring CM. The other of the source and the drain of the transistor Tr10 is electrically connected to the wiring VSS. The other of the source and the drain of the transistor Tr12 is electrically connected to the wiring VSS. The gate of the transistor Tr12 is electrically connected to the gate of the transistor Tr11, one of the source and the drain of the transistor Tr11, and one of the source and the drain of the transistor Tr8. The other of the source and the drain of the transistor Tr11 is electrically connected to the wiring VSS. The other of the source and the drain of the transistor Tr7 and the other of the source and the drain of the transistor Tr8 are electrically connected to the wiring VDD. The other of the source and the drain of the transistor Tr13 is electrically connected to a wiring VDD1, and the gate of the transistor Tr13 is electrically connected to the wiring BIAS.

The wiring VDD1 supplies a potential higher than the potential of the wiring VSS. Note that the potential of the wiring VDD1 may be lower or higher than the potential of the wiring VDD1. Alternatively, the potential of the wiring VDD may be the same as the potential of the wiring VDD1.

The comparison circuit 203 supplies the wiring CM with a potential lower than a high-level potential when a current flows in at least one of the wirings S[−] and S[+]. The potential outputted to the wiring CM is lowered with an increase in the amount of a current flowing in the wiring S[−] or S[+]. Although the output from the comparison circuit 203 is different from that from the comparison circuit 202, the comparison circuit 203 can determine whether or not a current flows in the wiring S[−] or S[+].

In the comparison circuit 202, the transistors Tr11 and Tr12 and the wiring VDD form a current mirror circuit CMC1. That is, when the transistor Tr10 is on, a current equivalent to that flowing between the source and the drain of the transistor Tr11 flows between the source and the drain of the transistor Tr12. The current mirror circuit CMC1 is not limited to the circuit formed with the transistors Tr11 and Tr12 and the wiring VDD, and any circuit where a current value on the input side is equivalent to that on the output side may be used instead.

<<Current Supply Circuit 301>>

A circuit configuration of the current supply circuits 301[1] to 301[n] is described with reference to FIG. 7D.

A current supply circuit 301 in FIG. 7D shows a configuration of any one of the current supply circuits 301[1] to 301[n], and includes transistors Tr14[1] to Tr14[s], a transistor Tr15, and a transistor Tr16. The transistors Tr15 and Tr16 are p-channel transistors, and the transistors Tr14[1] to Tr14[s] are n-channel transistors. The channel width ratio of the transistor Tr14[1] to the transistor Tr14[k] is 1:2^{k-1} (k is an integer greater than or equal to 1 and less than or equal to s).

A gate of the transistor Tr14[k] is electrically connected to a wiring D[k]. One of a source and a drain of the transistor Tr14[k] is electrically connected to one of a source and a drain of the transistor Tr15, a gate of the transistor Tr15. and a gate of the transistor Tr16. The other of the source and the drain of the transistor Tr14[k] is electrically connected to the wiring VL. The other of the source and the drain of the transistor Tr15 is electrically connected to the wiring VH. One of a source and a drain of the transistor Tr16 is electrically connected to the wiring BL. The other of the source and the drain of the transistor Tr16 is electrically connected to the wiring VH.

The wiring VH has a potential higher than those of the wirings VL and VSS. The wiring VL supplies the same potential as that of the wiring VL connected to the memory cell 101. The wirings VH and VL are supplied with desired potentials to operate the semiconductor device 1000.

Note that FIG. 7D only shows the transistors Tr14[1], Tr14[k], Tr14[s], Tr15, and Tr16, the wirings D[1], D[k], D[s], VL, VH, and BL, and a current mirror circuit CMC2 that is described later; the other numerals and symbols are omitted.

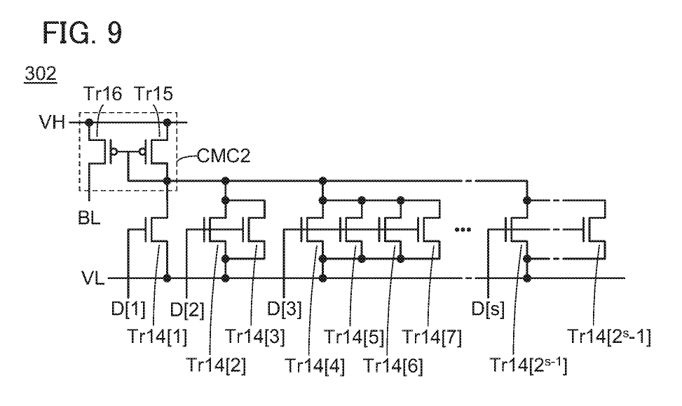

Instead of setting the channel width ratio of the transistor Tr14[1] to the transistor Tr14[k] to 1:2^{k-1}, 2^{s}−1 transistors with the same channel length and the same channel width may be used. In that case, there is a circuit where the 2^{k-1} transistors are connected in parallel on the k-th column, and the circuits are arranged on s columns in total. The current supply circuit in that case is shown in FIG. 9. A current supply circuit 302 includes transistors Tr14[1] to Tr14[2-1], the transistor Tr15, and the transistor Tr16. The transistors Tr15 and Tr16 are p-channel transistors, and the transistors Tr14[1] to Tr14[2^{s}−1] are n-channel transistors. FIG. 9 only shows the transistors Tr14[1], Tr14[2], Tr14[3], Tr14[4], Tr14[5], Tr14[6], Tr14[7], Tr14[2^{s-1}]. Tr14[2^{s}−1], Tr15. and Tr16, the wirings D[1], D[2], D[3], D[s]. VL, VH, and BL, and the current mirror circuit CMC2 that is described later: the other numerals and symbols are omitted.

One of a source and a drain of each of the transistors Tr14[1] to Tr14[2^{s}-1] is electrically connected to one of the source and the drain of the transistor Tr15, the gate of the transistor Tr15, and the gate of the transistor Tr16. A gate of each of the transistors Tr14[2^{k-1}] to Tr14[2^{k}-1] is electrically connected to the wiring D[k], the other of the source and the drain of each of the transistors Tr14[1] to Tr14[2^{s}-1] is electrically connected to the wiring VL. The other of the source and the drain of the transistor Tr15 is electrically connected to the wiring VH. One of the source and the drain of the transistor Tr16 is electrically connected to the wiring BL. The other of the source and the drain of the transistor Tr16 is electrically connected to the wiring VH.

Note that in this specification, the wirings D[1] to D[s] in the current supply circuit 301 [j] on the j-th column are described as wirings D[j, 1] to D[j, s].

In the current supply circuits 301 and 302, the current mirror circuit CMC2 is composed of the transistors Tr15 and Tr16 and the wiring VH. That is, a current equivalent to that inputted to one of the source and the drain of the transistor Tr15 is outputted to one of the source and the drain of the transistor Tr16. The current mirror circuit CMC2 is not limited to the circuit formed with the transistors Tr15 and Tr16 and the wiring VH, and any circuit where a current value on the input side is equivalent to that on the output side may be used instead.

<<Row Driver 400>>

The row driver 400 is described below.

The row driver 400 in FIG. 6 has a function of selecting any one of the rows in the memory cell array 100. When the row driver 400 selects one row in the memory cell array 100. data writing and readout can be performed in the n memory cells 101 on that row. In the memory cell 101 in FIG. 7A, high-level potentials should be applied to the corresponding wirings WR and WW to write data to the memory cell 101. To read data from the memory cell 101, a high-level potential is applied to the corresponding wiring WR.

The row driver 400 is electrically connected to the memory cells 101[i, 1] to 101[i, n] by the wirings WR[i] and WW[i]. In addition, the outside wirings WA, RA, WE. and RE are connected to the row driver 400. The wirings WA, RA, WE, and RE are wirings for sending control signals from the outside to the row driver 400. Specifically, the wirings WA, RA, WE, and RE send a writing address signal, a reading address signal, a write enable signal, and a read enable signal, respectively. The row driver 400 can select any one of the rows in the memory cell array 100 in accordance with signals from the wirings WA, RA, WE, and RE.

The connection structure of the row driver 400 is not limited to that in FIG. 6. In the semiconductor device 1000, any circuit that can select any one of the rows in the memory cell array 100 can be used instead of the row driver 400.

<Operation Example 1 of Semiconductor Device>

Next, an operation example of the semiconductor device 1000 will be described.

<<Flow Chart>>

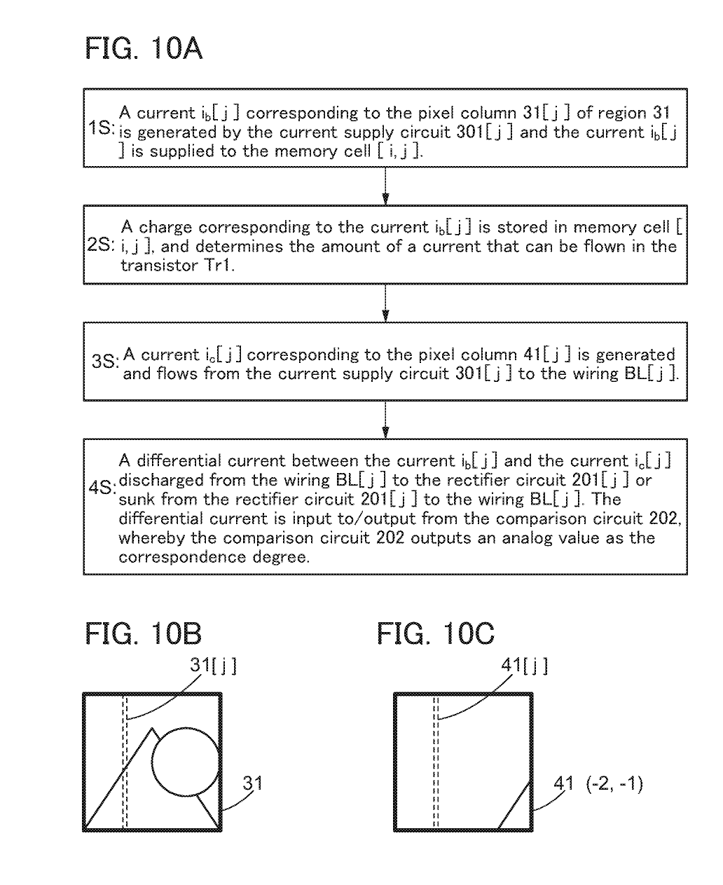

FIG. 10A is a flow chart showing an operation example of the semiconductor device 1000 shown in FIG. 6, and FIGS. 10B and 10C are drawings for supplemental explanation on the flow chart. How the semiconductor device 1000 described as a configuration example operates in accordance with the above-described example of a method for object motion detection will be described with reference to the flow chart in FIG. 10A. The flow chart in FIG. 10A focuses on the current supply circuit 301[j], the rectifier circuit 201 [j], and the memory cell 101[i, j] on the j-th column of the semiconductor device 1000, and uses the region 31 in FIG. 5E and the region 41 with (−2, −1) in FIG. 5F as image data for comparison. The pixel number of each of the region 31 and the region 41 is s x n (s pixels in one column and n pixels in one row).

In a step 1S, data of the region 31 is inputted to the semiconductor device 1000. Specifically, data corresponding to pixel values on the j-th pixel column of the region 31 (a pixel column 31[j] in FIG. 10B) are respectively inputted to the wirings DU[, 1] to D[i, s] of the current supply circuit 301[j]. Data corresponding to the pixel column 31[j] is inputted to the wirings D[j, 1] to D[j, s], whereby a current i_{b}[j] uniquely corresponding to the pixel column 31[j] is generated and flows from the current supply circuit 301[j] to the wiring BL[j]. The current i_{b}[j] is supplied to the memory cell 101[i, j].

In a step 2S, a charge is stored in the second terminal of the capacitor C1 of the memory cell 101[i, j] owing to the current i_{b}[j] generated in the step 1S. When the amount of a current that can be flown in the transistor Tr1 of the memory cell 101[i, j] is larger than the current i_{b}[j], the potential of the second terminal of the capacitor C1 decreases. When the amount of the current i_{b}[j] becomes equal to the amount of a current that can be flown in the transistor Tr1 of the memory cell 101[i, j]. the potential of the second terminal of the capacitor C1 becomes constant. When the amount of a current that can be flown in the transistor Tr1 of the memory cell 101[i, j] is less than the current i_{b}[j], the potential of the second terminal of the capacitor C1 increases; when the amount of the current i_{b}[i] becomes equal to the amount of a current that can be flown in the transistor Tr1 of the memory cell 101[i, j], the potential of the second terminal of the capacitor C1 becomes constant.

The memory cell 101[i, j] stores a charge of when the potential of the second terminal of the capacitor C1 becomes constant. The amount of the stored charge determines the amount of a current that can be flown in the transistor Tr1 of the memory cell 101[i, j]. When a charge is stored in the memory cell 101[i, j] owing to the current i_{b}[i], the amount of a current that can be flown in the transistor Tr1 becomes the amount of the current i_{b}[j].

In a step 3S, data of one of the plurality of regions 41 is inputted to the semiconductor device 1000. In this example, the data of the region 41(−2, −1) is input. In the step 3S, data corresponding to pixel values on the j-th pixel column of the region 41(−2, −1) (a pixel column 41[j] in FIG. 10C) are respectively inputted to the wirings D[j, 11] to DL[, s] of the current supply circuit 301[j]. Data corresponding to the pixel column 41[j] is inputted to the wirings D[j, 1] to D[j, s], whereby a current i_{c}[j] uniquely corresponding to the pixel column 41 [j] is generated and flows from the current supply circuit 301 [j] to the wiring BL[ ].

In a step 4S, the current i_{c}[j] generated in the step 3S is to be flown between the source and the drain of the transistor Tr1 of the memory cell 101 [i, j]. Here, the amount of a current flown between the source and the drain of the transistor Tr1 is determined by the amount of the charge stored in the step 2S. That is. the amount of a current flown between the source and the drain of the transistor Tr1 corresponds to that of the current i_{b}[j]. When the current i_{c}[j] is larger than the current i_{b}[j], the surplus current that does not flow between the source and the drain of the transistor Tr1 flows into the rectifier circuit 201 [j] as a discharge current. When the current i_{c}[j] is smaller than the current i_{b}[j], a sink current from the rectifier circuit 201 [j] to the wiring BL[j] is generated and flows between the source and the drain of the transistor Tr1 to compensate for the current i_{c}[i]. That is, when there is a difference between the current i_{b}[i] and the current i_{c}[l]J a current discharged from the wiring BL[j] to the rectifier circuit 201[j] or a current sunk from the rectifier circuit 201[j] to the wiring BL[j] is generated (hereinafter these currents are collectively referred to as a differential current). The differential current is inputted to/output from the comparison circuit 202, whereby the comparison circuit 202 outputs an analog value as the correspondence degree.

The steps 1S to 4S are performed with respect to all the cases of integers that j can take (i.e., the integers greater than or equal to 1 and less than or equal to n), whereby all the differential currents generated by data of all the pixel columns of the region 31 and that of the region 41(−2, −1) are supplied to the comparison circuit 202. As a result, the correspondence degree of the region 31 and the region 41(−2, −1) can be obtained, and thus the result of comparison between the region 31 and the region 41(−2, −1) can be obtained from the correspondence degree.

In the above explanation, the region 41(−2, −1) is used as data for comparison; in an operation example of the semiconductor device of one embodiment of the present invention, the plurality of regions 41 are sequentially compared with the region 31. That is, the steps 3S and 4S are repeated the number of times corresponding to the number of the plurality of regions 41 to obtain the correspondence degrees of image data of the regions 41 and acquire motion vectors. Every time the correspondence degree of one of the regions 41 and the region 31 is obtained, the analog value output from the wiring CM should be reset. In that case, a high-level potential is applied to the wiring BIAS to turn on the transistor Tr13 so that the wiring CM outputs the potential of the wiring VSS1 for initialization.

Although the number of pixels of each of the regions 31 and 41 are s x n in total (s pixels on one column and n pixels on one row) in the operation of the semiconductor device described in FIGS. 10A to 10C, an operation example of the semiconductor device of one embodiment of the present invention is not limited thereto. For example, each of the regions 31 and 41 may have less than s pixels on one column and less than n pixels on one row. In that case, a configuration where unused wirings among the wirings D[1] to D[s] are not supplied with image data and unused circuits among the current supply circuits 301[1] to 301 [n] do not operate is acceptable. Alternatively, for example, each of the regions 31 and 41 may have more than s pixels on one column and more than n pixels on one row. In that case, the number of wirings D of the current supply circuit 301 and the number of the current supply circuits 301 are increased as needed.

<<Timing Chart>>

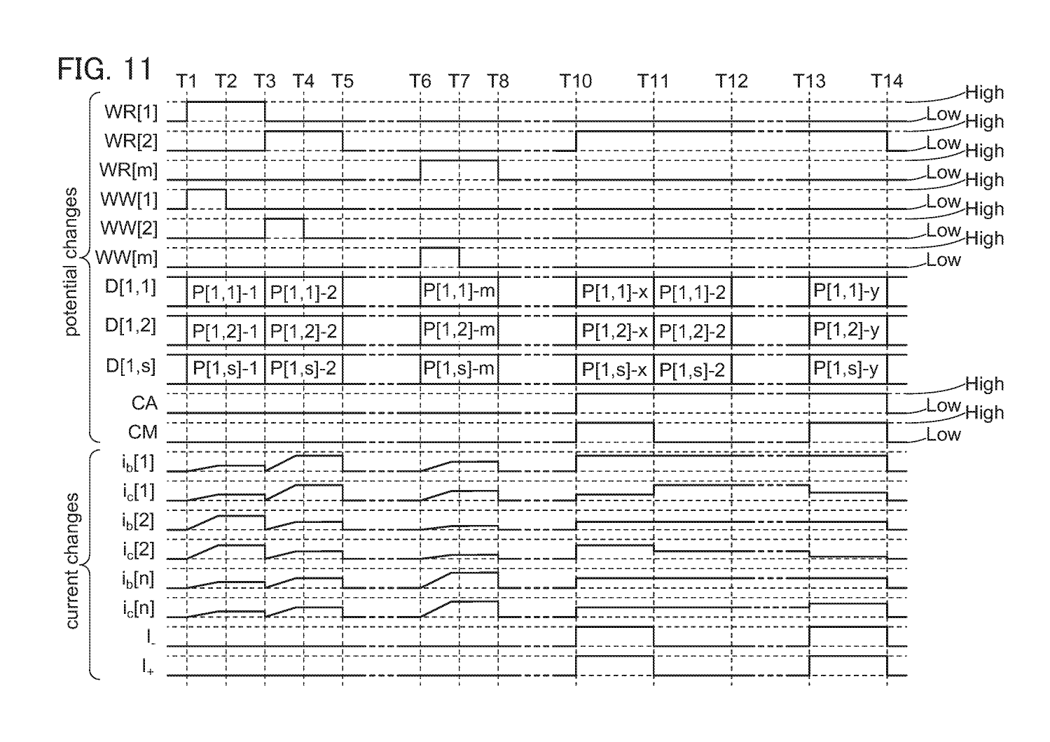

FIG. 11 is a timing chart illustrating an operation example of the semiconductor device 1000. In this embodiment, the wiring VH and the wiring VL are set to high (H) and low (L) level potentials, respectively.

A high-level potential or a low-level potential is applied to the wirings WR[1] to WR[m], and WW[1] to WW[m]. In FIG. 11, high- and low-level potentials are expressed as High and Low, respectively.

The timing chart in FIG. 11 shows potential changes of the wirings WR[1], WR[2], WR[m], WW[1], WW[2], WW[m], D[1, 1], D[1, 2], D[1, s], CA and CM from time T1 to time T14. In FIG. 11, high- and low-level potentials applied to the wirings CA and CM are expressed as High and Low, respectively. The timing chart in FIG. 11 also shows current changes of i_{b}[1], i_{c}[1], i_{b}[2]. i_{c}[2], i_{b}[n], i_{c}[n], I₋, and I₊ from Time T1 to Time T14.

The current i_{b}[j] indicates a current that flows from the wiring BL[j] to any one of the memory cells 101[1, j] to 101[m, j]. The current i_{c}[j] indicates a current that flows from the current supply circuit 301[j] to the wiring BL[j]. The current I₋ indicates a current that flows in the wiring S[−], and the current I₊ indicates a current that flows in the wiring S[+].

[Time T1 to T3]

From time T1 to T2, a high-level potential from the wiring WR[1], low-level potentials from the wirings WR[2] to WR[m], a high-level potential from the wiring WW[1], and low-level potentials from the wirings WW[2] to WW[m] are inputted to the memory cell array 100. Accordingly, the transistors Tr2 and Tr3 included in the memory cells 101[1, 1] to 101[1, n] of the memory cell array 100 are turned on.

In addition, a potential (signal) of data P[1, 1]-1 from the wiring D[1, 1], a potential (signal) of data P[1, 2]-1 from the wiring D[1, 2], a potential (signal) of data P[1, h]-1 from the wiring D[1, h], and a potential (signal) of data P[1, s]-1 from the wiring D[1, s] are inputted to the current supply circuit 301[1] (h is an integer greater than or equal to 3 and less than s; the wiring D[1, h] is not illustrated in FIG. 11).

Similarly, potentials (signals) are input also to the current supply circuits 301[2] to 301[n]. That is, potentials (signals) of data P[j, 1]-1 to P[j, s]-1 of the wirings D[j, 1] to D[j, s] are inputted to the current supply circuit 301[j]. At the same time, a low-level potential is input from the wiring CA to the analog processing circuit 200. Thus, the transistor Tr4 is off and currents do not flow in the wirings S[−] and S[+].

At this time, the current supply circuit 301[1] supplies the wiring BL[1] with a current that uniquely corresponds to data P[1, 1]-1 to P[1, s]-1 supplied from the wirings D[1, 1] to D[1, s]. Similarly, the current supply circuit 301[j] supplies the wiring BL[i] with a current that uniquely corresponds to data P[j, 1]-1 to P[j, s]-1. To the transistors Tr14[1] to Tr14[s], Tr15, and Tr16 of the current supply circuit 301, gate voltages are applied in such a range that the transistors operate in a saturation region.

Since the transistors Tr2 and Tr3 in the memory cells 10[1, 1] to 101[1, n] are on. currents flow from the current supply circuits 301[1] to 301 [n] to the memory cells 101[1, 1] to 101[1, n], respectively, through the wirings BL[1] to BL[n]. As a result, one of the source and the drain of the transistor Tr1 in each of the memory cells 101[1, 1] to 101[1, n] has the same potential as the second terminal of the capacitor C1.

From time T2 to T3, the wiring WW[1] is set to a low-level potential while the potential of the wiring WR[1] is kept a high level. Accordingly, the transistors Tr2 of the memory cells 101[1, 1] to 101[1, n] of the memory cell array 100 are on while the transistors Tr3 of them are turned off. Here, the potentials are stored by the capacitors C included in the memory cells 101[1, 1] to 101[1, n]. That is, from time T1 to T3, the potential uniquely corresponding to the data P[1, 1]-1 to P[1, s]-1 is stored in the memory cell 101[1, 1]. Similarly, the potential uniquely corresponding to the data P[j, 1]-1 to P[j, s]-1 is stored in the memory cell 101[1, j].

From time T1 to T3. since all the current from the current supply circuit 301[j] flows into the memory cell 101[1, j], i_{b}[j] and i_{c}[j] are equivalent to each other. As shown in the timing chart of FIG. 11, the current values of i_{b}[1] and i_{c}[1] are equivalent to each other, the current values of i_{b}[2] and i_{c}[2] are equivalent to each other, and the current values of i_{b}[n] and i_{c}[n] are equivalent to each other.

[Time T3 to T8]

From time T3 to T5, a potential uniquely corresponding to data P[j, 1]-2 to P[j, s]-2 is written to the memory cell 101 [2,j], in a way similar to the operation from time T1 to T3.

Operation from time T3 to T5 is specifically described. From time T3 to T4, a low-level potential from the wiring WR[1], a high-level potential from the wiring WR[2], low-level potentials from the wirings WR[3] to WR[m], a low-level potential from the wiring WW[1], a high-level potential from the wiring WW[2], and low-level potentials from the wirings WW[3] to WW[m] are inputted to the memory cell array 100. Accordingly, the transistors Tr2 and Tr3 included in the memory cells 101[2, 1] to 101[2, n] of the memory cell array 100 are turned on.

In addition, a potential (signal) of data P[1, 1]-2 from the wiring D[1, 1], a potential (signal) of data P[1, 2]-2 from the wiring D[1, 2], a potential (signal) of data P[1, h]-2 from the wiring D[1, h], and a potential (signal) of data P[1, s]-2 from the wiring D[1, s] are inputted to the current supply circuit 301[1].

Similarly, potentials (signals) are input also to the current supply circuits 301[2] to 301[n]. That is, potentials (signals) of data P[j, 1]-2 to P[j, s]-2 of the wirings D[j, 1] to D[j, s] are inputted to the current supply circuit 301[j]. Since before time T3, a low-level potential has been input from the wiring CA to the analog processing circuit 200 continuously. Thus, the transistor Tr4 is off and currents do not flow in the wirings S[−] and S[+].

At this time, the current supply circuit 301[1] supplies the wiring BL[1] with a current that uniquely corresponds to data P[1, 1]-2 to P[1, s]-2 supplied from the wirings D[1, 1] to D[1, s]. Similarly, the current supply circuit 301[j] supplies the wiring BL[i] with a current that uniquely corresponds to data P[j, 1]-2 to P[j, s]-2.

Since the transistors Tr2 and Tr3 in the memory cells 101[2, 1] to 101[2, n] are on. currents flow from the current supply circuits 301[1] to 301[n] to the memory cells 101[2, 1] to 101[2, n], respectively, through the wirings BL[1] to BL[n]. As a result, one of the source and the drain of the transistor Tr1 in each of the memory cells 101[2, 1] to 101[2, n] has the same potential as the second terminal of the capacitor C1.

From time T4 to T5, the wiring WW[2] is set to a low-level potential while the potential of the wiring WR[2] is kept a high level. Accordingly, the transistors Tr2 of the memory cells 101[2, 1] to 101[2, n] of the memory cell array 100 are on and the transistors Tr3 of them are turned off. Here, the potentials are stored by the capacitors C1 included in the memory cells 101[2, 1] to 101[2, n]. That is, from time T3 to T5, the potential uniquely corresponding to the data P[1, 1]-2 to P[1, s]-2 is stored in the memory cell 101[2, 1]. Similarly, the potential uniquely corresponding to the data P[j, 1]-2 to P[j, s]-2 is stored in the memory cell 101[2,j].

From time T3 to T5, since all the current from the current supply circuit 301[j] flows into the memory cell 101[2, j], i_{b}[i] and i_{c}[i] are equivalent to each other. As shown in the timing chart of FIG. 11, the current values of i_{b}[1] and i_{c}[1] are equivalent to each other, the current values of i_{b}[2] and i_{c}[2] are equivalent to each other, and the current values of i_{b}[n] and i_{c}[n] are equivalent to each other.

As in the operation from time T1 to T3 and that from time T3 to T5, a potential uniquely corresponding to data P[i, 1]-g to P[i, s]-g is stored in the memory cell 101[g, j] (g is an integer greater than or equal to 3 and less than or equal to m−1) in operation from time T5 to T6. Through operation from time T6 to T8, a potential uniquely corresponding to data P[j, 1]-m to P[j, s]-m is stored in the memory cell 101[m, j]. Note that at time T6, a high-level potential is applied to the wiring WW[m] to select the memory cell 101 [m,j].

The currents i_{b}[j] and i_{c}[j] from time T5 to T8 are equivalent to each other, as in the operation from time T1 to T3 and that from time T3 to T5. As shown in the timing chart of FIG. 11, the current values of i_{b}[1] and i_{c}[l] are equivalent to each other, the current values of i_{b}[2] and i_{c}[2] are equivalent to each other, and the current values of i_{b}[n] and i_{c}[n] are equivalent to each other.

[Time T10 to T14]

A period from time T10 to T14 corresponds to operation in which a displacement (motion vector) of the triangle 11 and the circle 12 from those in the image data 10 stored in the memory cell array 100 to those in the image data 20 in FIGS. 5A and 5B is calculated. Specifically, the plurality of regions 41 are compared with the region 31, and the correspondence degrees of them are output as analog values to calculate a displacement (motion vector) of the region 31. Here, data stored in the memory cells 101[2, 1] to 101[2, n] is treated as the region 31 (the first data).

From time T10 to T11, a low-level potential from the wiring WR[1], a high-level potential from the wiring WR[2]. low-level potentials from the wirings WR[3] to WR[m], and low-level potentials from the wirings WW[1] to WW[m] are inputted to the memory cell array 100. Accordingly, the transistors Tr2 of the memory cells 101[2, 1] to 101[2, n] in the memory cell array 100 are turned on while the transistors Tr3 of them are off. In addition, a high-level potential is input from the wiring CA to the analog processing circuit 200. Thus, the transistors Tr4 in the rectifier circuits 201[1] to 201[n] are turned on.

In addition, as the second data, a potential (signal) of data P[1, 1]-x from the wiring D[1, 1] (x is an integer greater than or equal to 1 but not 2), a potential (signal) of data P[1, 2]-x from the wiring D[1, 2], a potential (signal) of data P[1, h]-x from the wiring D[1, h], and a potential (signal) of data P[1, s]-x from the wiring D[1, s] are inputted to the current supply circuit 301[1].

Similarly, potentials (signals) are input also to the current supply circuits 301[2] to 301 [n]. That is, potentials (signals) of data P[j, 1]-x to P[j, s]-x of the wirings D[j, 1] to D[j, s] are inputted to the current supply circuit 301[j]. Note that these second data correspond to the region 41 with (−2, −1) of the image data 40, for example.

At this time, the current I_{b}[1] corresponding to the data P[1, 1]-2 to P[1, s]-2 stored in the memory cell 101[2, 1] is supplied from the wiring BL[1] to the memory cell 101[2, 1]. Furthermore, the current I_{c}[1] corresponding to the data P[1, 1]-x to P[1, s]-x supplied from the wirings D[1, 1] to D[1, s] is supplied from the current supply circuit 301[1] to the wiring BL[1].

Similarly, the current I_{b}[j] corresponding to the data P[j, 1]-2 to P[), s]-2 stored in the memory cell 101[2, j] is supplied from the wiring BL[j] to the memory cell 101[2, j]. Furthermore, the current I_{c}[j] corresponding to the data P[2, 1]-x to P[2, s]-x supplied from the wirings D[j, 1] to D[j, s] is supplied from the current supply circuit 301[j] to the wiring BL[j].

In other words, a flow of the current I_{b}[1] to the wiring VL and supply of the current I_{c}[1] occur at a time in the wiring BL[1], and similarly, a flow of the current I_{b}[2] to the wiring VL and supply of the current I_{c}[2] occur at a time in the wiring BL[2]. Furthermore, a flow of the current I_{b}[n] to the wiring VL and supply of the current I_{c}[n] occur at a time in the wiring BL[n].

Here, the current I_{b}[1] is larger than the current I_{c}[1], the current I_{b}[2] is smaller than the current I_{c}[2], and the current I_{b}[n] is equivalent to the current I_{c}[n]. Since the transistors Tr4 in the rectifier circuits 201[1] to 201[n] are on, a current i-[1] (=I_{b}[1]−I_{c}[1]) corresponding to a difference between the current I_{b}[1] and the current I_{c}[1] flows from the rectifier circuit 201[1] to the wiring BL[1] while a current i₊[2] (=I_{c}[2]−I_{b}[2]) corresponding to a difference between the current I_{b}[2] and the current I_{c}[2] flows from the wiring BL[2] to the rectifier circuit 201[2]. Since the current I_{b}[n] is equivalent to the current I_{c}[n], a current does not flow between the wiring BL[n] and the rectifier circuit 201[n].

Similarly to the above, a current corresponding to a difference between the current I_{b}[h] and the current I_{c}[h] flows between the wiring BL[h] and the rectifier circuit 201[h]. When the current I_{b}[h] is equivalent to the current I_{c}[h], a current does not flow between the wiring BL[h] and the rectifier circuit 201[h].

In the rectifier circuit 201[1], the transistors Tr5 and Tr6 are turned on and off. respectively, by the current i₋[1]; therefore, the current i₋[1] flows from the wiring S[−] to the wiring BL[1]. In the rectifier circuit 201[2]. the transistors Tr5 and Tr6 are turned off and on, respectively, by the current i₊[2]; therefore, the current i₊[2] flows from the wiring BL[2] to the wiring S[+]. Since the current I_{b}[n] is equivalent to the current I_{c}[n], the transistors Tr5 and Tr6 in the rectifier circuit 201[n] are turned off, so that a current does not flow through the wiring S[−] or the wiring S[+].

Similarly to the above, depending on the value of a difference between the current I_{b}[h] and the current I_{c}[h], whether or not a current flows through either the wiring S[−] or the wiring S[+] or whether or not a current does not flow through neither the wiring S[−] nor the wiring S[+] is determined in the rectifier circuit 201[h].

Here, the sum of the current flowing from the wiring S[−] to the rectifier circuits 201[1] to 201[n] is called the current I₋, while the sum of the current flowing from the rectifier circuits 201[1] to 201[n] to the wiring S[+] is called the current I₊.

Here, operation of the comparison circuit 202 is described. When the current I₋ flows from the comparison circuit 202 to the wiring S[−], a low-level potential is outputted to the output terminal of the comparator CMP[−] by the comparator CMP[−]. Accordingly, the transistors Tr7 and Tr8 are turned on. When the transistor Tr7 is turned on, a current flows from the wiring VDD to the wiring S[−]. When the transistor Tr8 is turned on, a current flows from the wiring VDD to the wiring CM and the potential of the wiring CM becomes higher than a low level.

When the current I₊ flows from the wiring S[+] to the comparison circuit 202, a high-level potential is outputted to the output terminal of the comparator CMP[+] by the comparator CMP[+]. Accordingly, the transistors Tr9 and Tr10 are turned on. When the transistor Tr9 is turned on, a current flows from the wiring S[+] to the wiring VSS. When the transistor Tr10 is turned on, a current flows from one of the source and the drain of the transistor Tr11 to one of the source and the drain of the transistor Tr10. Thus, the transistors Tr11 and Tr12 are turned on. When the transistor Tr12 is turned on, a current flows from the wiring VDD to the wiring CM and the potential of the wiring CM becomes higher than a low level.

When the current I₋ or current I₊ is generated between the comparison circuit 202 and the rectifier circuits 201[1] to 201[n] (i.e., when at least one of the data P[1, 1]-x to P[n, s]-x that are the second data is different from the corresponding data of the data P[1, 1]-2 to P[n, s]-2 that are the first data stored in the memory cells 101[2, 1] to 101[2, n]), the potential of the wiring CM becomes higher than a low level.

From time T11 to T12, a low-level potential from the wiring WR[1], a high-level potential from the wiring WR[2], low-level potentials from the wirings WR[3] to WR[m], and low-level potentials from the wirings WW[1] to WW[m] are inputted to the memory cell array 100. Accordingly, the transistors Tr2 of the memory cells 101[2, 1] to 101[2, n] in the memory cell array 100 are on while the transistors Tr3 of them are off. In addition, a high-level potential is input from the wiring CA to the analog processing circuit 200. Thus, the transistors Tr4 in the rectifier circuits 201[1] to 201[n] are on.

In addition, as the second data, a potential (signal) of data P[1, 1]-2 from the wiring D[1, 1]. a potential (signal) of data P[1, 2]-2 from the wiring D[1, 2]. a potential (signal) of data P[1, h]-2 from the wiring D[1, h], and a potential (signal) of data P[1, s]-2 from the wiring D[1, s] are inputted to the current supply circuit 301[1].

Similarly, potentials (signals) are input also to the current supply circuits 301[2] to 301[n]. That is, potentials (signals) of data P[j, 1]-2 to P[j, s]-2 of the wirings D[j, 1] to D[j, s] are inputted to the current supply circuit 301[j]. Note that these second data correspond to the region 41 with (+1, −1) of the image data 40. That is, the second data are data corresponding to the first data stored in the memory cells 101[2, 1] to 101[2, n].

At this time, the current I_{b}[l] corresponding to the data P[1, 1]-2 to P[1, s]-2 stored in the memory cell 101[2, 1] is supplied from the wiring BL[1] to the memory cell 101[2, 1]. Furthermore, the current I_{c}[1] corresponding to the data P[1, 1]-2 to P[1, s]-2 supplied from the wirings D[1, 1] to D[, s] is supplied from the current supply circuit 301[1] to the wiring BL[1].

Similarly, the current I_{b}[j] corresponding to the data P[j, 1]-2 to P[j, s]-2 stored in the memory cell 101[2, j] is supplied from the wiring BL[j] to the memory cell 101[2, j]. Furthermore, the current I_{c}[j] corresponding to the data P[j,s]-2 to P[j, s]-2 supplied from the wirings D[j, 1] to D[j, s] is supplied from the current supply circuit 301[j] to the wiring BL[j]. In other words, a flow of the current I_{b}[2] and supply of the current I_{c}[2] occur at a time in the wiring BL[2], and in addition, a flow of the current I_{b}[n] and supply of the current I_{c}[n] occur at a time in the wiring BL[n].

Since the second data correspond to the first data, the current I_{b}[1] is equivalent to the current I_{c}[1], the current I_{b}[2] is equivalent to the current I_{c}[2], the current I_{b}[h] is equivalent to the current I_{c}[h], and the current I_{b}[n] is equivalent to the current I_{c}[n]. There is no difference between the current I_{b}[1] and the current I_{c}[1], between the current I_{b}[2] and the current I_{c}[2], between the current I_{b}[h] and the current I_{c}[h], or between current I_{b}[n] and the current I_{c}[n]; therefore, a current flowing in the wirings S[−] and S[+] is not generated in the rectifier circuits 201[1] to 201[n]. Thus. the transistors Tr7 to Tr12 in the comparison circuit 202 are turned off, so that the potential output from the wiring CM becomes at a low level. That is, when the second data correspond to the first data. the potential of the wiring CM becomes at a low level.

From time T13 to T14, a low-level potential from the wiring WR[1], a high-level potential from the wiring WR[2], low-level potentials from the wirings WR[3] to WR[m], and low-level potentials from the wirings WW[1] to WW[m] are inputted to the memory cell array 100. Accordingly. the transistors Tr2 of the memory cells 101[2, 1] to 101[2, n] in the memory cell array 100 are on, while the transistors Tr3 of them are off. In addition, a high-level potential is input from the wiring CA to the analog processing circuit 200. Thus, the transistors Tr4 in the rectifier circuits 201[1] to 201[n] are on.

In addition, as the second data, a potential (signal) of data P[1, 1]-y from the wiring D[1, 1] (y is an integer greater than or equal to 1 but not 2 or x), a potential (signal) of data P[1, 2]-y from the wiring D[1, 2], a potential (signal) of data P[1, h]-y from the wiring D[. h], and a potential (signal) of data P[1, s]-y from the wiring D[1, s] are inputted to the current supply circuit 301[1]. Note that these second data correspond to the region 41 with (+1, +2) of the image data 40.

At this time, the current I_{b}[l] corresponding to the data P[1, 1]-2 to P[1, s]-2 stored in the memory cell 101[2, 1] is supplied from the wiring BL[1] to the memory cell 101[2, 1]. Furthermore, the current I_{c}[1] corresponding to the data P[j, 1]-y to P[j, s]-y supplied from the wirings D[j, 1] to D[j, s] is supplied from the current supply circuit 301[j] to the wiring BL[j].

Similarly, the current I_{b}[j] corresponding to the data P[j, 1]-2 to P[j, s]-2 stored in the memory cell 101[2, j] is supplied from the wiring BL[j] to the memory cell 101[2, j]. Furthermore, the current I_{c}[j] corresponding to the data P[j, 1]-y to P[j, s]-y supplied from the wirings D[j, 1] to D[j, s] is supplied from the current supply circuit 301 [j] to the wiring BL[j].

In other words, a flow of the current I_{b}[1] to the wiring VL and supply of the current I_{c}[1] occur at a time in the wiring BL[1], and similarly, a flow of the current I_{b}[2] to the wiring VL and supply of the current I_{c}[2] occur at a time in the wiring BL[2]. Furthermore, a flow of the current I_{b}[n] to the wiring VL and supply of the current I_{c}[n] occur at a time in the wiring BL[n].

Here, the current I_{b}[1] is larger than the current I_{c}[l], the current I_{b}[2] is larger than the current I_{c}[2], and the current I_{b}[n] is smaller than the current I_{c}[n]. Since the transistors Tr4 in the rectifier circuits 201[1] to 201[n] are on, a current i-[1] (=I_{b}[1]-I_{c}[1]) corresponding to a difference between the current I_{b}[l] and the current I_{c}[1] flows from the rectifier circuit 201[1] to the wiring BL[1] while a current i₋[2] (=I_{b}[2]-I_{c}[2]) corresponding to a difference between the current I_{b}[2] and the current I_{c}[2] flows from the wiring BL[2] to the rectifier circuit 201[2]. In addition, a current i₊[n] (=I_{c}[n]-I_{b}[n]) corresponding to a difference between the current I_{b}[n] and the current I_{c}[n] flows from the rectifier circuit 201[n] to the wiring BL[n].

In the rectifier circuit 201[1], the transistors Tr5 and Tr6 are turned on and off, respectively, by the current i-[1]: therefore, the current i-[1] flows from the wiring S[−] to the wiring BL[1]. In the rectifier circuit 201[2], the transistors Tr5 and Tr6 are turned on and off, respectively, by the current i-[2]: therefore, the current i-[2] flows from the wiring S[−] to the wiring BL[2]. In the rectifier circuit 201[n], the transistors Tr5 and Tr6 are turned off and on, respectively, by the current i₊[n]; therefore, the current i₊[n] flows from the wiring BL[n] to the wiring S[+].

The rest of operation is the same as that from time T10 to T11; a current is generated in the wiring S[−] and the wiring S[+] connected to the comparison circuit 202, and thus the potential of the wiring CM becomes higher than a low level.

In the semiconductor device 1000 in FIG. 6 with such a configuration, data comparison can be efficiently conducted. Thus, the use of the semiconductor device 1000 in the encoder 806 described in Embodiment 1 enables efficient compression of image data.

Even when the current supply circuit 301 is replaced with the current supply circuit 302 in FIG. 9 as described in the above configuration example, the semiconductor device 1000 can conduct the operation similar to the above.

Even when the comparison circuit 202 is replaced with the comparison circuit 203 in FIG. 8 as described in the above configuration example, the semiconductor device 1000 can operate as an encoder of one embodiment of the present invention. However, it should be noted that the output content of the comparison circuit 203 is different from that of the comparison circuit 202.

<Configuration Example 2 of Semiconductor Device>

Next, a method for performing the above-described motion detection by using a neural network, which is different from the method described in the configuration example 1 of semiconductor device, will be described.

In this configuration example, a configuration example of a semiconductor device in which a neural network is constructed with units resembling neurons as neuron circuits and units resembling synapses as synapse circuits will be described. After the configuration example is described, an operation example of the semiconductor device and a method for motion detection using the semiconductor device will be described.

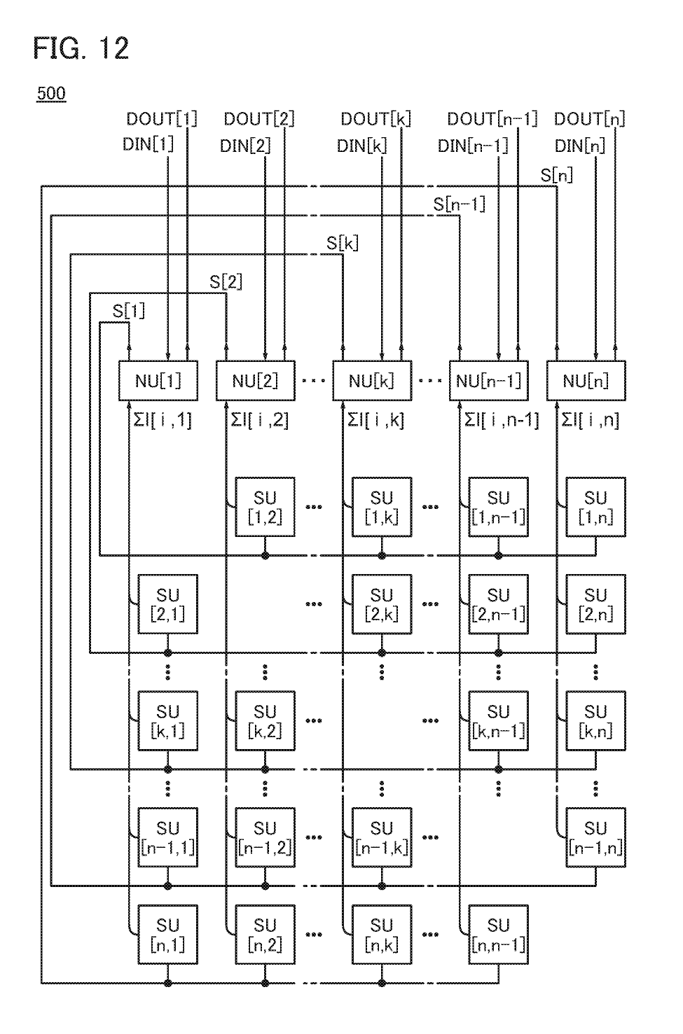

FIG. 12 illustrates an example of a semiconductor device in which a neural network is formed. A semiconductor device 500 includes neuron circuits NU[1] to NU[n] and (n²-n) synapse circuits SU (n is an integer of 2 or more).

The synapse circuits SU are arranged so that n circuits are arranged per side. In FIG. 12, the synapse circuit SU in an i-th row and a j-th column is denoted by SU[i, j]. Note that i is an integer of 1 or more and n or less, and j is an integer of 1 or more and n or less. The synapse circuit SU is not provided at the address [i, j] that satisfies i=j. Accordingly, the number of synapse circuits SU included in the semiconductor device 500 is (n²-n).

The neuron circuit NU[1] is electrically connected to the synapse circuits SU[2, 1] to SU[n, 1] in the first column and the synapse circuits SU[1, 2] to SU[1, n] in the first row.

The neuron circuit NU[k] is electrically connected to the synapse circuits SU[1, k] to SU[n, k] in the k-th column and the synapse circuits SU[k, 1] to SU[k, n] in the k-th row (k is an integer of 2 or more and (n−1) or less).

The neuron circuit NU[n] is electrically connected to the synapse circuits SU[1, n] to SU[n−1, n] in the n-th column and the synapse circuits SU[n, 1] to SU[n, n−1] in the n-th row.

With the above structure, a neural network called a Hopfield network can be formed in the semiconductor device 500.

External input signals DIN[1] to DIN[n] are inputted to the neuron circuits NU[1] to NU[n], respectively, from the outside, and processing is carried out in the semiconductor device 500. The processing results are output from the neuron circuits NU[1] to NU[n] as external output signals DOUT[1] to DOUT[n], respectively.

Note that the external input signals DIN[1] to DIN[n] do no need to be inputted to all the neuron circuits NU[1] to NU[n], and circuits to which input signals are input may be selected from the neuron circuits NU[1] to NU[n] in accordance with the number of necessary input signals. Similarly, the external output signals DOUT[1] to DOUT[n] do not need to be output from all the neuron circuits NU[1] to NU[n], and circuits from which output signals are output may be selected from the neuron circuits NU[1] to NU[n] in accordance with the number of necessary output signals.

The neuron circuit NU[1] outputs a signal S[1] to be inputted to the synapse circuits SU[1, 2] to SU[1, n] in the first row.

The neuron circuit NU[k] outputs a signal S[k] to be inputted to the synapse circuits SU[k,] to SU[k, n] in the k-th row.

The neuron circuit NU[n] outputs a signal S[n] to be inputted to the synapse circuits SU[n, 1] to SU[n, n−1] in the n-th row.

When focusing on the first column, signals S[2] to S[n] are inputted to the synapse circuits SU[2, 1] to SU[n, 1] in the first column, respectively. The synapse circuits SU[2, 1] to SU[n, 1] output signals corresponding to signal strength obtained by multiplying the signals S[2] to S[n] inputted to respective circuits by connection strengths w[2, 1] to w[n, 1]. The connection strength will be described later. Specifically, the synapse circuits SU[2, 1] to SU[n, 1] output signals (currents) I[2, 1] to I[n, 1], respectively. Consequently, a sum signal (current) ΣI[i, 1], i.e., the sum of signals (currents) I[2, 1] to I[n, 1], is inputted to the neuron circuit NU[1]. Note that i used in this paragraph is an integer of 2 or more and n or less.

Similarly, the signals S[1] to S[n] (except the signal S[k]) are inputted to the synapse circuits SU[1, k] to SU[n, k] in the k-th column, respectively. The synapse circuits SU[1, k] to SU[n, k] output signals corresponding to signal strength obtained by multiplying the signals S[1] to S[n] (except the signal S[k]) inputted to the respective circuits by connection strengths w[1, k] to w[n, k], respectively. Specifically, the synapse circuits SU[1, k] to SU[n, k] output the signals (currents) I[1, k] to I[n, k], respectively. Consequently, a sum signal (current) ΣI[i, k], i.e., the sum of signals (currents) I[1, k] to I[n, k], is inputted to the neuron circuit NU[k]. Note that i used in this paragraph is an integer of 1 or more and n or less and is not k.

Similarly, the signals S[1] to S[n−1] are inputted to the synapse circuits SU[1, n] to SU[n−1, n] in the n-th column, respectively. The synapse circuits SU[1, n] to SU[n−1, n] output signals corresponding to signal strength obtained by multiplying the signals S[1] to S[n−1] inputted to the respective circuits by connection strengths w[1, n] to w[n−1, n]. Specifically, synapse circuits SU[1, n] to SU[n−1, n] output signals (currents) I[1, n] to I[n−1, n], respectively. Consequently, a sum signal (current) ΣI[i, n], i.e., the sum of signals (currents) I[1, n] to I[n−1, n], are inputted to the neuron circuit NU[n]. Note that i used in this paragraph is an integer of 1 or more and (n−1) or less.

A connection strength w[i, j] is determined by analog data stored in the synapse circuit SU[i, j]. Here, since the semiconductor device 500 forms a Hopfield network, the connection strength w[i, j] is equivalent to the connection strength w[j, i]. In other words, the analog data of the synapse circuit SU[i, j] can be shared with the synapse circuit SU[j, i]. The synapse circuit SU[i,j] and the synapse circuit SU[j, i] each include an analog memory AM and a writing control circuit WCTL. The semiconductor device 500 can have a structure in which the analog memory AM and the writing control circuit WCTL are shared between the synapse circuits SU[i, j] and SU[j, i]. The semiconductor device having such a structure will be described in detail below.

In this specification, the sum of connection strengths held in all the synapse circuits SU included in the semiconductor device 500 is denoted by a connection strength W in some cases. Furthermore, the connection strength W can be referred to as an n x n square matrix in some cases. In that case, W represents a symmetric matrix with all diagonal elements of 0.

In FIG. 12, only the following elements are illustrated, and the other circuits, wirings, signals, reference numerals and symbols, and the like are not shown: the neuron circuit NU[1]. the neuron circuit NU[2], the neuron circuit NU[k], the neuron circuit NU[n−1], the neuron circuit NU[n], the synapse circuit SU[1, 2], the synapse circuit SU[1, k], the synapse circuit SU[1, n−1], the synapse circuit SU[1, n], the synapse circuit SU[2, 1], the synapse circuit SU[2, k], the synapse circuit SU[2, n−1], the synapse circuit SU[2, n], the synapse circuit SU[k, 1], the synapse circuit SU[k, 2], the synapse circuit SU[k, n−1], the synapse circuit SU[k, n], the synapse circuit SU[n−1, 1], the synapse circuit SU[n−1, 2], the synapse circuit SU[n−1, k], the synapse circuit SU[n−1, n], the synapse circuit SU[n, 1], the synapse circuit SU[n, 2], the synapse circuit SU[n, k], the synapse circuit SU[n, n−1], the signal S[1], the signal S[2], the signal S[k], the signal S[n−1], the signal S[n], the sum signal (current) ΣI[i, 1], the sum signal (current), ΣI[i, 2], the sum signal (current) ΣI[i, k], the sum signal (current) ΣI[i, n−1], the sum signal (current) ΣI[i, n], the external input signal DIN[1], the external input signal DIN[2], the external input signal DIN[k], the external input signal DIN[n−1], the external input signal DIN[n], the external output signal DOUT[1], the external output signal DOUT[2], the external output signal DOUT[k], the external output signal DOUT[n−1], and the external output signal DOUT[n].

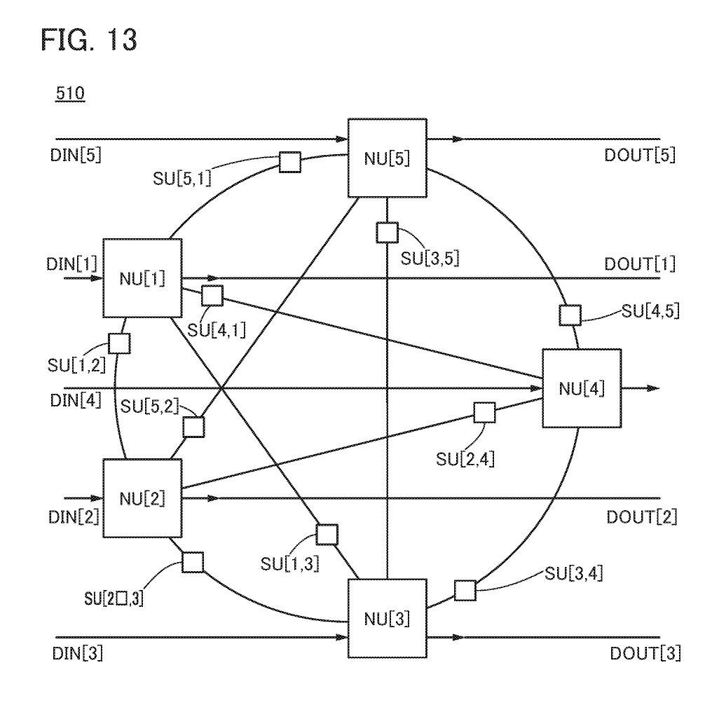

Note that in this configuration example, a circuit configuration in which synapse circuits SU are arranged in a square matrix with a side of n circuits is described: however, one embodiment of the present invention is not limited thereto. For example, the neuron circuits NU[1] to NU[n] may be arranged in a circle, and the synapse circuits SU may be arranged between neuron circuits. FIG. 13 illustrates an example of a circuit configuration where n=5 is satisfied. A semiconductor device 510 illustrated in FIG. 13 includes a neuron circuit NU[1], a neuron circuit NU[2], a neuron circuit NU[3], a neuron circuit NU[4], a neuron circuit NU[5], a synapse circuit SU[1, 2], a synapse circuit SU[1, 3], a synapse circuit SU[2, 3], a synapse circuit SU[2, 4], a synapse circuit SU[3, 4], a synapse circuit SU[3, 5], a synapse circuit SU[4, 5], a synapse circuit SU[4, 1], a synapse circuit SU[5, 1], and a synapse circuit SU[5, 2]. In the semiconductor device 510, when the external input signal DIN[1], the external input signal DIN[2], the external input signal DIN[3], the external input signal DIN[4], and the external input signal DIN[5] are input, the external output signal DOUT[1], the external output signal DOUT[2]. the external output signal DOUT[3]. the external output signal DOUT[4]. and the external output signal DOUT[5] are obtained. In FIG. 13, only connection relationships between the neuron circuits and the synapse circuits included in the semiconductor device 510 are illustrated, and specific lines such as signal transmission lines from the neuron circuits to the synapse circuits and signal transmission lines from the synapse circuits to the neuron circuits are omitted.

[Neuron Circuit]

Next, a neuron circuit will be described.

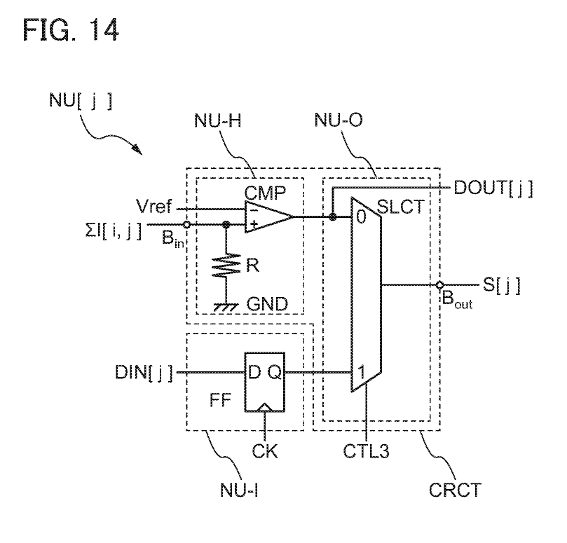

FIG. 14 illustrates a configuration example of the neuron circuit. A neuron circuit NU[j] illustrated in FIG. 14 includes an input neuron circuit portion NU-I, a hidden neuron circuit portion NU-H, and an output neuron circuit portion NU-O. The neuron circuit NU[j] further includes an internal input terminal Bᵢₙ and an internal output terminal Bₒᵤₜ as terminals for receiving and sending signals with the synapse circuits SU. Note that the hidden neuron circuit portion NU-H and the output neuron circuit portion NU-O are collectively referred to as a circuit CRCT.

The hidden neuron circuit portion NU-H includes a comparator CMP and a resistor R.

A non-inverting input terminal of the comparator CMP is electrically connected to a first terminal of the resistor R, and a non-inverting input terminal of the comparator CMP is electrically connected to an internal input terminal Bᵢₙ. A sum signal (current) ΣI[i, j] is inputted to the internal input terminal Bᵢₙ (here, i is an integer of 1 or more and n or less and is not j), and a reference potential Vref is inputted to an inverting input terminal of the comparator CMP. A ground potential GND is inputted to a second terminal of the resistor R

Only a signal generated in the semiconductor device 500 is inputted to the hidden neuron circuit portion NU-H.

In the hidden neuron circuit portion NU-H, the sum signal (current) ΣI[i, j] generated in the semiconductor device 500 is converted into a voltage by the resistor R. Then, the voltage and the reference potential Vref are inputted to the comparator CMP. and a signal corresponding to the comparison result is output from an output terminal of the comparator CMP. Here, when the voltage into which the sum signal (current) ΣI[i,j] is converted by the resistor R exceeds the reference potential Vref, a signal “1” is output from the output terminal of the comparator CMP. This operation result corresponds to “firing” of the neuron circuit. When the voltage into which the sum signal (current) ΣI[i, j] is converted by the resistor R is lower than the reference potential Vref, a signal “0” is output from the output terminal of the comparator CMP.

Note that the reference potential Vref can be determined in accordance with the threshold value of the neuron circuit NU[j] as appropriate.

The external output signals DOUT[1] to DOUT[n] are collectively referred to as expected data in some cases. By inputting data to the semiconductor device 500, connection strengths W corresponding to the data are held in all the synapse circuits, and the external output signals DOUT[1] to DOUT[n] are formed using their connection strengths W.

The input neuron circuit portion NU-I includes a flip-flop circuit FF.

An external input signal DIN is inputted to an input terminal D of the flip-flop circuit FF. an output signal is output from an output terminal Q of the flip-flop circuit FF, and a clock signal CK is inputted to a clock terminal of the flip-flop circuit FF.

The flip-flop circuit FF can hold an external input signal DIN[j] and can output the external input signal DIN[j] from the output terminal Q when the clock signal CK is a high-level potential.

The output neuron circuit portion NU-O includes a selector SLCT

The selector SLCT includes a first input terminal (denoted by “1” in FIG. 14). a second input terminal (denoted by “0” in FIG. 14), an output terminal, and a control signal input terminal. The first input terminal, the second input terminal, and the output terminal of the selector SLCT are electrically connected to the output terminal Q of the flip-flop circuit FF, the output terminal of the comparator CMP, and the internal output terminal Bₒᵤₜ, respectively.

The external output signal DOUT is output from the output terminal of the comparator CMP, and the signal S[j] is output from the output terminal of the selector SLCT. A control signal CTL3 is inputted to the control signal input terminal of the selector SLCT. When the value of the control signal CTL3 is “1”, a signal inputted to the first input terminal is output from the output terminal of the selector SLCT, and when the value of the control signal CTL3 is “0”, a signal inputted to the second input terminal is output from the output terminal of the selector SLCT. Specifically, in first learning described later, when the neuron circuit NU[j] functions as an input neuron, data “1” is input as the control signal CTL3; when the neuron circuit NU[j] functions as a hidden neuron, data “0” is input as the control signal CTL3: and when the neuron circuit NU[j] functions as an output neuron, data “1” is input as the control signal CTL3. In second learning described later, when the neuron circuit NU[j] functions as an input neuron, data “1” is input as the control signal CTL3; when the neuron circuit NU[j] functions as a hidden neuron, data “0” is input as the control signal CTL3: and when the neuron circuit NU[j] functions as an output neuron, data “0” is input as the control signal CTL3. In comparison operation described later, when the neuron circuit NU[j] functions as an input neuron, data “1” is input as the control signal CTL3; when the neuron circuit NU[j] functions as a hidden neuron, data “0” is input as the control signal CTL3; and when the neuron circuit NU[j] functions as an output neuron, data “0” is input as the control signal CTL3.

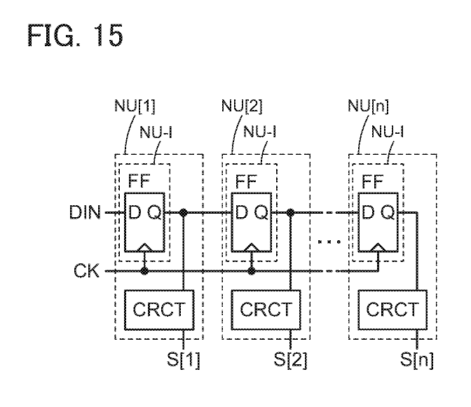

Furthermore, as illustrated in FIG. 15, the number of terminals through which data is input from the outside may be reduced with a shift register formed by connecting flip-flop circuits FF of input neuron circuit portions NU-I of the neuron circuits NU[1] to NU[n]. For example, when the semiconductor device 500 is formed with a small number of chip input terminals, data input from the outside to the semiconductor device 500 can be easily performed by the operation of the shift register. In FIG. 15, only the signals S[1], S[2], and S[n] are illustrated, and the other output signals are omitted. Note that in the case where the number of external input signals is small, a flip-flop circuit FF is not provided and the external input signals may be directly input from a chip input terminal.

[Synapse Circuit]

Next, an example of the synapse circuit is described.

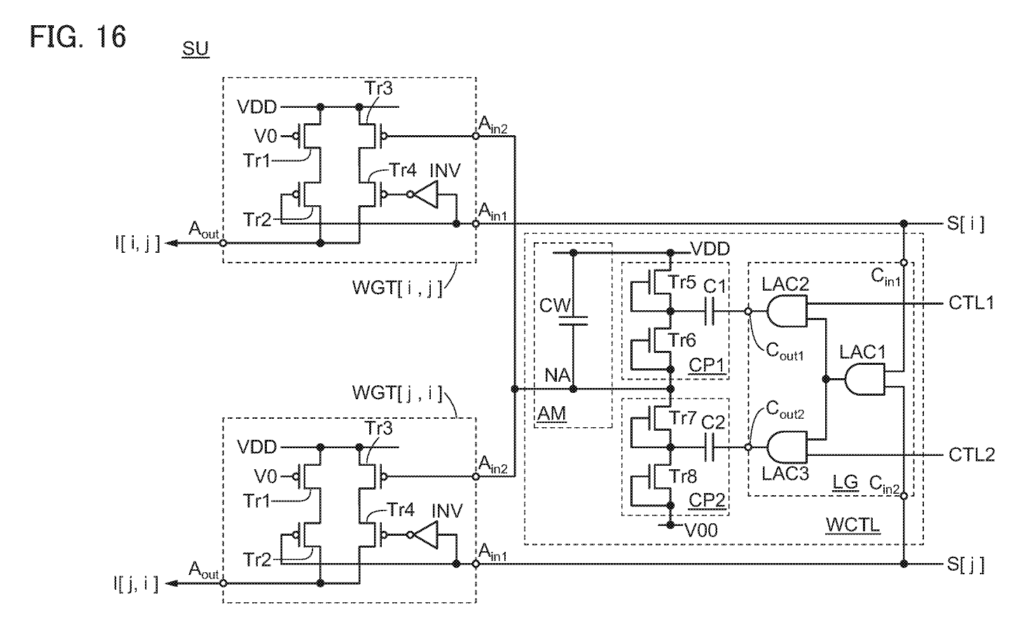

The synapse circuit SU illustrated in FIG. 16 includes the writing control circuit WCTL. a weighting circuit WGT[j, i], and a weighting circuit WGT[i, j]. The writing control circuit WCTL includes an analog memory AM.

As for the example of the synapse circuit SU described here, the writing control circuit WCTL is shared between the synapse circuits SU[j, i] and SU[i, j]. In other words, the analog memory AM included in the writing control circuit WCTL and data held in the analog memory AM are shared. Furthermore, the weighting circuits WGT[j, i] and WGT[i, j] are provided in the synapse circuits SU[j, t] and SU[i, j], respectively. In other words, the writing control circuit WCTL and the weighting circuit WGT[j, i] function as the synapse circuit SU[j, i], and the writing control circuit WCTL and the weighting circuit WGT[i, j] function as the synapse circuit SU[i, j].

The weighting circuit WGT[i, j] includes transistors Tr1 to Tr4, an inverter INV, an internal input terminal Aᵢₙ₁, an internal input terminal Aᵢₙ₂, and an internal output terminal Aₒᵤₜ. Note that the transistors Tr1 and Tr3 are each appropriately biased to operate in a saturation region.

A first terminal of the transistor Tr1 is electrically connected to a first terminal of the transistor Tr2: a first terminal of the transistor Tr3 is electrically connected to a first terminal of the transistor Tr4; and a second terminal of the transistor Tr2 is electrically connected to a second terminal of the transistor Tr4 and the internal output terminal Aₒᵤₜ. A gate of the transistor Tr2 is electrically connected to an input terminal of the inverter INV and the internal input terminal Aᵢₙ₁; a gate of the transistor Tr4 is electrically connected to an output terminal of the inverter INV: and a gate of the transistor Tr3 is electrically connected to a node NA in the analog memory AM through the internal input terminal Aᵢₙ₂.

A potential VDD is inputted to a second terminal of the transistor Tr1 and a second terminal of the transistor Tr3, and a potential V0 is inputted to a gate of the transistor Tr1.

For the description of the configuration of the weighting circuit WGT[j, i], the above description of the weighting circuit WGT[i, j] is referred to.

In the weighting circuit WGT[i, j], the signal S[i] from the neuron circuit NU[i] is inputted to the input terminal of the inverter INV and the gate of the transistor Tr2 as an input signal. The signal (current) I[i, j] is output from the second terminal of the transistor Tr2 or the second terminal of the transistor Tr4 in accordance with the value of the signal S[i].

In the weighting circuit WGT[j, i], the signal S[j] from the neuron circuit NU[j] is inputted to the input terminal of the inverter INV and the gate of the transistor Tr2 as an input signal. The signal (current) I[b, i] is output from the second terminal of the transistor Tr2 or the second terminal of the transistor Tr4 in accordance with the value of the signal S[j].

The analog memory AM includes a capacitor CW and the node NA.

A first terminal of the capacitor CW is electrically connected to the node NA. The potential VDD is inputted to a second terminal of the capacitor CW.

A potential corresponding to a connection strength w[i, j] is held by the capacitor CW in the analog memory AM.

The writing control circuit WCTL includes, in addition to the above-described analog memory AM. a charge pump circuit CP1, a charge pump circuit CP2. and a logic circuit LG.

The charge pump circuit CP1 includes a transistor Tr5, a transistor Tr6, and a capacitor C1. The charge pump circuit CP2 includes a transistor Tr7, a transistor Tr8, and a capacitor C2. The logic circuit LG includes AND circuits LAC to LAC3, an internal input terminal Cᵢₙ₁, an internal input terminal Cᵢₙ₂, an internal output terminal Cₒᵤₜ₁, and an internal output terminal Cₒᵤₜ₂.

A first terminal of the transistor Tr5 is electrically connected to a gate of the transistor Tr5, a first terminal of the transistor Tr6, and a first terminal of the capacitor C1. A second terminal of the transistor Tr6 is electrically connected to a gate of the transistor Tr6, a first terminal of the transistor Tr7, and the node NA in the analog memory AM. A second terminal of the transistor Tr7 is electrically connected to a gate of the transistor Tr7, a first terminal of the transistor Tr8, and a first terminal of the capacitor C2. A second terminal of the transistor Tr8 is electrically connected to a gate of the transistor Tr8. A second terminal of the capacitor C1 is electrically connected to the internal output terminal Cₒᵤₜ₁, and a second terminal of the capacitor C2 is electrically connected to the internal output terminal Cₒᵤₜ₂.

In the synapse circuit in FIG. 16, the transistors Tr1 to Tr4 are p-channel transistors and the transistors Tr5 to Tr8 are n-channel transistors.

The potential VDD is inputted to a second terminal of the transistor Tr5, and a potential V00 is inputted to the second terminal and gate of the transistor Tr8. Note that the potential VDD is higher than the potential V0, and the potential V00 is lower than the potential V0.

A first input terminal of the AND circuit LAC is electrically connected to the internal input terminal Cᵢₙ₁; a second input terminal of the AND circuit LAC1 is electrically connected to the internal input terminal Cᵢₙ₂; and an output terminal of the AND circuit LAC1 is electrically connected to a first input terminal of the AND circuit LAC2 and a first input terminal of the AND circuit LAC3. An output terminal of the AND circuit LAC2 is electrically connected to the internal output terminal Cₒᵤₜ₁, and an output terminal of the AND circuit LAC3 is electrically connected to the internal output terminal Cₒᵤₜ₂.

The signal S[i] from the neuron circuit NU[i] is inputted to the internal input terminal Cᵢₙ₁, and the signal S[j] from the neuron circuit NU[j] is inputted to the internal input terminal Cᵢₙ₂. A control signal CTL1 is inputted to a second input terminal of the AND circuit LAC2, and a control signal CTL2 is inputted to a second input terminal of the AND circuit LAC3.

As each of the transistors Tr5 to Tr8 in the writing control circuit WCTL, a transistor including an oxide semiconductor in a channel formation region, i.e., an OS transistor, is preferably used. When formed using OS transistors, the transistors Tr5 to Tr8 can have extremely low off-state currents. In other words, leakage current which is generated in the transistors Tr5 to Tr8 in an off state can be extremely reduced. Thus, charge retention characteristics of the capacitor CW can be improved. Furthermore, regular refresh operation for data retention is not necessary, which leads to a reduction in power consumption. In addition, a circuit for refresh operation does not need to be provided, which leads to a reduction in chip area in the semiconductor device 500. The structure of the OS transistor will be described in Embodiment 6.

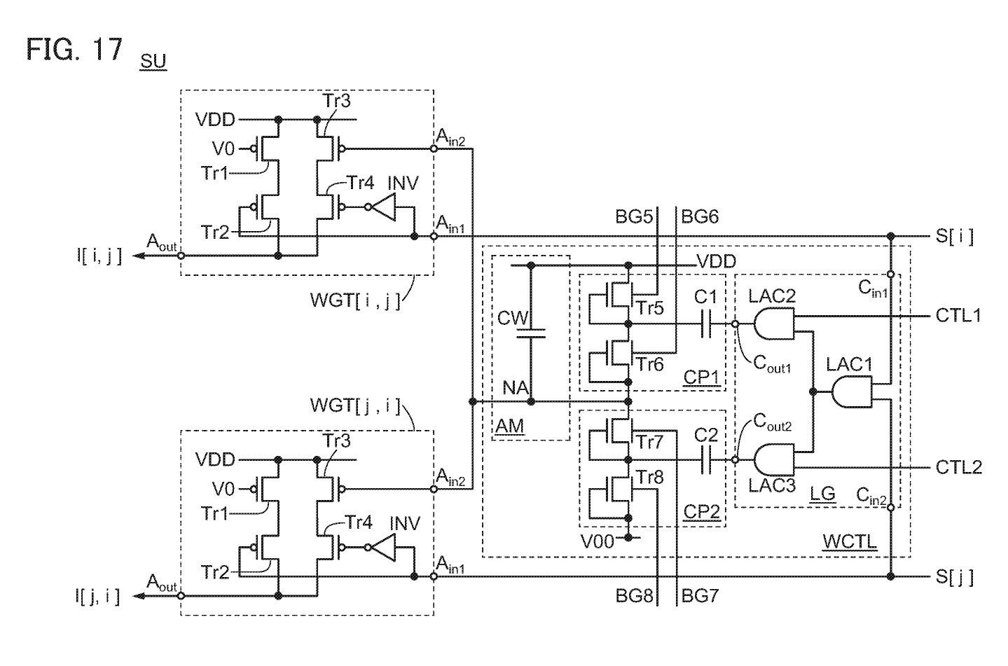

In the synapse circuit SU, a back gate may be provided in each of the transistors Tr5 to Tr8 as illustrated in FIG. 17. A back gate of the transistor Tr5 is electrically connected to a wiring BG5: a back gate of the transistor Tr6 is electrically connected to a wiring BG6; a back gate of the transistor Tr7 is electrically connected to a wiring BG7; and a back gate of the transistor Tr8 is electrically connected to a wiring BG8. With such a configuration, voltages can be inputted to the back gates of the transistors Tr5 to Tr8 through the wirings BG5 to BG8, and threshold voltages of the transistors Tr5 to Tr8 can be controlled.

In the synapse circuit SU illustrated in FIG. 16, the transistors Tr1 to Tr4 are p-channel transistors; however, one embodiment of the present invention is not limited thereto. In the synapse circuit SU, the transistors Tr1 to Tr4 may be n-channel transistors.

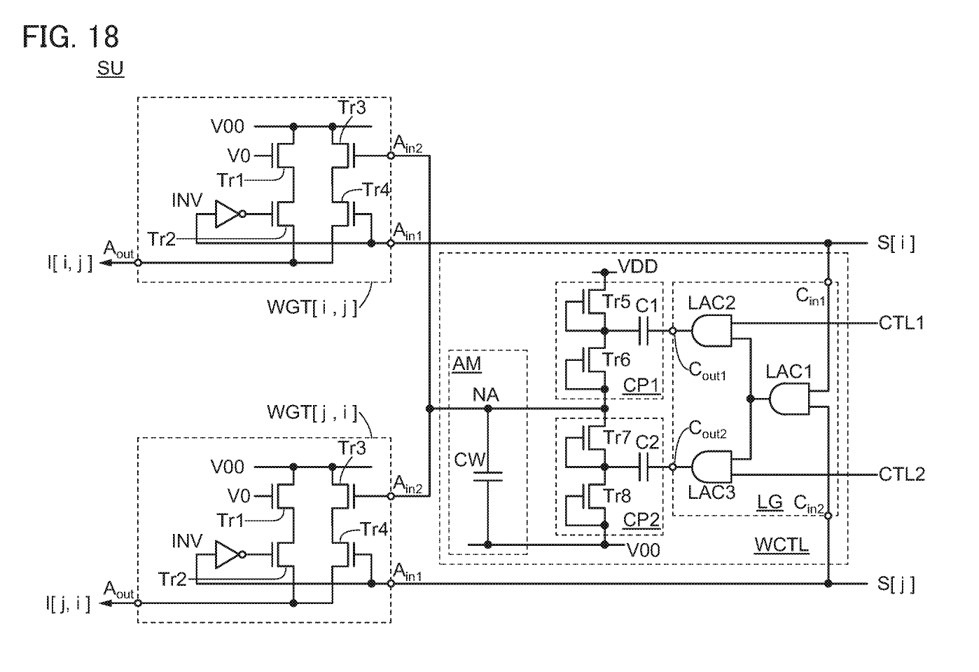

FIG. 18 illustrates a circuit configuration of the synapse circuit SU where the transistors Tr1 to Tr4 are n-channel transistors. The first terminal of the transistor Tr1 is electrically connected to the first terminal of the transistor Tr2: the first terminal of the transistor Tr3 is electrically connected to the first terminal of the transistor Tr4: and the second terminal of the transistor Tr2 is electrically connected to the second terminal of the transistor Tr4. The gate of the transistor Tr4 is electrically connected to the input terminal of the inverter INV; the gate of the transistor Tr2 is electrically connected to the output terminal of the inverter INV; and the gate of the transistor Tr3 is electrically connected to the node NA in the analog memory AM.

The potential V00 is inputted to the second terminal of the transistor Tr1 and the second terminal of the transistor Tr3, and the potential V0 is inputted to the gate of the transistor Tr1.

For the description of the configuration of the weighting circuit WGT[j, i], the above description of the weighting circuit WGT[i, j] is referred to.

In the weighting circuit WGT[i, j], the signal S[i] from the neuron circuit NU[i] is inputted to the input terminal of the inverter INV and the gate of the transistor Tr4 as an input signal. The signal (current) I[i, j] is output from the second terminal of the transistor Tr2 or the second terminal of the transistor Tr4 in accordance with the value of the signal S[i].

In the weighting circuit WGT[j, i], the signal S[j] from the neuron circuit NU[j] is inputted to the input terminal of the inverter INV and the gate of the transistor Tr4 as an input signal. The signal (current) I[j, i] is output from the second terminal of the transistor Tr2 or the second terminal of the transistor Tr4 in accordance with the value of the signal S[j].

The analog memory AM includes the capacitor CW and the node NA.

The first terminal of the capacitor CW is electrically connected to the node NA. The potential V00 is inputted to the second terminal of the capacitor CW.

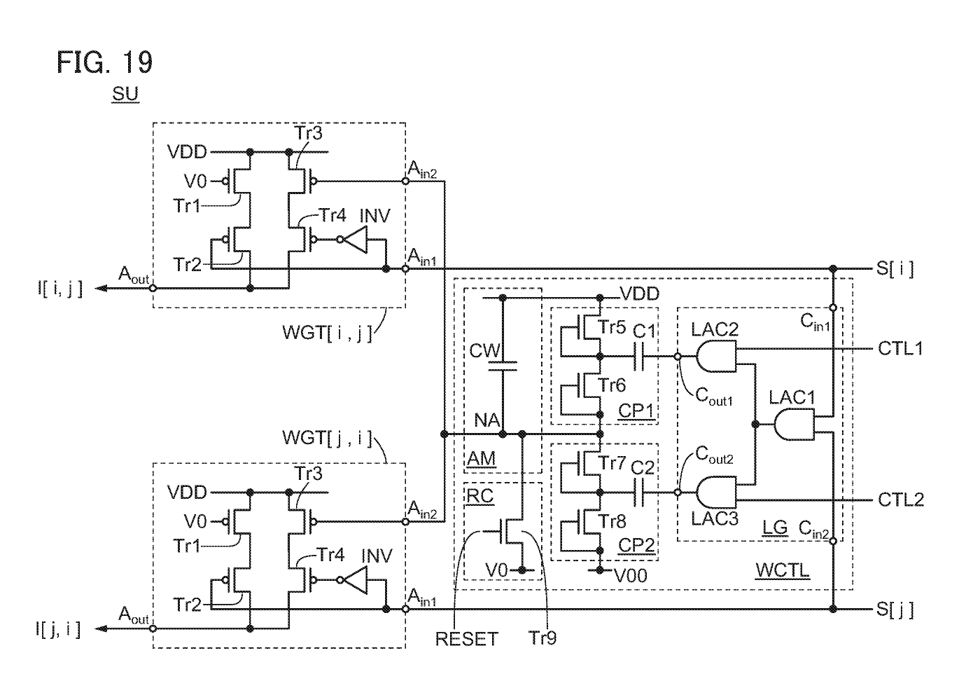

The synapse circuit may include a reset circuit for initializing the potential held in the analog memory AM in the synapse circuit SU. FIG. 19 illustrates a circuit configuration where a reset circuit RC is provided in the synapse circuit SU in FIG. 16.

The writing control circuit WCTL includes the reset circuit RC, and the reset circuit RC includes a transistor Tr9. A first terminal of the transistor Tr9 is electrically connected to the node NA in the analog memory AM; a second terminal of the transistor Tr9 is electrically connected to a wiring through which the potential V0 is supplied: and a gate of the transistor Tr9 is electrically connected to a wiring RESET.

To initialize the semiconductor device 500, a high-level potential is inputted to the wiring RESET so that the transistor Tr9 is turned on. and the potential of the node NA is set to V0. The reset circuit RC enables easy initialization of the potential held in the analog memory. A structure where an arbitrary value can be set to each of the nodes NA after the initialization may be employed. Different values may be set to the nodes NA.

Next, an operation example of the synapse circuit SU in FIG. 16 is described.

When the signal S[i] from the neuron circuit NU[i] is inputted to the synapse circuit SU, the weighting circuit WGT[i, j] outputs the signal (current) I[i,j] corresponding to signal strength obtained by multiplying the signal S[i] by the connection strength w[i,j].

Since the weighting circuits WGT[i,j] and WGT[i, i] output currents, the sum of output signals of the plurality of synapse circuits SU can be easily obtained by sharing the output signal line between the plurality of synapse circuits SU. For example, as illustrated in FIG. 12. when an output signal line is shared between the synapse circuits SU[2, I] to SU[n, 1] in the first column, a sum signal (current) ΣI[i, 1] that is the sum of output signals can be easily inputted to the neuron circuit NU[1] (here, i is an integer of 2 or more and n or less). Similarly, when an output signal line is shared between the synapse circuits SU[1, k] to SU[n, k] in the k-th column, the sum signal (current) ΣI[i, k] that is the sum of output signals can be easily inputted to the neuron circuit NU[k] (here, i is an integer of 1 or more and n or less and is not k). Similarly, when an output signal line is shared between the synapse circuits SU[1, n] to SU[n−1, n] in the n-th column, the sum signal (current) ΣI[i, n] that is the sum of output signals can be easily inputted to the neuron circuit NU[n] (here, i is an integer of 1 or more and (n−1) or less).

The signal S[i] inputted to the weighting circuit WGT[i, j] is inputted to the gate of the transistor Tr2 and to the gate of the transistor Tr4 through the inverter INV. thus, the signal S[i] can control on/off states of the transistors Tr2 and Tr4. When the signal S[i] is “0”, the transistor Tr2 is turned on and the transistor Tr4 is turned off, so that the signal (current) I₀ corresponding to the potential V0 is output from the weighting circuit WGT[i, j] as the signal (current) I[i,j] through the transistors Tr1 and Tr2. Note that I₀ refers to a reference current in the weighting circuit WGT[i, j]. and the potential V0 is set so that the corresponding current I₀ flows in the case where the signal (current) w[i, j]S[i] is “0”. When the signal S[i] is “1”, the transistor Tr2 is turned off and the transistor Tr4 is turned on, so that the signal (current) w[i, j]S[i] corresponding to the potential of the node NA is output from the weighting circuit WGT[i, j] as the signal (current) I[i, j] through the transistors Tr3 and Tr4. In the case where the potential of the node NA is set to V0 after the initialization, when the signal S[i] is “1”, in the synapse circuit SU, the signal (current) I₀ that is a reference current is output from the weighting circuit WGT[i,j] as the signal (current) I[i,j].

The signal (current) w[i, j]S[i] output when the signal S[i] is “1′” is determined depending on the potential of the node NA. For example, the lower the potential of the node NA is, the higher the output signal (current) w[i, j]S[i] is, and the higher the potential of the node NA is, the lower the output signal (current) w[i,j]S[i] is.

The lower the potential of the node NA is, the higher the signal (current) w[i, j]S[i] is, and a voltage applied to the resistor R in the hidden neuron circuit portion NU-H is increased. This is because of a high connection strength w[i, j]. By contrast, the higher the potential of the node NA is, the lower the signal (current) w[i,j]S[i] is, and a voltage applied to the resistor R in the hidden neuron circuit portion NU-H is decreased. This is because of a low connection strength w[i, j].

The weighting circuit WGT[j, i] operates in a manner similar to that of the weighting circuit WGT[i, j]. When the signal S[i] input from the neuron circuit NU[j] to the synapse circuit SU is “0”, the signal (current) I₀ corresponding to the potential V0 is output as the signal (current) I[j, i], and when the signal S[j] is “1”, the signal (current) w[j, i]S[j] corresponding to the signal strength obtained by multiplying the signal S[j] by the connection strength w[j, i] is output as the signal (current) I[j, i].

The signal S[j] inputted to the weighting circuit WGT[j, i] is inputted to the gate of the transistor Tr2 and to the gate of the transistor Tr4 through the inverter INV; thus, the signal S[j] can control on/off states of the transistors Tr2 and Tr4. When the signal S[j] is “0,” the transistor Tr2 is turned on and the transistor Tr4 is turned off, so that the signal (current) I₀ corresponding to the potential V0 is output from the weighting circuit WGT[/, i] through the transistors Tr1 and Tr2. Here, the signal (current) I₀ refers to a reference current in the weighting circuit WGT[j, i]. For the signal (current) I₀, the description of the weighting circuit WGT[i, j] is referred to. When the signal S[j] is “1”, the transistor Tr2 is turned off and the transistor Tr4 is turned on, so that the signal (current) w[j, i]S[j] corresponding to the potential of the node NA is output from the weighting circuit WGT[/, i] as the signal (current) I[j, i] through the transistors Tr3 and Tr4. In the case where the potential of the node NA is V0 after the initialization, when the signal S[i] is “1,” in the synapse circuit SU, the signal (current) I₀ that is a reference current is output from the weighting circuit WGT[i,j] as the signal (current) I[i, j].

The signal (current) w[j, i]S[j] output when the signal S[j] is “1” is determined depending on the potential of the node NA. For example, the lower the potential of the node NA is, the higher the output signal (current) w[j, i]S[j] is, and the higher the potential of the node NA is, the lower the output signal (current) w[j, i]S[i] is.

The lower the potential of the node NA is, the higher the signal (current) w[j, i]S[j] is. and a voltage applied to the resistor R in the hidden neuron circuit portion NU-H is increased. This is because of a high connection strength w[j, i]. By contrast, the higher the potential of the node NA is, the lower the signal (current) w[j, i]S[j] is, and a voltage applied to the resistor R in the hidden neuron circuit portion NU-H is decreased. This is because of a low connection strength w[j, i].

The potential of the node NA of the analog memory AM can be changed in the range from the potential V00 to the potential VDD by the operation of the writing control circuit WCTL. Specifically, the potential of the node NA can be decreased by the charge pump circuit CP1 in the writing control circuit WCTL or the potential of the node NA can be increased by the charge pump circuit CP2 in the writing control circuit WCTL.

Note that using OS transistors as the transistors Tr5 to Tr8 is a preferable way to improve the efficiency of the charge pump circuits CP1 and CP2. Since the OS transistor has an extremely low off-state current, the potential of the node NA in the analog memory AM can be retained by the OS transistor for a long time. Furthermore, back gates are preferably provided in the transistors Tr5 to Tr8 as illustrated in FIG. 17. The transistors Tr5 to Tr8 including back gates can have higher on-state currents.

The writing control circuit WCTL operates by receiving the signal S[i] from the neuron circuit NU[i], the signal S[j] from the neuron circuit NU[j], the control signal CTL1, and the control signal CTL2. In other words, when these signals are received, the charge pump circuit CP1 or the charge pump circuit CP2 can be operated.

When the signal S[i] from the neuron circuit NU[i] is “1” and the signal S[j] from the neuron circuit NU[j] is “1”, they are inputted to the first input terminal and the second input terminal of the AND circuit LAC1; consequently, a signal “1” is output from the output terminal of the AND circuit LAC1. In that case, the signal “1” is inputted to the first input terminal of the AND circuit LAC2 and the first input terminal of the AND circuit LAC3.

In this state, when the control signal CTL1 inputted to the second input terminal of the AND circuit LAC2 is “1”, the signal “1” is outputted to the output terminal of the AND circuit LAC2; and when the control signal CTL1 inputted to the second input terminal of the AND circuit LAC2 is “0”, the signal “0” is outputted to the output terminal of the AND circuit LAC2. In other words, when the control signal CTL1 is a pulse signal, the charge pump circuit CP1 operates and the potential of the node NA can be decreased.

On the other hand, when the control signal CTL2 inputted to the second input terminal of the AND circuit LAC3 is “1”, the signal “1′” is outputted to the output terminal of the AND circuit LAC3: and when the control signal CTL2 inputted to the second input terminal of the AND circuit LAC3 is “0”, the signal “0” is outputted to the output terminal of the AND circuit LAC3. In other words, when the control signal CTL2 is a pulse signal, the charge pump circuit CP2 operates and the potential of the node NA can be increased.

In other words, when the signal S[i] of “1′” and the signal S[j] of “1” are input and the pulsed control signal CTL1 is inputted to the synapse circuits SU, the potential of the node NA corresponding to the connection strength w[j, i] held in the analog memory AM is decreased, so that the connection strength w[j, i] is increased. When the signal S[i] of “1” and the signal S[j] of “1” are input and the pulsed control signal CTL2 is inputted to the synapse circuits SU, the potential of the node NA corresponding to the connection strength w[j, i] held in the analog memory AM is increased, so that the connection strength w[j, i] is decreased. Therefore, when the connection strength w[j, i] is increased, the signal (current) w[j, i]S[j] output from the weighting circuit WGT[j, i] is increased, and when the connection strength w[j, i] is decreased, the signal (current) w[j, i]S[j] output from the weighting circuit WGT[j, i] is decreased.

Note that in the case where the synapse circuit SU is initialized, the following setting is effective: at least one of the signal S[i] and the signal S[j] is “0”; a pulse signal is input as the control signal CTL1; and the connection strength w[j, i] becomes low. Alternatively, the following setting is effective: at least one of the signal S[i] and the signal S[j] is “0”; a pulse signal is input as the control signal CTL2; and the connection strength w[j, i] becomes high.

Here, as the principle of the semiconductor device 500 in which a neural network is formed, first learning, second learning, and convergence of a connection strength W are described.

The first learning refers to operation in which the control signal CTL3 of “l” is inputted to the neuron circuit NU corresponding to the input neuron and output neuron and a pulse signal is input as the control signal CTL1. In other words, by the first learning, the charge pump circuit CP1 operates to increase the connection strength w[i, j]. Note that when at least one of the signal S[i] and the signal S[i] is “0”, the connection strength w[i,j] is not updated.

The second learning refers to operation in which the control signal CTL3 of “0” is inputted to the neuron circuit NU corresponding to the output neuron and a pulse signal is input as the control signal CTL2. In other words, by the second learning, the charge pump circuit CP2 operates to increase the connection strength w[i, j]. Note that when at least one of the signal S[i] and the signal S[j] is “0”, the connection strength w[i,j] is not updated.

Energy E of the network of the connection strength W where the semiconductor device 500 forming the Hopfield neural network circuit uses external input signals DIN[1] to DIN[n](learning data) is represented by Formula 1.

$$\begin{matrix}[ Formula 1 ] & \\ E = - \frac{1}{2} {\sum }_{j = 1}^{n} {\sum }_{i \neq j}^{n} {w}_{ji} {O}_{j} {O}_{i} + {\sum }_{j = 1}^{n} {θ}_{j} {O}_{j} & ( 1 )\end{matrix}$$

It is known that output of the Hopfield network is changed, which leads to a reduction in the energy E of the network.

In Formula 1, wⱼᵢ corresponds to the connection strength w[i, j] of the synapse circuit SU[i, j], Oᵢ corresponds to an external output signal DOUT[i], i.e., expected data, and θⱼ corresponds to the threshold value of the neuron circuit NU[j]. In the semiconductor device 500, the threshold value corresponds to the reference potential Vref.

When the external output signal DOUT[i] is 1, Oᵢ is set to “1”, and when the external output signal DOUT[i] is 0, Oᵢ is set to “−1”.

In the sum of first terms in Formula 1, as the number of combinations of i and j where Oᵢ and Oⱼ, i.e., both of the external output signals DOUT[i] and DOUT[j], are “1” or “−1” is large, the energy E becomes lower and the network is more stable. By contrast, as the number of combinations of i and j where one of the external output signals DOUT[i] and DOUT[j] is “1” and the other thereof is “−1” is large, the energy E becomes higher and the network is more unstable. In other words, when the neuron circuit NU[i] and the neuron circuit NU[j] are fired and strongly connected to each other, or not fired and strongly connected, the network is stable.

Furthermore, in the second term in Formula 1, the level of the energy E is determined by the product of the threshold value θⱼ and the external output signal DOUT[i]. For example, in the case where the threshold value θⱼ required for “firing” of the neuron circuit NU[i] is high, the energy E of the network when the neuron circuit NU[i] is “fired” becomes high and the energy E of the network when the neuron circuit NU[i] is not “fired” becomes low.

Here, the energy E when ΣθⱼOⱼ of the threshold value θⱼ of the neuron circuit NU is the reference level of the energy is represented by the following formula.

$$\begin{matrix}[ Formula 2 ] & \\ E = - \frac{1}{2} {\sum }_{j = 1}^{n} {\sum }_{i \neq j}^{n} {w}_{ji} {O}_{j} {O}_{i} & ( 2 )\end{matrix}$$

In Formula 2, as in Formula 1, as the number of combinations of i and j where both of the external output signals DOUT[i] and DOUT[j] are “1” or “−1” is large, the energy E becomes lower and the network is more stable. By contrast, as the number of combinations of i and j where one of the external output signals DOUT[i] and DOUT[j] is “1′” and the other thereof is “−1” is large, the energy E becomes higher and the network is more unstable.

In the case where Formula 2 is used, since the threshold value θⱼ is 0, the energy E of the Hopfield network is determined by only the external output signal DOUT[i], the external output signal DOUT[j], and the connection strength w[i, j].

Here, the case where the first learning is repeated is described. By repeating the first learning, the connection strength w[i, j] when both of the signals S[i] and S[j] are “1” is increased. By this operation, expected data and the connection strength W are each converged to a certain value, so that the energy E becomes the local minimum value in Formula 1 or Formula 2.

Meanwhile, the case where the second learning is repeated is described. By repeating the second learning, the connection strength w[i, j] when both of the signals S[i] and S[j] are “1” is decreased. In other words, when the connection strength W is decreased, the energy E is increased in Formula 1 or Formula 2.

The second learning is performed to obtain a connection strength W and expected data of the network corresponding to the energy E which has the minimum value in a wide range in the energy function obtained by Formula 1 or Formula 2. The energy function obtained by Formula 1 or Formula 2 has a plurality of energies E that are the local minimum values in some cases, and there is a possibility that only performing the first learning repeatedly does not reach the energy E which has the minimum value in a wide range. Therefore, the energy E that has a converged local minimum value is temporarily increased by performing the second learning as appropriate; thus, the energy E can be transferred to energy E that has another local minimum value.

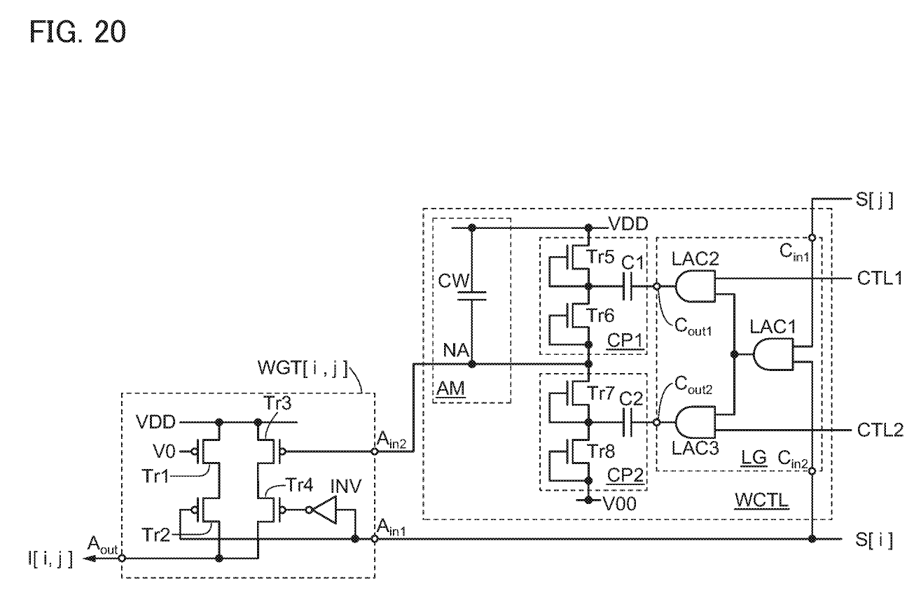

As for the structure and operation of the synapse circuit SU. the synapse circuit SU illustrated in FIG. 16 is described as an example; however, one embodiment of the present invention is not limited thereto. For example, a synapse circuit SU illustrated in FIG. 20 may be used. FIG. 20 illustrates a structure where the analog memory AM and the writing control circuit WCTL are not shared between the synapse circuits SU[j, i] and SU[i, j], and specifically, each synapse circuit SU[i, j] includes the analog memory AM and the writing control circuit WCTL. Note that the updating is performed so that the potential of the node NA in the analog memory AM in the synapse circuit SU[j, i] and the potential of the node NA in the analog memory AM in the synapse circuit SU[i, j] have the same value. With such a structure, physical symmetrical arrangement of neurons and synapses can be easily made.

Note that a circuit configuration of the charge pump circuits CP1 and CP2 included in the synapse circuit SU. the analog memory, and the weighting circuits WGT[i, j] and WGT[j, i] is described using the circuit configuration illustrated in FIG. 16 as an example: however, one embodiment of the present invention is not limited thereto. For example, the circuit configuration of the logic circuit LG illustrated in FIG. 16 may be changed by using a circuit equivalent to the logic circuit LG illustrated in FIG. 16. For example, the circuit configuration of the charge pump circuit CP1 or CP2 illustrated in FIG. 16 may be changed by using a circuit equivalent to the charge pump circuit CP1 or CP2 illustrated in FIG. 16. For example, in the analog memory AM illustrated in FIG. 16, the capacitor CW is not provided and parasitic capacitance formed of a wiring of the node NA and a wiring through which the potential VDD is supplied may be provided instead of the capacitor CW.

<Operation Example 2 of Semiconductor Device>

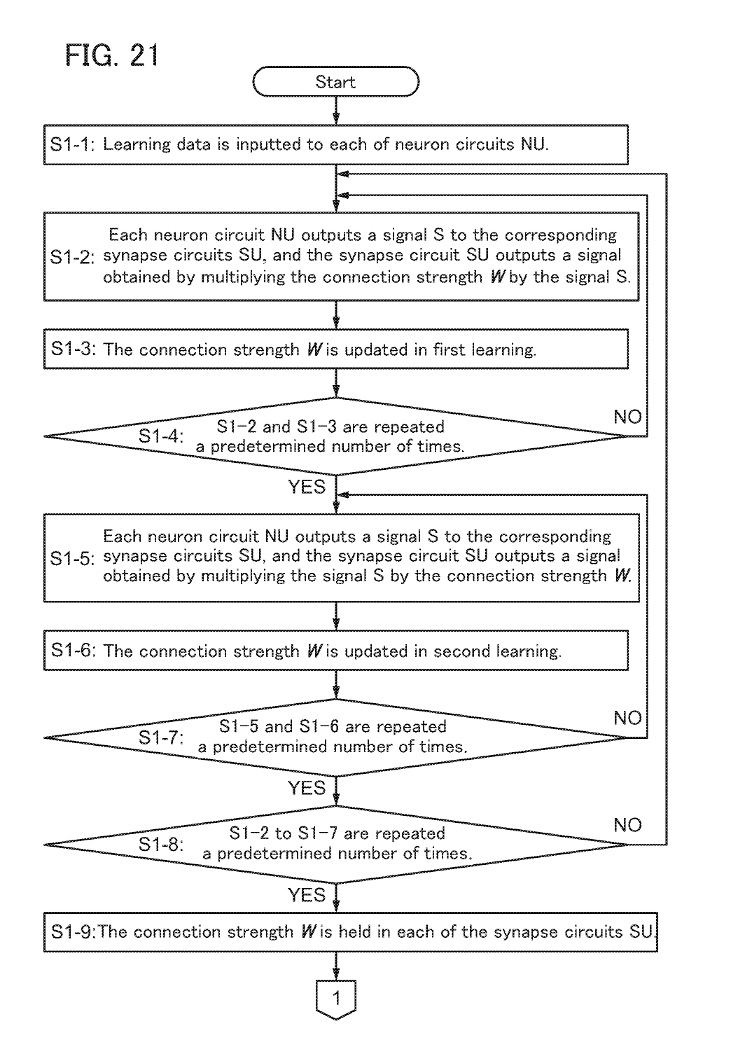

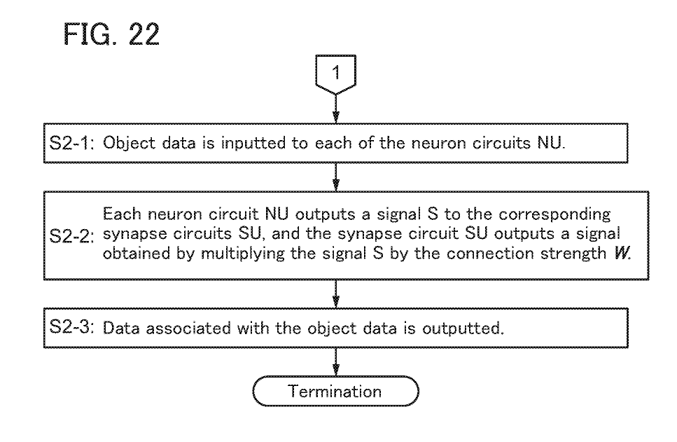

Here, an operation example of the semiconductor device 500 is described. The operation here refers to operation in which learning data is inputted to the semiconductor device 500 so that the semiconductor device 500 learns the learning data, object data is inputted to the semiconductor device 500, and determination whether the learning data and the object data match, are similar, or mismatch is made. Note that in this specification and the like, the phrase “the data are similar” indicates the case where the object data and the learning data are not the same as each other but can be regarded as substantially the same. Here, substantially the same data indicates the case where although the object data and the learning data in large regions match, there are mismatches between the object data and the learning data in small regions. FIG. 21 and FIG. 22 are flowcharts of the operation of the semiconductor device 500. Note that the operation example of the semiconductor device 500 including the neuron circuit NUIil illustrated in FIG. 14 and the synapse circuit SU illustrated in FIG. 16 is described here.

First, operation where the semiconductor device 500 learns data is described with reference to FIG. 21.

[Step S1-1]

In Step S1-1, learning data is input from the outside to the neuron circuit NU. Note that leaning data is represented in binary here, and the number of neuron circuits to which learning data is input is determined in accordance with the number of bits of the learning data. Therefore, the semiconductor device 500 preferably has a structure in which input/output of data to neuron circuits to which data is not necessarily input/output is electrically disconnected. Here, the volume of learning data is n-bits and the value of an i-th bit of learning data is denoted by learning data [i]. Learning data [1] to [n] are inputted to the neuron circuits NU[1] to NU[n], respectively. The learning data [i] is inputted to the neuron circuit NU[i] as the external input signal DIN[i].

[Step S1-2]

In Step S1-2, the clock signal CK which is a high-level potential is inputted to the flip-flop circuit FF, and the control signal CTL3 of “1” is inputted to the selector SLCT. Thus. the neuron circuit NU[i] corresponding to the input neuron and the output neuron outputs a signal corresponding to the learning data [i] as the signal S[i]. The output signal S[i] is inputted to the synapse circuits SU[i, 1] to SU[i, n]. Note that signals S[1] to S[n] are collectively referred to as a signal S in the flowchart of FIG. 21. The signal S can be expressed as signals in 1×n matrix or signals in n×1 matrix in some cases.

Thus, the signal S corresponding to the learning data is inputted to the corresponding synapse circuits SU in the neuron circuits NU[1] to NU[n].

The synapse circuit SU[i, j] outputs the current I[i, j] corresponding to the signal S[i] by receiving the signal S[i]. Thus, the sum current ΣI[i, j] output from all the synapse circuits SU in the j-th column is inputted to the neuron circuit NU[j].

[Step S1-3]

In Step S1-3, the connection strength W is updated in the first learning. Therefore, when both of the signal S[i] and the signal S[j] inputted to the synapse circuit SU[i, j] are “1”, the connection strength w[i, j] is increased. When at least one of the signal S[i] and the signal S[j] inputted to the synapse circuit SU[i,j] is “0”, the connection strength w[i,j] is not updated. In the case where the connection strength w[i, j] is increased, the current I[i, j] output from the synapse circuit SU[i,j] is increased.

[Step S1-4]

In Step S1-4, determination whether a predetermined number of times of Step S1-2 and Step S1-3 has been repeated is made. When the predetermined number of times is satisfied, the process proceeds to Step S1-5, and when the predetermined number of times is not satisfied, the process returns to Step S1-2 and processing is performed again.

Note that the predetermined number of times is ideally the number of repetition times to obtain stable energy of the network; however, it may be an arbitrary number empirically determined.

[Step S1-5]

In Step S1-5, the control signal CTL3 of “0” is inputted to the selector SLCT in the neuron circuit NUil corresponding to the output neuron, and the control signal CTL3 of “1” is inputted to the selector SLCT in the neuron circuit NU[i] corresponding to the input neuron. Thus, the neuron circuit NU[i] outputs a signal corresponding to data output from the hidden neuron circuit portion NU-H as the signal S[i]. The output signal S[i] is inputted to the synapse circuits SU[i, 1] to SU[i, n].

Thus, the signal S corresponding to the learning data is inputted to the corresponding synapse circuits SU in the neuron circuits NU[1] to NU[n].

The synapse circuit SU[i,j] outputs the current I[i, j] corresponding to the signal S[i] by receiving the signal S[i]. Thus, the sum current ΣI[i,j] output from all the synapse circuits SU in the j-th column is inputted to the neuron circuit NU[j].

[Step S1-6]

In Step S1-6, the connection strength W is updated in the second learning. Therefore, when both of the signal S[i] and the signal S[j] inputted to the synapse circuit SU[i, j] are “1”, the connection strength w[i, j] is decreased. When at least one of the signal S[i] and the signal S[j] inputted to the synapse circuit SU[i, j] is “0”, the connection strength w[i, j] is not updated. In the case where the connection strength w[i, j] is decreased, the current I[i, j] output from the synapse circuit SU[i,j] is decreased.

[Step S1-7]

In Step S1-7, determination whether a predetermined number of times of Step S1-5 and Step S1-6 has been repeated is made. When the predetermined number of times is satisfied, the process proceeds to Step S1-8, and when the predetermined number of times is not satisfied, the process returns to Step S1-5 and processing is performed again.

Note that the predetermined number of times is ideally the number of repetition times to obtain the energy which is not locally minimum energy, however, it may be an arbitrary number empirically determined.

[Step S1-8]

In Step S1-8, determination whether a predetermined number of times of Step S1-2 to Step S1-7 has been repeated is made. When the predetermined number of times is satisfied, the process proceeds to Step S1-9, and when the predetermined number of times is not satisfied, the process returns to Step S1-2 and processing is performed again.

Note that the predetermined number of times is ideally the number of repetition times to obtain stable energy of the network; however, it may be an arbitrary number empirically determined.

[Step S1-9]

In Step S1-9, the connection strength W of the network in accordance with the learning data, which is obtained by performing Step S1-2, Step S1-3, and Step S1-5 a predetermined number of times, is held, and expected data thereof is obtained. After that, the process proceeds to Step S2-1 to perform comparison.

As described above, in the Hopfield network, the connection strength W of the network is converged to a certain value or a certain matrix in some cases by performing Step S1-2 to Step S1-8 repeatedly. The network when the connection strength W is converged can be regarded as being in a stable state, and the stable state of the network corresponding to the input learning data is stored.

Next, operation in which object data is inputted to the semiconductor device 500 where data is learned in advance and a result is output is described with reference to FIG. 22. Among a plurality of data learned here, data expected to be the nearest to the object data is output as a result.

[Step S2-1]

In Step S2-1, object data is input from the outside to the neuron circuit NU. Note that the object data here is represented in binary and is n-bits which is the same number of bits as the learning data input in Step S1-1, and is inputted to the neuron circuits NU[1] to NU[n].

Object data [i] is inputted to the neuron circuit NU[i] as the external input signal DIN[i]. Thus, the object data [i] is inputted to an input terminal D of the input neuron circuit portion NU-I included in the neuron circuit NU[i]. Then, by inputting a clock signal which is a high-level potential to the flip-flop circuit FF, the input neuron circuit portion NU-I corresponding to the input neuron inputs the object data [i] to the first input terminal of the selector SLCT. In Step S2-1. the control signal CTL3 of “1” is inputted to the selector SLCT and the object data [i] is output from the output terminal of the selector SLCT as the signal S[i]. The output signal S[i] is inputted to the synapse circuits SU[i, 1] to SU[i, n].

Thus, the object data is inputted to all the synapse circuits SU in the neuron circuits NU[1] to NU[n].

[Step S2-2]

In Step S2-2, the signal S[i] inputted to the synapse circuit SU[i,j] controls on/off states of the transistor Tr2 or Tr4 in the weighting circuit WGT[i, j]. When the signal S[i] is “1”, the transistor Tr2 is turned off and the transistor Tr4 is turned on, so that the signal (current) w[i, j]S[i] corresponding to the connection strength w[i, j] held in Step S1-2 or Step S1-6 in learning is output from the synapse circuit SU[i, j] as the signal (current) I[i, j]. When the signal S[i] is “0”, the transistor Tr2 is turned on and the transistor Tr4 is turned off, so that current I₀ corresponding to the potential V0 flowing through the transistor Tr1 is output from the synapse circuit SU[i, j] as the signal (current) I[i, j].

In Step S2-2. input of the control signal CTL1 and the control signal CTL2 to the synapse circuit SU[i, j] is not performed. In other words, the charge pump circuits CP1 and CP2 included in the writing control circuit WCTL do not operate, and the connection strength w[i,j] is not updated.

[Step S2-3]

In Step S2-3, as in Step S1-3, the signal (current) I[i,j] output from the synapse circuit SU[i, j] is inputted to the neuron circuit NU[j]. Signals (currents) output from all the synapse circuits SU in the j-th column are added and inputted to the neuron circuit NU[j]. In other words, sum signals (currents) ΣI[i, 1] to ΣI[i, n] are inputted to the neuron circuits NU[1] to NU[n], respectively.

When the sum signal (current) ΣI[i,j] is inputted to the neuron circuit NU[j], a potential is generated in the first terminal of the resistor R of the hidden neuron circuit portion NU-H. The potential of the first terminal of the resistor R and the reference potential Vref are inputted to a non-inverting input terminal and an inverting input terminal of the comparator CMP, respectively. The output terminal of the comparator CMP outputs a signal corresponding to a potential difference between the potential of the first terminal of the resistor R and the reference potential Vref. The output signal from the comparator CMP is outputted to the outside of the semiconductor device as an external output signal DOUT[j] and inputted to the second input terminal of the selector SLCT

Here, the external output signals DOUT[1] to DOUT[n] are data expected to be the nearest data among a plurality of learning data. In other words, determination whether learning data and object data match, are similar, or mismatch can be made.

Through Step S1-1 to Step S1-6 and Step S2-1 to Step S2-3 which are described above, the semiconductor device 500 is made to learn learning data, and then can output data which matches, is similar to, or mismatches learning data by receiving object data. Thus, the semiconductor device 500 can perform processing such as pattern recognition or associative storage.

<<Motion Compensation Prediction>>

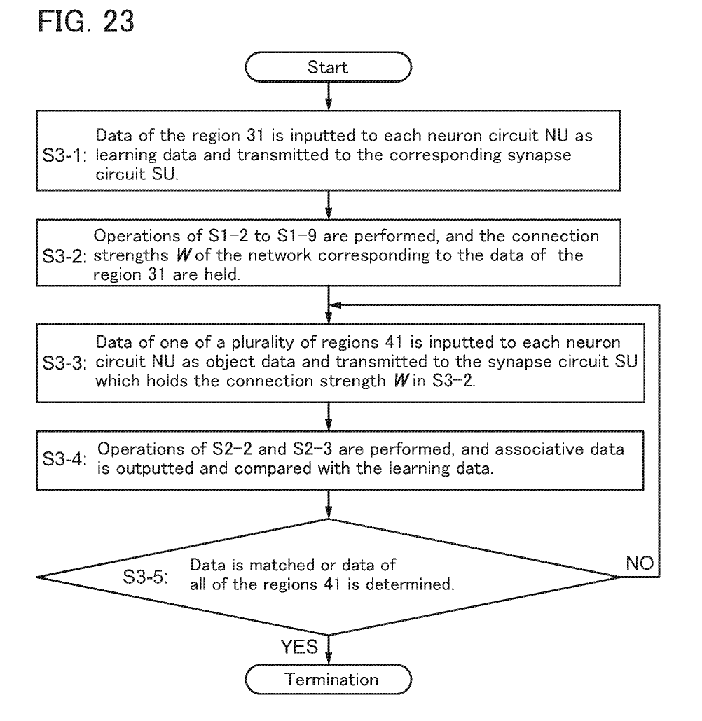

Next, a motion compensation prediction method using the semiconductor device 500 will be described with reference to FIG. 23.

[Step S3-1]

In Step S3-1, data of the region 31 is inputted to the neuron circuits NU[1] to NU[n] in the semiconductor device 500 as learning data. Note that the learning data is data of the region 31 represented in binary, and is of n-bits.

[Step S3-2]

In Step S3-2, input of data of the region 31 is performed in operation similar to Step S1-2 to Step S1-6. In other words, in all the synapse circuits SU, connection strengths W are updated repeatedly, and the connection strengths W of all the synapse circuits corresponding to the data of the region 31 are held.

[Step S3-3]

In Step S3-3, as object data, data of one of the plurality of regions 41 is inputted to the neuron circuits NU[1] to NU[n] in the semiconductor device 500 having the connection strength W formed in Step S3-2. Note that the object data is data of one of the regions 41 represented in binary, and is of n-bits.

[Step S3-4]

In Step S3-4, input of data of one of the plurality of regions 41 is performed in operation similar to Step S2-1 to Step S2-3. In other words, by input of data of one of the plurality of regions 41, the semiconductor device 500 which has learned data of the region 31 outputs associative data.

Here, by comparison between data of the region 31 and associative data, determination whether the data of the region 31 and the data of one of the plurality of regions 41 match, are similar, or mismatch is made.

[Step S3-5]

In Step S3-5, in accordance with the above determination results, the step to which the process proceeds is determined.

When the determination result shows a mismatch of the data of the region 31 and the one of the plurality of regions 41, the region 41 different from the one of the plurality of regions 41 is subjected to the operation in Step S3-3 and Step S3-4 again as the object data.

When the determination result shows a match of the data of the region 31 and data of the one of the plurality of regions 41, a motion vector of one of the plurality of regions 41 using the region 31 as a reference is obtained, so that the operation is terminated. By obtaining the motion vector, motion compensation prediction using the motion vector as a difference can be performed. The motion compensation prediction enables efficient compression of video data.

When the determination result shows similarity of the data of the region 31 and the data of the one of the plurality of regions 41, as described in Example of object motion detection. displacement in the case where the difference between the external output signals has the minimum value is predicted and the value thereof is obtained as the motion vector of an object. Then, the operation is terminated.

When comparison is performed using data of all of the regions 41 as the object data and the determination result shows a mismatch or non-similarity of the learning data and all of the object data, it is determined that a motion vector for motion compensation prediction cannot be obtained from the data of the region 31 and data of the plurality of regions 41, and then, the operation is terminated.

Through the above operation, the Hopfield neural network can be used as an encoder which compresses video data. Thus, an encoder with high efficiency which can compress a large volume of image data can be provided.

Note that this embodiment can be combined with any of the other embodiments in this specification as appropriate.

### Embodiment 3

In this embodiment, a connection structure of the electronic device and its peripheral devices, which are described in Embodiment 1, will be described.

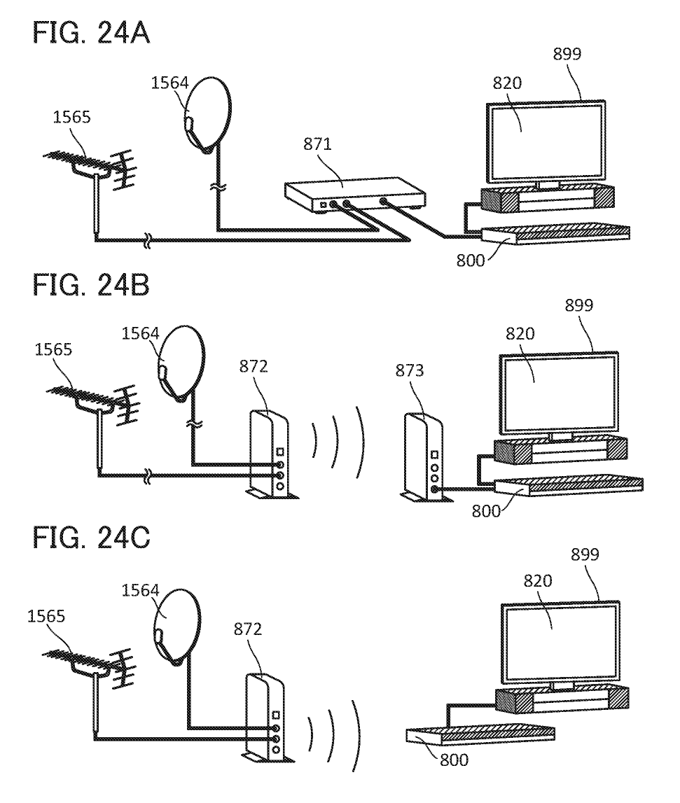

FIGS. 24A to 24C each illustrate a connection structure of the electronic device 800 illustrate in FIG. 1, an electronic device provided with a video display portion, a receiver, and antennas. In particular, FIGS. 24A to 24C each illustrate an example of a mode of the receiver. Note that the receiver in this embodiment includes the tuner 832 and the STB 833 described in Embodiment 1.

FIG. 24A illustrates a connection structure of an electronic device 899 including the video display portion 820, the electronic device 800, a receiver 871, an antenna 1564, and an antenna 1565. The antenna 1564 and the antenna 1565 are electrically connected to the receiver 871. The receiver 871 is electrically connected to the electronic device 800, and the electronic device 800 is electrically connected to the video display portion 820. In the structure in FIG. 24A, wirings are used to connect the electronic device 899, the electronic device 800, the receiver 871, the antenna 1564, and the antenna 1565.

In FIG. 24A. a television device is illustrated as the electronic device 899. Note that the electronic device 899 is not limited to the television device, and an electronic device including a display device other than the television device may be employed.

In FIG. 24A, a parabolic antenna is illustrated as the antenna 1564. Examples of the parabolic antenna include a BS·110° CS antenna and a CS antenna. In FIG. 24A, an ultra-high frequency (UHF) antenna is illustrated as the antenna 1565.

FIG. 24B illustrates a connection example which is different from that in FIG. 24A. In FIG. 24B, the electronic device 899 including the video display portion 820, the electronic device 800, a receiver 872, a receiver 873, the antenna 1564, and the antenna 1565 are connected.

The electronic device 800 is electrically connected to the electronic device 899 and the receiver 873. The receiver 872 and the receiver 873 communicate with each other wirelessly. One of the receiver 872 and the receiver 873 includes the tuner 832 and the STB 833. Alternatively, the receiver 872 may include the tuner 832, and the receiver 873 may include the STB 833.

For the video display portion 820. the electronic device 899, the antenna 1564, and the antenna 1565, the description for FIG. 24A is referred to.

FIG. 24C illustrates a connection structure which is different from those in FIGS. 24A and 24B. The connection structure in FIG. 24C includes the electronic device 899 including the video display portion 820, the electronic device 800, the receiver 872, the antenna 1564, and the antenna 1565.

The electronic device 800 is electrically connected to the electronic device 899. The electronic device 800 contains the receiver 873. In other words, the receiver 872 and the electronic device 800 communicate with each other wirelessly. The tuner 832 and the STB 833 are included in one of the receiver 872 and the electronic device 800. Alternatively, the receiver 872 may include the tuner 832, and the electronic device 800 may include the STB 833.

For the video display portion 820, the electronic device 899, the antenna 1564, and the antenna 1565, the description for FIG. 24A is referred to.

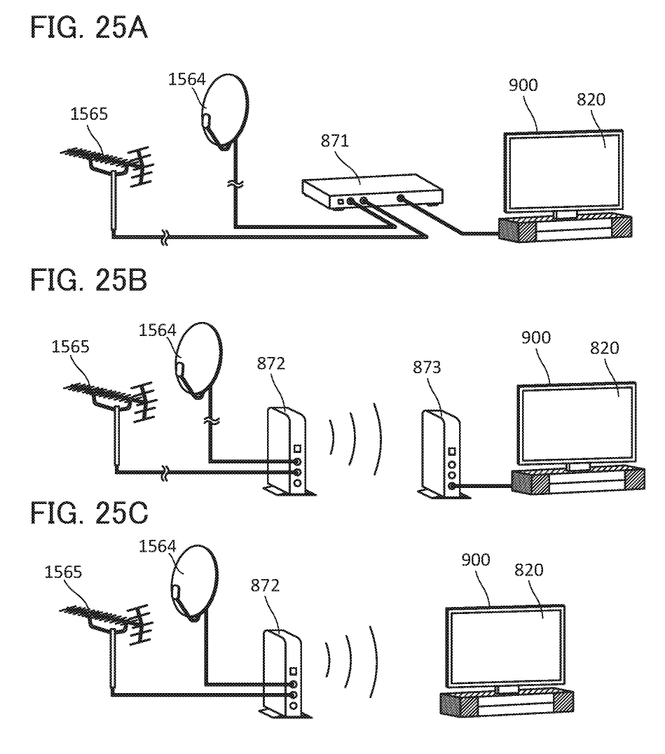

FIGS. 25A to 25C each illustrate a connection structure of the electronic device 900 described in Embodiment 1, a receiver, and antennas. In particular, FIGS. 25A to 25C each illustrate an example of a mode of a receiver. As in the cases of FIGS. 24A to 24C, the receiver includes the tuner 832 and the STB 833.

In FIG. 25A, the receiver 871 illustrated in FIG. 24A is electrically connected to the electronic device 900. In FIG. 25B, the receiver 872 and the receiver 873 illustrated in FIG. 24B are electrically connected to the electronic device 900.

In FIG. 25C, the electronic device 900 contains the receiver 873 as in FIG. 24C. In other words, the receiver 872 communicates with the electronic device 900 wirelessly. The tuner 832 and the STB 833 are included in one of the receiver 872 and the electronic device 900. Alternatively, the receiver 872 may include the tuner 832, and the electronic device 900 may include the STB 833.

This embodiment can be combined with any of the other embodiments in this specification as appropriate.

### Embodiment 4

In this embodiment, an operation example of an electronic device in which a hybrid display device is provided for the electronic device 900 described in Embodiments 1 and 3 will be described.

The hybrid display device is a display device including one of a light-emitting element and a transmissive liquid crystal element and a reflective element as display elements. A display including the hybrid display device is called a hybrid display.

In particular, a display including a light-emitting element and a reflective element as display elements is called an emissive OLED and reflective LC hybrid display or an emission/reflection hybrid display (ER-hybrid display) in this specification. A display including a transmissive liquid crystal element and a reflective liquid crystal element as display elements is called a transmissive LC and reflective LC hybrid display or a transmission/reflection hybrid display (TR-hybrid display).

The details of the hybrid display device will be described in Embodiment 5.

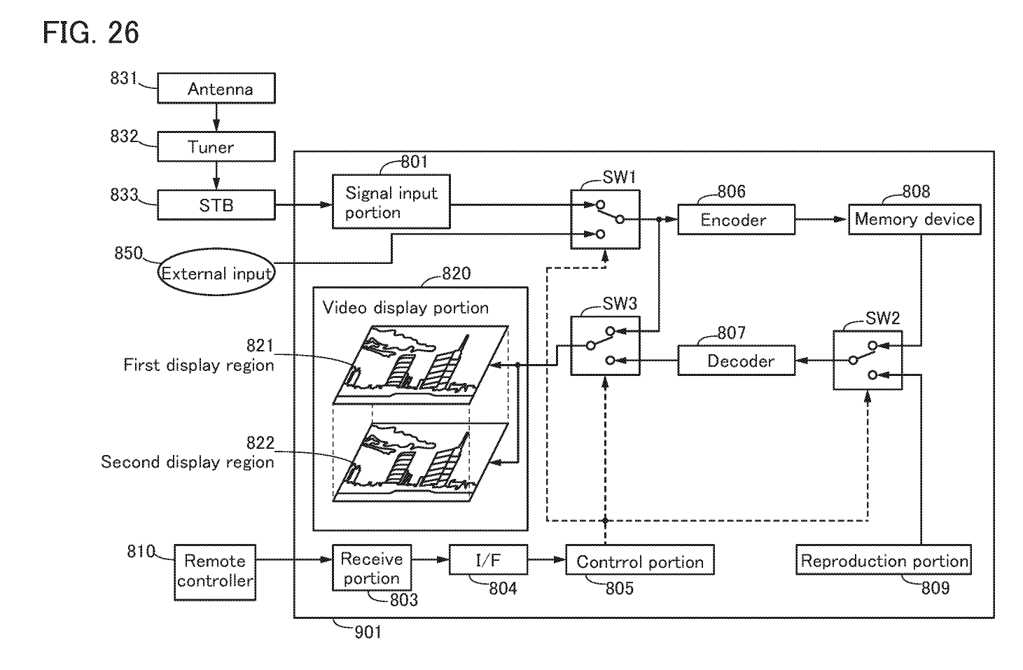

FIG. 26 illustrates a configuration example of an electronic device 901 in which a hybrid display device is provided for the video display portion 820 that is included in the electronic device 900 illustrated in FIG. 2.

The video display portion 820 of the electronic device 901 includes a first display region 821 and a second display region 822. and the first display region 821 overlaps with the second display region 822. Data of a broadcast signal from the outside (the first or second data) or reproduction data read out from the inside (first to third internal reproduction data) is transmitted to each of the first display region 821 and the second display region 822. whereby an image can be displayed on the video display portion 820. Here, the first display region 821 includes a reflective element, and the second display region 822 includes one of a light-emitting element and a transmissive liquid crystal element.

In the terrestrial digital broadcasting in Japan, the data of a broadcast signal from the outside (the first or second data) is generally transmitted in a multiplex form of a plurality of packets by a transmission system called transport stream. One packet includes a portion called a header (4-byte) and a portion containing data such as an image, an audio or contents for data broadcasting (184-byte).

The header has numbers for identifying the data contained in the packet. The above-described STB 833 decodes and demodulates image data and audio data on the basis of the numbers in the header.

In the case where a program is viewed using the electronic device 901, the header of the packet may have numbers for identifying an image displayed on the first display region 821 and an image displayed on the second display region 822. Then, the STB 833 may decode and demodulate data of the image displayed on the first display region 821 and data of the image on the second display region 822 in accordance with the header, and then transmit the demodulated/decoded data to the electronic device 901.

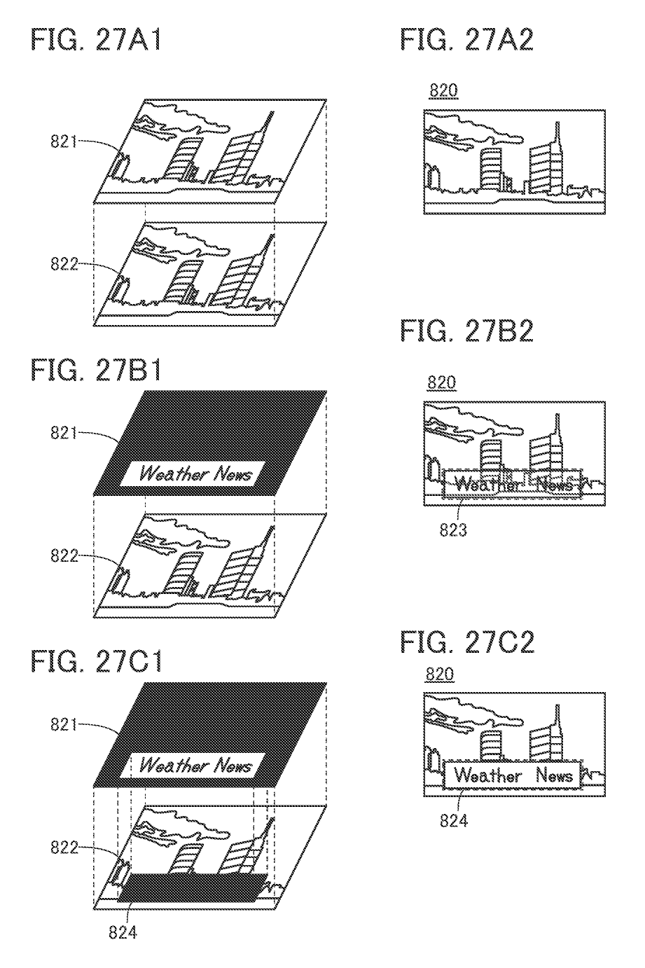

Next, an operation example of the electronic device 901 is described. FIGS. 27A1, 27B1. and 27C1 each illustrate images displayed on the first display region 821 and the second display region 822, and FIGS. 27A2, 27B2, and 27C2 each illustrate an image displayed on the video display portion 820, which is obtained by combination of the images displayed on the first display region 821 and the second display region 822.

First, the case where data of an image displayed on the first display region 821 and data of an image displayed on the second display region 822 are the same with each other is described. FIG. 27A1 illustrates an example in which the same image data is transmitted to the first display region 821 and the second display region 822, and the data is displayed on each display region. FIG. 27A2 illustrates an image that can be viewed on the video display portion 820 according to the display of the image in FIG. 27A1. Although the details of the displayed image will be described in another embodiment, it is briefly described here. In the case where the image displayed by the electronic device 901 is viewed in a dark environment, the reflection intensity of the reflective element included in the first display region 821 becomes low. In this case, the luminance of one of the light-emitting element and the transmissive liquid crystal element included in the second display region 822 is increased, so that an image with high viewability can be displayed. In the case where the image displayed by the electronic device 901 is viewed in a bright environment, the reflection intensity of the reflective element in the first display region 821 is increased, so that an image with high viewability can be displayed. Thus, it is not necessary to increase the emission intensity of one of the light-emitting element and the transmissive liquid crystal element in the second display region 822, whereby power consumption of the electronic device 901 can be reduced.

Next, in the case where data of an image displayed on the first display region 821 is different from data of an image displayed on the second display region 822 is described. Here, the following case is described as an example: a packet including data such as text, a figure, or a pattern as an image displayed on the first display region 821 and a packet including the image data displayed on the second display region 822 are received as broadcast signals by the antenna. FIG. 27B1 illustrates an example in which image data including text, a figure, or a pattern is transmitted to the first display region 821 and main image data is transmitted to the second display region 822 to display the image data. FIG. 27B2 illustrates an image that can be viewed on the video display portion 820 according to the display of the images in FIG. 27B1, as in the case of FIGS. 27A1 and 27A2. As illustrated in FIG. 27B2, the image that can be viewed on the video display portion 820 is obtained by combination of the image on the first display region 821 and the image on the second display region 822.

As illustrated in FIG. 27B1, a region other than a region displaying text, a figure, or a pattern is black display in the image displayed on the first display region 821, which means that values of pixels in the black display region are 0. Thus, as the display of the video display portion 820, the image displayed on the second display region 822 is directly displayed on the black display region in the first display region 821

Furthermore, as illustrated in FIG. 27B1, the region displaying text, a figure, or a pattern in the image displayed on the first display region 821 overlaps with the image displayed on the second display region 822. Thus, a region 823 exists in the video display portion 820, where the image displaying text, a figure, or a pattern displayed on the first display region 821 is combined with the image displayed on the second display region 822.

In such a manner, a packet including an image displayed on the first display region 821 and a packet including image data displayed on the second display region 822 are transmitted as broadcast signals, so that the images can be displayed on the first display region 821 and the second display region 822 with the electronic device 901. Note that as in the operation example described in Embodiment 1, the image data displayed on the first display region 821 and the image data displayed on the second display region 822 may be stored separately. Furthermore. the image data displayed on the first display region 821 and the image data displayed on the second display region 822 may be read out from the memory device or a storage media to be displayed on the video display portion 820.

Furthermore, the electronic device 901 may have a function of processing the image data displayed on the second display region 822 in accordance with the image data displayed on the first display region 821 and displaying the processed image data on the video display portion 820.

FIG. 27C1 illustrates an example in which image data including text, a figure. or a pattern is transmitted to the first display region 821 and processed image data is transmitted to the second display region 822 to display the image data. As the processing of the image data described here, a region 824 in the image displayed on the second display region 822, which overlaps with the image displaying text, a figure, or a pattern on the first display region 821, is made to be black display (a pixel value in the region 824 is 0).

In the image displayed on the second display region 822, the region overlapping with the image displaying text, a figure, or a pattern on the first display region 821 is black display in the above manner, whereby the image displayed on the second display region 822 is not overlapped with the image of text, a figure, or a pattern on the first display region 821. As a result, the video display portion 820 in FIG. 27C2 has better viewability than that in FIG. 27B2.

Depending on the circumstances or conditions, the above-described processing may be performed not only on the second display region 822 but also on the first display region 821.

The above-described processing can be conducted when the electronic device 901 is provided with a memory device, a graphics processing unit (GPU), or the like, which has a program for compiling the image data.

Note that this embodiment can be combined with any of the other embodiments in this specification as appropriate.

### Embodiment 5

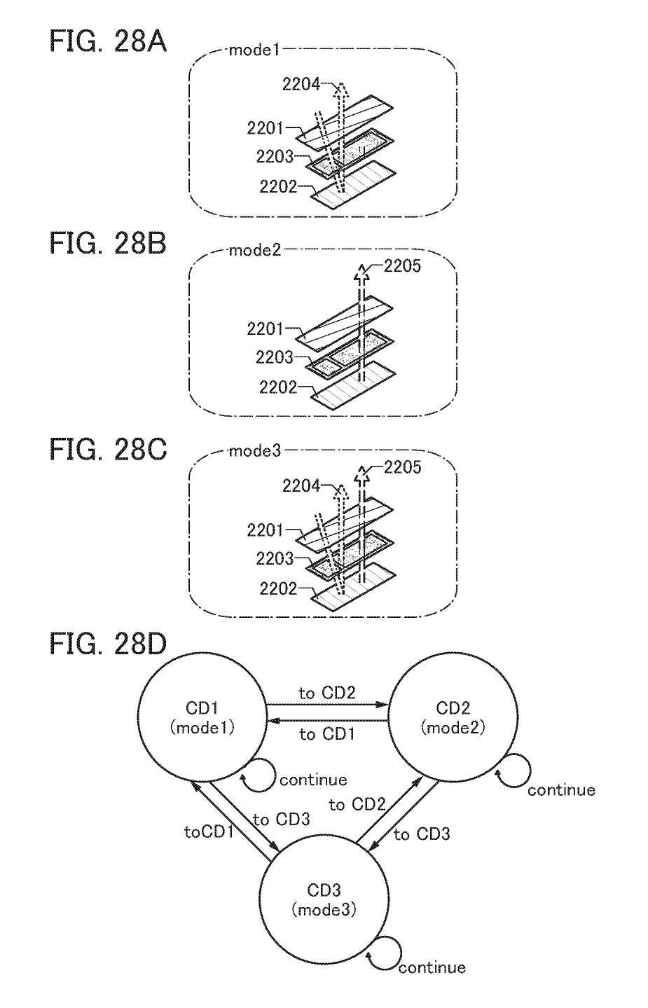

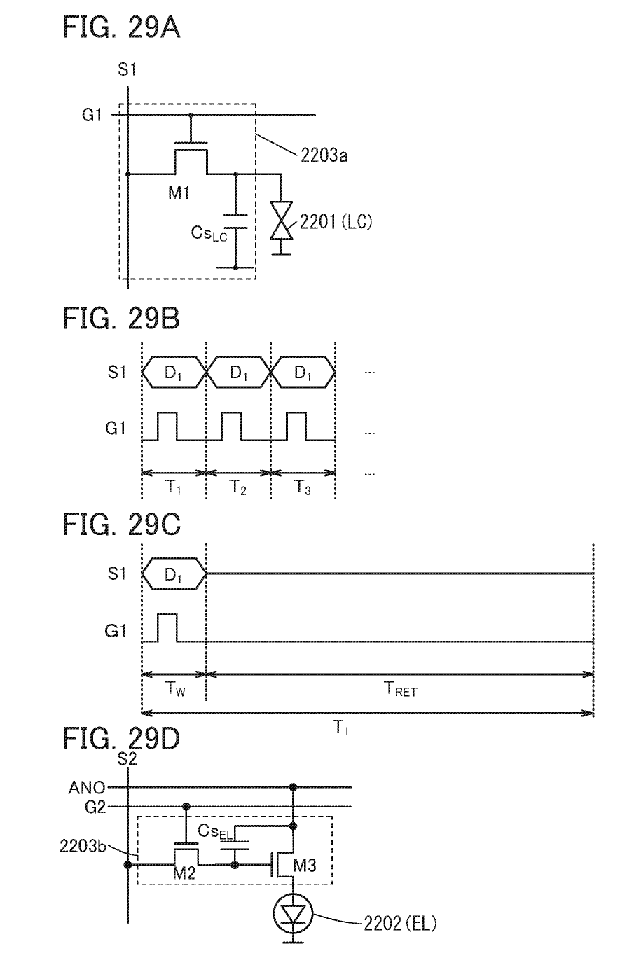

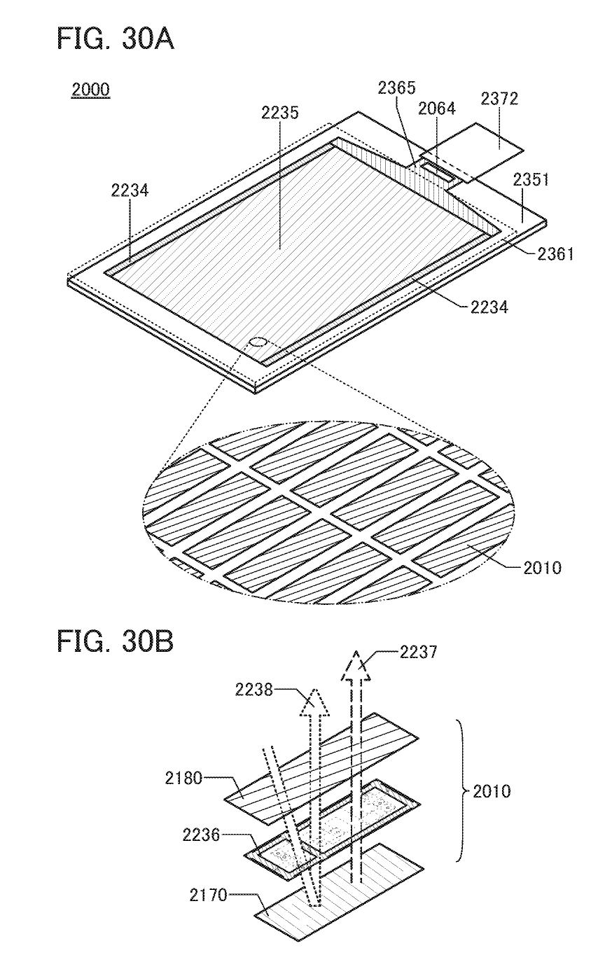

In this embodiment, a display device which can be used for the video display portion 820 of the electronic device 901 described in Embodiment 4 will be described with reference to FIGS. 28A to 28D, FIGS. 29A to 29D. FIGS. 30A and 30B, FIGS. 31A and 31B, FIG. 32, FIG. 33, FIG. 34, FIG. 35, and FIG. 36.

A hybrid display device described in this embodiment includes a first display element reflecting visible light and a second display element emitting visible light. For example, in the video display portion 820 of the electronic device 901, the first display region 821 includes the first display elements in a matrix, and the second display region 822 includes the second display elements in a matrix.

The hybrid display device of this embodiment has a function of displaying an image with the use of light reflected from the first display element and/or light emitted from the second display element.

As the first display element, an element which displays an image by reflecting external light can be used. Such an element does not include a light source and thus power consumption in display can be significantly reduced.

As the first display element, typically, a reflective liquid crystal element can be used.

As the first display element, other than a micro electro mechanical systems (MEMS) shutter element or an optical interference type MEMS element, an element using a microcapsule method, an electrophoretic method, an electrowetting method, or the like can also be used.

As the second display element, a light-emitting element is preferably used. Since the luminance and the chromaticity of light emitted from such a display element are hardly affected by external light, a clear image that has high color reproducibility (wide color gamut) and a high contrast can be displayed.

As the second display element, a self-luminous light-emitting element such as an organic light-emitting diode (OLED), a light-emitting diode (LED), a quantum-dot light-emitting diode (QLED), or a semiconductor laser can be used. Note that it is preferable to use a self-luminous light-emitting element as the second display element: however, the second display element is not limited thereto and may be a transmissive liquid crystal element combining a light source, such as a backlight or a sidelight, and a liquid crystal element, for example.

The hybrid display device of this embodiment has a first mode in which an image is displayed using the first display element, a second mode in which an image is displayed using the second display element, and a third mode in which an image is displayed using both the first display element and the second display element. The first to third modes can be switched automatically or manually. The first to third modes will be described in detail below.

In this specification, hybrid display (display in the third mode) is a method for displaying a letter or an image using reflected light and self-emitted light together in one panel that complement the color tone or light intensity of each other. Alternatively, hybrid display is a method for displaying a letter and/or an image using light from a plurality of display elements in one pixel or one subpixel. Note that when a hybrid display is locally observed, a pixel or a subpixel performing display using any one of the plurality of display elements and a pixel or a subpixel performing display using two or more of the plurality of display elements are included in some cases.

Note that in the present specification and the like, hybrid display satisfies any one or a plurality of the above-described descriptions.

Furthermore, a hybrid display includes a plurality of display elements in one pixel or one subpixel. Note that as an example of the plurality of display elements, a reflective element that reflects light and a self-luminous element that emits light can be given. Note that the reflective element and the self-luminous element can be controlled independently. A hybrid display has a function of displaying a letter and/or an image using one or both of reflected light and self-emitted light in a display portion.

[First Mode]

In the first mode, an image is displayed using the first display element and external light. The first mode does not require a light source and is therefore an extremely low-power mode. When sufficient external light enters the hybrid display device (e.g., in a bright environment), for example, an image can be displayed by using light reflected by the first display element. The first mode is effective in the case where external light is white light or light near white light and is sufficiently strong, for example. The first mode is suitable for displaying text. Furthermore, the use of reflected external light enables eye-friendly display in the first mode, which leads to an effect of reducing eyestrain. Note that the first mode may be referred to as a reflective display mode (reflection mode) because display is performed using reflected light.

[Second Mode]

In the second mode, an image is displayed utilizing light emitted from the second display element. Thus, an extremely vivid image (with high contrast and excellent color reproducibility) can be displayed regardless of the illuminance and the chromaticity of external light. The second mode is effective in the case of extremely low illuminance, such as in a night environment or in a dark room, for example. When a bright image is displayed in a dark environment, a user may feel that the image is too bright. To prevent this, an image with reduced luminance is preferably displayed in the second mode. Thus, not only a reduction in the luminance but also low power consumption can be achieved. The second mode is suitable for displaying a clear (still and moving) image or the like. Note that the second mode may be referred to as an emissive display mode (emission mode) because display is performed using light emission, i.e., emitted light.

[Third Mode]

In the third mode, display is performed utilizing both light reflected from the first display element and light emitted from the second display element. The display in which the first display element and the second display element are combined can be performed by driving the first display element and the second display element independently of each other in the same period. In this specification and the like, the display in which the first display element and the second display element are combined. i.e., the third mode, can be referred to as a hybrid display mode (HB display mode). Alternatively, the third mode may be referred to as a display mode in which an emission display mode and a reflective display mode are combined (ER-Hybrid mode).

The display in the third mode can be clearer than that in the first mode and can have lower power consumption than that in the second mode. For example, the third mode is effective when the illuminance is relatively low such as under indoor illumination or in the morning or evening hours, or when the external light does not represent a white chromaticity. With use of the combination of reflected light and emitted light, an image that makes a viewer feel like looking at a painting can be displayed.

In one embodiment of the present invention, subtitles are displayed using the first display element, and an image is displayed using the second display element, as described in the above embodiment. When both the image and the subtitles are displayed, the hybrid display device is driven in the above-described third mode.

In the case of not displaying subtitles, the second display element may display an image; thus, the hybrid display device may be driven in the above-described second mode. In the case where the illuminance is high, an image may be displayed using the first display element; thus. the hybrid display device may be driven not in the second mode but in the first mode.

<Specific Example of First to Third Modes>

Here, a specific example of the case where the above-described first to third modes are employed is described with reference to FIGS. 28A to 28D and FIGS. 29A to 29C.

Note that the case where the first to third modes are switched automatically in accordance with the illuminance will be described below. In the case where the modes are switched automatically depending on the illuminance, an illuminance sensor or the like is provided in the hybrid display device and the display mode can be switched in response to data from the illuminance sensor, for example.

FIGS. 28A to 28C are schematic views of a pixel for describing display modes that the hybrid display device of this embodiment can enter.

FIGS. 28A to 28C illustrate a first display element 2201, a second display element 2202, a pixel circuit 2203, reflected light 2204 that passes through the first display element 2201 and is reflected by the second display element 2202, and transmitted light 2205 that is emitted from the second display element 2202. Note that FIG. 28A, FIG. 28B, and FIG. 28C are diagrams illustrating a first display mode, a second display mode, and a third display mode, respectively.

FIGS. 28A to 28C illustrate the case where a reflective liquid crystal element is used as the first display element 2201 and a self-luminous OLED is used as the second display element 2202.

In the first display mode illustrated in FIG. 28A, gray scale display can be performed by driving the reflective liquid crystal element that is the first display element 2201 to adjust the intensity of reflected light. For example, as illustrated in FIG. 28A, the intensity of the reflected light 2204 reflected by the reflective electrode in the reflective liquid crystal element that is the first display element 2201 is adjusted with the liquid crystal layer. In this manner, gray scale can be expressed.

In the second mode illustrated in FIG. 28B, gray scale can be expressed by adjusting the emission intensity of the self-luminous OLED that is the second display element 2202. Note that light emitted from the second display element 2202 passes through the pixel circuit 2203 and is extracted to the outside as the transmitted light 2205.

The third mode illustrated in FIG. 28C is a display mode in which the first mode and the second mode described above are combined. For example, in the third mode, gray scale is expressed in such a manner that the emission intensity of the reflected light 2204 reflected by the reflective electrode in the reflective liquid crystal element (the first display element 2201) is adjusted with the liquid crystal layer while the self-luminous OLED (the second display element 2202) is being driven. Furthermore, the third display mode enables expression of gray scale by gray scale is expressed by adjusting the emission intensity of the self-luminous OLED (the second display element 2202), i.e., the intensity of the transmitted light 2205 in a period during which the first display element 2201 is driven.

<State Transition of First to Third Modes>

Next, the state transition of the first to third modes will be described with reference to FIG. 28D. FIG. 28D is a state transition diagram of the first mode, the second mode, and the third mode. In FIG. 28D, a state CD1, a state CD2, and a state CD3 correspond to the first mode, the second mode, and the third mode, respectively.

As illustrated in FIG. 28D, the display mode can be selected from the states CD1 to CD3 in accordance with the illuminance. For example, under high illuminance such as in the day time, the state CD1 can be selected. In the case where the illuminance decreases as time passes from day to night, the state CD1 transitions to the state CD2. Even in the day time, in the case where the illuminance becomes too low to sufficiently express grayscale with reflected light, the state CD1 transitions to the state CD2. Needless to say, transition from the state CD3 to the state CD1, transition from the state CD1 to the state CD3, transition from the state CD3 to the state CD2, or transition from the state CD2 to the state CD3 also occurs.

As illustrated in FIG. 28D. in the case where the illuminance does not change or slightly changes in the states CD1 to CD3, the present state may be maintained without transitioning to another state.

The above structure of switching the display mode in accordance with illuminance enables grayscale display of the display device in accordance with the illuminance. Furthermore, the grayscale display enables a reduction in the frequency of light emission from the light-emitting element which consumes a relatively large amount of power. Accordingly, the power consumption of the display device can be reduced. In the display device, the operation mode can be further switched in accordance with the amount of remaining battery power, the contents to be displayed, or the illuminance of the surrounding environment. Although the case where the display mode is automatically switched with illuminance is described above as an example, one embodiment of the present invention is not limited thereto, and a user may switch the display mode manually.

<Operation Mode>

Next, operation modes which can be performed by the first display element and the second display element are described with reference to FIGS. 29A to 29D.

A normal driving mode (Normal mode) with a normal frame frequency (typically, higher than or equal to 60 Hz and lower than or equal to 240 Hz) and an idling stop (IDS) driving mode with a low frame frequency is described below.

Note that the idling stop (IDS) driving mode refers to a method in which after image data is written, rewriting of image data is stopped. This increases the interval between writing of image data and subsequent writing of image data, thereby reducing the power that would be consumed by writing of image data in that interval. The idling stop (IDS) driving mode can be performed at a frame frequency which is 1/100 to 1/10 of the normal driving mode, for example.

FIGS. 29A to 29C are a circuit diagram and timing charts illustrating the normal driving mode and the idling stop (IDS) driving mode. Note that FIG. 29A illustrates the first display element 2201 (here, a liquid crystal element) and a pixel circuit 2203a electrically connected to the first display element 2201. The pixel circuit 2203a may be included in the pixel circuit 2203 illustrated in FIGS. 28A to 28C. In the pixel circuit 2203a in FIG. 29A, a signal line S1, a gate line G1, a transistor M1 connected to the signal line S1 and the gate line G1, and a capacitor C_{SLC} connected to the transistor M1 are illustrated.

A transistor including a metal oxide in a semiconductor layer is preferably used as the transistor M1. As a typical example of the transistor, a transistor including an oxide semiconductor which is a kind of metal oxide (OS transistor) will be described. The OS transistor has an extremely low leakage current in a non-conduction state (off-state current), so that charge can be retained in a pixel electrode of a liquid crystal element when the OS transistor is turned off.

FIG. 29B is a timing chart showing waveforms of signals supplied to the signal line S1 and the gate line G1 in the normal driving mode. In the normal driving mode, a normal frame frequency (e.g., 60 Hz) is used for operation. FIG. 29B shows periods T₁ to T₃, a scanning signal is supplied to the gate line G1 in each frame period and data D₁ is written from the signal line S1. This operation is performed both to write the same data D₁ in the periods T₁ to T₃ and to write different data in the periods T₁ to T₃.

In contrast, FIG. 29C is a timing chart showing waveforms of signals supplied to the signal line S1 and the gate line G1 in the idling stop (IDS) driving mode. In the idling stop (IDS) driving, a low frame frequency (e.g., 1 Hz) is used for operation. One frame period is denoted by a period T₁ and includes a data writing period T_{W} and a data retention period T_{RET}. In the idling stop (IDS) driving mode, a scanning signal is supplied to the gate line G1 and the data D₁ of the signal line S1 is written in the period T_{W}, the gate line G1 is fixed to a low-level voltage in the period T_{RET}, and the transistor M1 is turned off so that the written data D₁ is retained.

Note that IDS driving of the second display element can also be performed in some cases.

FIG. 29D illustrates the second display element 2202 (here, an organic EL element) and a pixel circuit 2203b electrically connected to the second display element. The pixel circuit 2203b may be included in the pixel circuit 2203 in FIGS. 28A to 28C. In the pixel circuit 2203b illustrated in FIG. 29D, a signal line S2, a gate line G2. a current supply line ANO, a transistor M2 electrically connected to the signal line S2 and the gate line G2, a capacitor C_{SEL} electrically connected to the transistor M2 and the current supply line ANO, and a transistor M3 electrically connected to the transistor M2. the capacitor C_{SEL}, the current supply line ANO, and the second display element 2202 are illustrated. The current supply line ANO functions as a wiring for supplying current for making the second display element emit light.

The transistor M2 is preferably an OS transistor like the transistor M1. The OS transistor has an extremely low leakage current in a non-conduction state (off-state current); therefore, charge accumulated in the capacitor C_{SEL} can be retained by turning off the OS transistor. In other words, the gate-drain voltage of the transistor M3 can be kept constant, whereby the emission intensity of the second display element 2202 can be constant.

Therefore, as in the IDS driving of the first display element, the IDS driving of the second display element is performed as follows: a scanning signal is supplied to the gate line G2, data is written from the signal line S2, and then, the gate line G2 is fixed to a low-level voltage to turn off the transistor M2 and retain the written data.

The transistor M3 is preferably formed using a material similar to that of the transistor M2. The use of the same material for the transistor M3 and the transistor M2 can shorten the fabrication process of the pixel circuit 2203b.

The combination of the IDS driving mode with the aforementioned first to third modes can enhance the effect of reducing the power consumption.

As described above, the hybrid display device of this embodiment can display an image by switching between the first to third display modes. Thus, an all-weather display device or a highly convenient display device with high visibility regardless of the ambient brightness can be fabricated.

The hybrid display device of this embodiment preferably includes a plurality of first pixels including first display elements and a plurality of second pixels including second display elements. The first pixels and the second pixels are preferably arranged in matrices.

Each of the first pixels and the second pixels can include one or more sub-pixels. The pixel can include, for example, one sub-pixel (e.g., a white (W) sub-pixel), three sub-pixels (e.g., red (R), green (G), and blue (B) sub-pixels), or four sub-pixels (e.g., red (R), green (G), blue (B), and white (W) sub-pixels, or red (R), green (G), blue (B), and yellow (Y) sub-pixels). Note that color elements included in the first and second pixels are not limited to the above, and may be combined with another color such as cyan (C), magenta (M), or the like as necessary.

In the hybrid display device of this embodiment, the first pixels can display a full-color image and the second pixels can display a full-color image. Alternatively, the hybrid display device described in this embodiment can be configured to display a black-and-white image or a grayscale image using the first pixels and can display a full-color image using the second pixels. The first pixels that can be used for displaying a black-and-white image or a grayscale image are suitable for displaying information that need not be displayed in color such as text information.

<Schematic Perspective View of Hybrid Display Device>

Next, the hybrid display device of this embodiment is described with reference to FIG. 30A.

FIG. 30A is a schematic perspective view of a display device 2000. In the display device 2000, a substrate 2351 and a substrate 2361 are bonded to each other. In FIG. 30A. the substrate 2361 is denoted by a dashed line.

The display device 2000 includes a display region 2235. a peripheral circuit region 2234, a wiring 2365, and the like. In FIG. 30A, an example in which a source driver IC 2064 and an FPC 2372 mounted over the display device 2000 is illustrated.

The peripheral circuit region 2234 includes a circuit for supplying a signal to the display region 2235. The circuit included in the peripheral circuit region 2234 is, for example, a gate driver and the like.

The wiring 2365 has a function of supplying a signal and power to the display region 2235 and the peripheral circuit region 2234. The signal and power are inputted to the wiring 2365 from the outside through the FPC 2372 or from the source driver IC 2064.

FIG. 30A illustrates an example in which the source driver IC 2064 is provided over the substrate 2351 by a COG method, a COF method, or the like. An IC including a scan line driver circuit, a signal line driver circuit, or the like can be used, for example. Note that the source driver IC 2064 may be mounted over an FPC by a COF method or the like.

FIG. 30A also illustrates an enlarged view of part of the display region 2235. In the display region 2235, a plurality of pixels 2010 are arranged in a matrix. Each of the pixels 2010 includes a light-emitting element 2170 and a liquid crystal element 2180 as display elements. Furthermore, the pixel 2010 includes a pixel circuit 2236 for driving the display elements.

FIG. 30B is a schematic perspective view of the pixel 2010. The light-emitting element 2170 (corresponding to the first display element 2201) and the liquid crystal element 2180 (corresponding to the second display element 2202) in the pixel 2010 overlap with each other with the pixel circuit 2236 (corresponding to the pixel circuit 2203) provided therebetween. The pixel circuit 2236 includes a first circuit for driving the light-emitting element 2170 and a second circuit for driving the liquid crystal element 2180.

Light 2237 (corresponding to the transmitted light 2205) is emitted from the light-emitting element 2170 to the outside through the pixel circuit 2236 and the liquid crystal element 2180. Furthermore, light 2238 (corresponding to the reflected light 2204) is entered from the outside, passes through the liquid crystal element 2180 and the pixel circuit 2236, and is reflected by the electrode of the light-emitting element 2170. Then, the light 2238 passes through the pixel circuit 2236 and the liquid crystal element 2180 again and is emitted to the outside as reflected light.

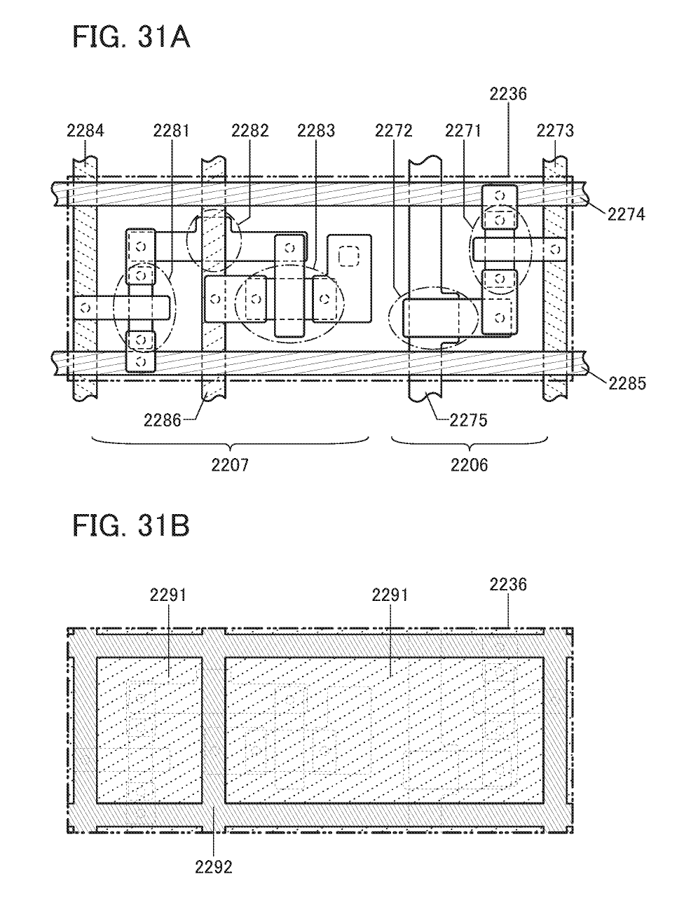

FIG. 31A illustrates a planar structure example of the pixel circuit 2236. The pixel circuit 2236 illustrated in FIG. 31A includes a first circuit 2206 for driving the liquid crystal element 2180 and a second circuit 2207 for driving the light-emitting element 2170. The first circuit 2206 includes a transistor 2271 and a capacitor 2272. The second circuit 2207 includes a transistor 2281, a capacitor 2282, and a transistor 2283. The pixel circuit 2236 includes part of a scan line 2273, part of a signal line 2274, part of a common potential line 2275, part of a scan line 2284, part of a signal line 2285, and part of a power supply line 2286.

As described above, the pixel circuit 2236 transmits the light 2237 once. The pixel circuit 2236 transmits the light 2238 twice. Thus, the pixel circuit 2236 preferably includes a light-transmitting material.

At least one of the transistor 2271, the capacitor 2272, the transistor 2281, the capacitor 2282, and the transistor 2283 is preferably formed using a light-transmitting conductive material. An electrode connected to any of the above components in the pixel circuit 2236 is preferably formed using a light-transmitting material.

As a light-transmitting conductive material, a conductive oxide such as indium oxide, indium tin oxide, indium zinc oxide, zinc oxide, or zinc oxide to which gallium is added can be used, for example. In particular, a conductive material with an energy gap of 2.5 eV or more is preferably used because it has high visible-light transmittance.

On the other hand, the light-transmitting conductive material has higher resistance than a light-blocking conductive material such as copper or aluminum. Thus, a bus line such as the scan line 2273, the signal line 2274, the scan line 2284, the signal line 2285, or the power supply line 2286 is preferably formed using a light-blocking conductive material (metal material) with lower resistance so as to prevent the signal delay. However, depending on the size of the display region 2235, the width or thickness of the bus line, and the like, a light-transmitting conductive material is used for the bus line in some cases.

The common potential line 2275 is generally used to supply a constant potential into the pixel circuit 2236, and accordingly, a large amount of current does not flow through the common potential line 2275. Thus, the common potential line 2275 can be formed using a light-transmitting conductive material with high resistance. However, in the case where a potential of the common potential line 2275 is varied for driving the display element, it is preferable to use a light-blocking metal material with low resistance for the common potential line 2275.

FIG. 31B is a plan view illustrating a transmissive region 2291 and a light-blocking region 2292 in the pixel circuit 2236. The light 2237 and the light 2238 are emitted through the transmissive region 2291. Thus, as the ratio of the transmissive region 2291 to the area occupied by the pixel 2010 (the ratio is also referred to as “aperture ratio”) in the plan view is high, the extraction efficiency of the light 2237 and the light 2238 can be increased. In other words, power consumption of the display device 2000 can be reduced. Furthermore, the visibility of the display device 2000 can be increased. Furthermore, the display quality of the display device 2000 can be improved.

In the display device 2000 of one embodiment of the present invention, the components included in the pixel circuit 2236 are formed using a light-transmitting material, whereby the aperture ratio can be higher than or equal to 60%, or higher than or equal to 80%.

For example, in the case where a constant light-emitting luminance (the amount of light emission) is obtained per pixel, an increase in the light-emitting area of the light-emitting element 2170 results in a decrease of the light-emitting luminance per unit area. Thus, the deterioration of the light-emitting element 2170 can be reduced, and accordingly, the reliability of the display device 2000 can be increased.

For the light-emitting element 2170, it is preferable to use a self-luminous light-emitting element such as an organic EL element, an inorganic EL element, a light-emitting diode (LED), a quantum-dot light-emitting diode (QLED), or a semiconductor laser. Furthermore, for the light-emitting element 2170, a transmissive liquid crystal in which a light source (e.g., LED) and a liquid crystal are combined may be used. Note that in this embodiment, the light-emitting element 2170 is described below as an organic EL element.

<Cross-Sectional Structure Example 1>

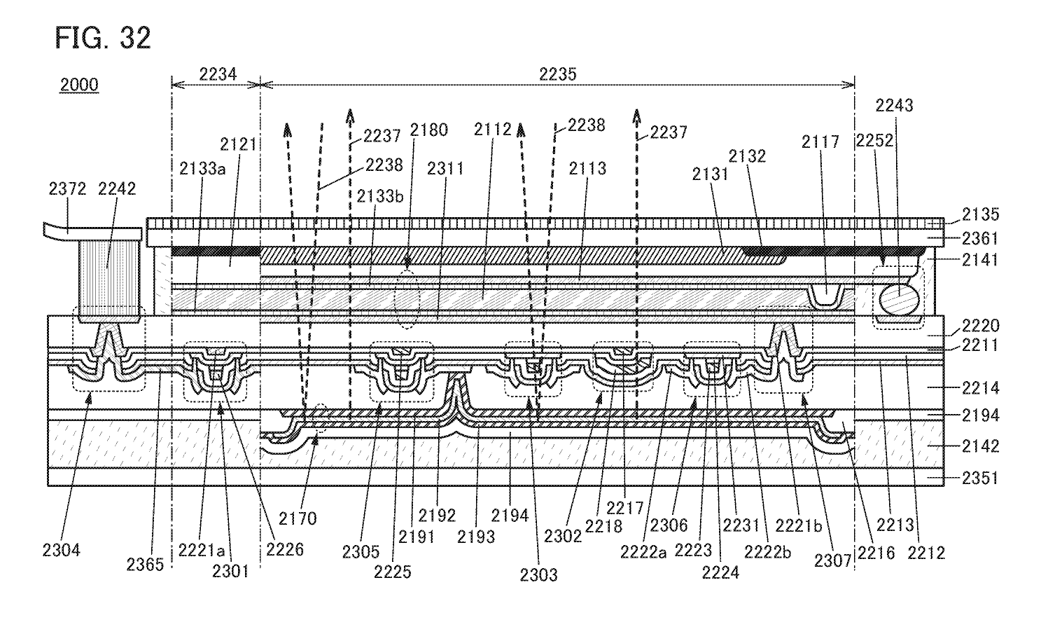

FIG. 32 illustrates an example of cross sections of part of a region including the FPC 2372, part of a region including the peripheral circuit region 2234, and part of a region including the display region 2235 of the display device 2000 illustrated in FIG. 30A.

The display device 2000 illustrated in FIG. 32 includes a transistor 2301, a transistor 2303, a transistor 2305, a transistor 2306, a capacitor 2302, the liquid crystal element 2180, the light-emitting element 2170, an insulating layer 2220, a coloring layer 2131, and the like, between the substrate 2351 and the substrate 2361. The substrate 2361 and the insulating layer 2220 are bonded with an adhesive layer 2141. The substrate 2351 and the insulating layer 2220 are bonded with an adhesive layer 2142. The insulating layer 2220 has a function of transmitting visible light.

The substrate 2361 is provided with the coloring layer 2131, a light-blocking layer 2132, an insulating layer 2121, an electrode 2113 functioning as a common electrode of the liquid crystal element 2180, an alignment film 2133b, an insulating layer 2117, and the like. The insulating layer 2121 has a function of transmitting visible light, and may also functions as a planarization layer. The insulating layer 2121 enables the electrode 2113 to have an almost flat surface, resulting in a uniform alignment state of liquid crystal 2112. The insulating layer 2117 functions as a spacer for holding a cell gap of the liquid crystal element 2180. In the case where the insulating layer 2117 transmits visible light, the insulating layer 2117 may be provided to overlap with a display region in the liquid crystal element 2180.

Note that a functional member 2135 such as a variety of optical members can be arranged on the outer surface of the substrate 2361. Examples of the optical member include a polarizing plate, a retardation plate, a light diffusion layer (e.g., a diffusion film), an anti-reflection layer (also referred to “AR layer”), an anti-glare layer (also referred to as “AG layer”). and a light-condensing film. Furthermore, examples of the functional member except the optical members include an antistatic layer preventing the attachment of dust, a water repellent layer suppressing the attachment of stain, and a hard coat film suppressing generation of a scratch caused by the use. For the functional member 2135, any of the above members may be combined. For example, a circular polarizer in which a linear polarizing plate and a retardation plate are combined may be used.

The AR layer has a function of reducing the specular reflection (mirror reflection) of external light utilizing the light interference. In the case where the AR layer is used as the functional member 2135, the AR layer is formed using a material having a refractive index different from that of the substrate 2361. The AR layer can be formed using a material such as zirconium oxide, magnesium fluoride, aluminum oxide, or silicon oxide, for example.

Instead of the AR layer, an anti-glare layer may be provided. The AG layer has a function of reducing the specular reflection (mirror reflection) by diffusion of entered external light.

As a formation method of the AG layer, a method for forming fine unevenness on a surface, a method for mixing materials with different refractive indexes, a method for combining the above methods, or the like is known. For example, a light-transmitting resin is mixed with nanofiber such as cellulosic fiber, inorganic beads such as silicon oxide, resin beads, or the like, so that the AG layer can be formed.

Alternatively, the AG layer may be provided to overlap with the AR layer. With a stack of the AR layer and the AG layer, a function of preventing reflection of external light can be further increased. By using the AR layer and/or the AG layer, or the like, the external-light reflectivity on a surface of the display device may be lower than 1%, preferably lower than 0.3%.

The liquid crystal element 2180 illustrated in this embodiment is a reflective liquid crystal element in which a conductive layer 2193 in the light-emitting element 2170 is used as a reflective electrode. The liquid crystal element 2180 has a stacked-layer structure of an electrode 2311, the liquid crystal 2112, and the electrode 2113. The electrode 2311 and the electrode 2113 transmit visible light. An alignment film 2133a is provided between the liquid crystal 2112 and the electrode 2311. The alignment film 2133b is provided between the liquid crystal 2112 and the electrode 2113.

The reflective electrode of the liquid crystal element 2180 also serves as the conductive layer 2193 of the light-emitting element 2170, whereby a reflective electrode only used for the liquid crystal element 2180 can be omitted. Thus, the fabrication cost of the display device can be reduced. Furthermore, the productivity of the display device can be improved.

In this embodiment, a circular polarizer is used as the functional member 2135. Light entering from the substrate 2361 side is polarized by the functional member 2135 (circular polarizer), passes through the electrode 2113, the liquid crystal 2112, and the electrode 2311, and is reflected by the conductive layer 2193. Then, the light passes through the liquid crystal 2112 and the electrode 2113 again, and reaches the functional member 2135 (circular polarizer). In this case, alignment of liquid crystal can be controlled with a voltage that is applied between the electrode 2311 and the electrode 2113, and thus optical modulation of light can be controlled. That is, the intensity of light emitted through the functional member 2135 (circular polarizer) can be controlled. When light out of a specific wavelength range is absorbed by the coloring layer 2131, light in the specific wavelength range can be extracted. Consequently, red light is extracted, for example.

At a connection portion 2307, the electrode 2311 is electrically connected to a conductive layer 2222b included in the transistor 2306 via a conductive layer 2221b. The transistor 2306 has a function of controlling the driving of the liquid crystal element 2180.

A connection portion 2252 is provided in part of a region where the adhesive layer 2141 is provided. In the connection portion 2252, a conductive layer obtained by processing the same conductive film as the electrode 2311 is electrically connected to part of the electrode 2113 with a connector 2243. Accordingly, a signal or a potential inputted from the FPC 2372 can be supplied to the electrode 2113 formed on the substrate 2361 side through the connection portion 2252.

As the connector 2243. a conductive particle can be used, for example. As the conductive particle, a particle of an organic resin, silica, or the like coated with a metal material can be used. It is preferable to use nickel or gold as the metal material because contact resistance can be decreased. It is also preferable to use a particle coated with layers of two or more kinds of metal materials, such as a particle coated with nickel and further with gold. As the connector 2243, a material capable of elastic deformation or plastic deformation is preferably used. As illustrated in FIG. 32, the connector 2243 which is the conductive particle has a shape that is vertically crushed in some cases. With the crushed shape, the contact area between the connector 2243 and a conductive layer electrically connected to the connector 2243 can be increased, thereby reducing contact resistance and suppressing the generation of problems such as disconnection. For example, the connector 2243 may be dispersed in the adhesive layer 2141 before curing of the adhesive layer 2141.

The connector 2243 is preferably provided so as to be covered with the adhesive layer 2141. For example, the connectors 2243 may be dispersed in the adhesive layer 2141 before curing of the adhesive layer 2141.

The light-emitting element 2170 is a bottom-emission light-emitting element. The light-emitting element 2170 has a structure in which a conductive layer 2191, an EL layer 2192, and the conductive layer 2193 are stacked in this order from the insulating layer 2220 side. The conductive layer 2191 is connected to the conductive layer 2222b included in the transistor 2305 through an opening provided in an insulating layer 2214. The transistor 2305 has a function of controlling the driving of the light-emitting element 2170. An insulating layer 2216 covers an end portion of the conductive layer 2191. The conductive layer 2193 has a function of reflecting visible light, and the conductive layer 2191 has a function of transmitting visible light. An insulating layer 2194 is provided to cover the conductive layer 2193. Light emitted from the light-emitting element 2170 is emitted to the substrate 2361 side through the insulating layer 2220, the electrode 2311, the coloring layer 2131, and the like.

The emission color of the light-emitting element 2170 can be changed to white, red. green, blue, cyan, magenta, yellow, or the like depending on the material that forms the EL layer 2192. The color of the reflected light controlled by the liquid crystal element 2180 can be changed to white, red, green, blue. cyan, magenta, yellow, or the like depending on the material that forms the coloring layer 2131. The color of controlled light is varied depending on the pixel in the light-emitting element 2170 and the liquid crystal element 2180, whereby color display can be achieved.

Alternatively, the EL layer 2192 emitting white light is used for the light-emitting element 2170, and light may be colored using the coloring layer 2131.

To achieve color display, the emission colors of the light-emitting element 2170 and the colors of the coloring layers combined with the liquid crystal element 2180 may be a combination of yellow, cyan, and magenta, as well as a combination of red, green, and blue. The colors of the combined coloring layer may be determined as appropriate in accordance with the purpose, the uses, or the like.

The transistor 2301, the transistor 2303, the transistor 2305, the transistor 2306, and the capacitor 2302 are formed on a plane of the insulating layer 2220 on the substrate 2351 side. In FIG. 32, each of the transistor 2301, the transistor 2303, the transistor 2305, and the transistor 2306 is a top-gate transistor.

The transistor 2303 is used for controlling whether the pixel is selected or not (such a transistor is also referred to as a switching transistor or a selection transistor). The transistor 2305 is a transistor (also referred to as a driving transistor) for controlling current flowing to the light-emitting element 2170.

Insulating layers such as an insulating layer 2211, an insulating layer 2212, an insulating layer 2213, and the insulating layer 2214 are provided on the insulating layer 2220 on the substrate 2351 side. The insulating layer 2212 and the insulating layer 2213 are provided to cover gate electrodes and the like of the transistor 2301, the transistor 2303, the transistor 2305, and the transistor 2306. The insulating layer 2214 functions as a planarization layer. Note that the number of insulating layers covering the transistor is not limited and may be one or two or more. Furthermore, each of the insulating layer 2211, the insulating layer 2212, the insulating layer 2213, and the insulating layer 2214 has a function of transmitting visible light.

A material through which impurities such as water or hydrogen do not easily diffuse is preferably used for at least one of the insulating layers that cover the transistors. This is because such an insulating layer can serve as a barrier film. Such a structure can effectively suppress diffusion of the impurities into the transistors from the outside, and a highly reliable display device can be achieved.

The capacitor 2302 includes conductive layers 2217 and 2218 which partly overlap with each other with the insulating layer 2211 sandwiched therebetween. For each of the conductive layers 2217 and 2218, a conductive material transmitting visible light, such as an In-Sn oxide or an In-Zn oxide can be used. The conductive layer 2217 can be formed in the following manner: a conductive film is formed, a resist mask is formed, the conductive film is etched, and the resist mask is removed.

Each of the transistor 2303, the transistor 2305, and the transistor 2306 is formed using a light-transmitting material. The light-transmitting conductive material has higher resistance than a light-blocking conductive material such as copper or aluminum. Thus, the conductive layer used for the transistor 2301 that is required to operate at high speed and included in the peripheral circuit region 2234 is formed using a light-blocking conductive material (metal material) with low resistance.

Each of the transistor 2303, the transistor 2305, and the transistor 2306 includes a conductive layer 2223 functioning as a gate, an insulating layer 2224 functioning as a gate insulating layer, a conductive layer 2222a and the conductive layer 2222b functioning as a source and a drain, and a semiconductor layer 2231. Here, a plurality of layers obtained by processing the same conductive film are shown with the same hatching pattern. Furthermore, the transistor 2305 includes a conductive layer 2225 functioning as a gate. Note that each of the conductive layer 2223, the conductive layer 2222a, and the conductive layer 2222b is formed using a conductive material transmitting visible light. The semiconductor layer 2231 is formed using a semiconductor material transmitting visible light.

The transistor 2301 also includes a conductive layer functioning as a gate, an insulating layer functioning as a gate insulating layer, conductive layers functioning as a source and a drain, and a semiconductor layer. The transistor 2305 includes a conductive layer 2226 functioning as a first gate and a conductive layer 2221a functioning as a second gate. As described above, each of the conductive layer 2226 and the conductive layer 2221a has low resistance and is formed using a light-blocking conductive material. The conductive layer 2221a and the conductive layer 2221b can be obtained by processing the same conductive film.

The structure in which the semiconductor layer where a channel is formed is provided between two gates is used as an example of the transistors 2301 and 2305. Such a structure enables the control of the threshold voltage of transistor. In that case, the two gates may be connected to each other and supplied with the same signal to operate the transistor. Such transistors can have a higher field-effect mobility and thus have higher on-state current than other transistors. Consequently, a circuit capable of high-speed operation can be obtained. Furthermore, the area occupied by a circuit portion can be reduced. The use of the transistor having high on-state current can reduce signal delay in wirings and can reduce display unevenness even in a display device in which the number of wirings is increased because of increase in size or definition.

Alternatively, by supplying a potential for controlling the threshold voltage to one of the two gates and a potential for driving to the other, the threshold voltage of the transistor can be controlled.

There is no limitation on the structure of the transistors included in the display device. The transistor included in the peripheral circuit region 2234 and the transistor included in the display region 2235 may have the same structure or different structures. Similarly, a plurality of transistors included in the peripheral circuit region 2234 may have the same structure or a combination of two or more kinds of structures. Similarly, a plurality of transistors included in the display region 2235 may have the same structure or a combination of two or more kinds of structures.

The conductive layer functioning as a gate may include a conductive material including an oxide. When the conductive layer is deposited in an atmosphere containing oxygen, oxygen can be supplied to the gate insulating layer. The proportion of an oxygen gas in a deposition gas is preferably higher than or equal to 90% and lower than or equal to 100%. Oxygen supplied to the gate insulating layer is then supplied to the semiconductor layer by later heat treatment; as a result, oxygen vacancies in the semiconductor layer can be reduced.

A connection portion 2304 is provided in a region where the substrate 2351 and the substrate 2361 do not overlap with each other. In the connection portion 2304, the wiring 2365 is electrically connected to the FPC 2372 via a connection layer 2242. The connection portion 2304 has a structure similar to that of the connection portion 2307. On the top surface of the connection portion 2304, a conductive layer obtained by processing the same conductive film as the electrode 2311 is exposed. Thus, the connection portion 2304 and the FPC 2372 can be electrically connected to each other through the connection layer 2242.

A liquid crystal element having, for example, a vertical alignment (VA) mode can be used as the liquid crystal element 2180. Examples of the vertical alignment mode include a multi-domain vertical alignment (MVA) mode, a patterned vertical alignment (PVA) mode, and an advanced super view (ASV) mode.

A liquid crystal element having a variety of modes can be used as the liquid crystal element 2180. For example, a liquid crystal element using, instead of a VA mode, a twisted nematic (TN) mode, an in-plane switching (IPS) mode, a VA-IPS mode, a fringe field switching (FFS) mode, an axially symmetric aligned micro-cell (ASM) mode, an optically compensated birefringence (OCB) mode, a ferroelectric liquid crystal (FLC) mode, an antiferroelectric liquid crystal (AFLC) mode, a guest-host mode, or the like can be used.

The liquid crystal element controls transmission or non-transmission of light utilizing an optical modulation action of liquid crystal. The optical modulation action of liquid crystal is controlled by an electric field applied to the liquid crystal (including a lateral electric field, a vertical electric field and a diagonal electric field). As the liquid crystal used for the liquid crystal element, a thermotropic liquid crystal, a low-molecular liquid crystal, a high-molecular liquid crystal, a polymer dispersed liquid crystal (PDLC). a ferroelectric liquid crystal, an anti-ferroelectric liquid crystal, or the like can be used. Such a liquid crystal material exhibits a cholesteric phase, a smectic phase, a cubic phase, a chiral nematic phase, an isotropic phase, or the like depending on conditions.

As the liquid crystal material, either positive liquid crystal or negative liquid crystal may be used, and an appropriate liquid crystal material can be used depending on the mode or design to be used.

In addition, to control the alignment of the liquid crystal, an alignment film can be provided. In the case where a horizontal electric field mode is employed, a liquid crystal exhibiting a blue phase for which an alignment film is unnecessary may be used. A blue phase is one of liquid crystal phases, which is generated just before a cholesteric phase changes into an isotropic phase while temperature of cholesteric liquid crystal is increased. Since the blue phase appears only in a narrow temperature range, a liquid crystal composition in which a chiral material is mixed to account for several weight percent or more is used for the liquid crystal in order to improve the temperature range. The liquid crystal composition which includes liquid crystal exhibiting a blue phase and a chiral material has a short response time and optical isotropy, which makes the alignment process unneeded. In addition, the liquid crystal composition which includes liquid crystal exhibiting a blue phase and a chiral material has a small viewing angle dependence. An alignment film does not need to be provided and rubbing treatment is thus not necessary; accordingly, electrostatic discharge damage caused by the rubbing treatment can be prevented and defects and damage of the liquid crystal display device in the manufacturing process can be reduced.

Note that a liquid crystal material acting in a guest-host mode is used for the liquid crystal element 2180, whereby a functional member such as a light diffusion layer or a polarizing plate can be omitted. Accordingly, the productivity of the display device can be improved. Without a functional member such as a polarizing plate, the luminance of reflected light of the liquid crystal element 2180 can be increased. Thus, the visibility of the display device can be improved.

For switching of an on state and an off state (bright state and dark state) of a reflective liquid crystal display device using a circular polarizer, major axes of liquid crystal molecules are aligned in the direction substantially perpendicular to the substrate or in the direction substantially parallel to the substrate. In a liquid crystal element driven in a horizontal electric field mode such as an IPS mode, generally, major axes of liquid crystal molecules are aligned in the direction substantially parallel to the substrate both in an on state and an off state. Thus, it is difficult to use such a liquid crystal element for a reflective liquid crystal display device.

A liquid crystal element driving in a horizontal electric field mode such a VA-IPS mode is switched to be in an on state or an off state by aligning major axes of liquid crystal molecules in the direction substantially perpendicular to the substrate or in the direction substantially parallel to the substrate. Thus, when a liquid crystal element driven in a horizontal electric field mode is used for a reflective liquid crystal display device, a liquid crystal element driving in a VA-IPs mode is preferably used.

A front light may be provided on the outer side of the functional member 2135. As the front light, an edge-light front light is preferably used. A front light including a light-emitting diode (LED) is preferably used to reduce power consumption.

As the adhesive layer, a variety of curable adhesives such as a reactive curable adhesive, a thermosetting adhesive, an anaerobic adhesive, and a photocurable adhesive such as an ultraviolet curable adhesive can be used. Examples of these adhesives include an epoxy resin. an acrylic resin, a silicone resin, a phenol resin, a polyimide resin, an imide resin, a polyvinyl chloride (PVC) resin, a polyvinyl butyral (PVB) resin, an ethylene vinyl acetate (EVA) resin, and the like. In particular, a material with low moisture permeability, such as an epoxy resin, is preferred. Alternatively, a two-component type resin may be used. Still alternatively. an adhesive sheet or the like may be used.

The connection layer 2242 can be formed using any of various kinds of anisotropic conductive films (ACF), anisotropic conductive pastes (ACP), and the like.

The light-emitting element has a top emission structure, a bottom emission structure, a dual emission structure, or the like. A conductive film that transmits visible light is used as the electrode through which light is extracted. A conductive film that reflects visible light is preferably used as the electrode through which light is not extracted. The light-emitting element 2170 can be referred to as a bottom-emission light-emitting element.

The EL layer 2192 includes at least a light-emitting layer. In addition to the light-emitting layer, the EL layer 2192 may further include one or more layers containing any of a substance with a high hole-injection property, a substance with a high hole-transport property, a hole-blocking material, a substance with a high electron-transport property, a substance with a high electron-injection property, a substance with a bipolar property (a substance with a high electron- and hole-transport property), and the like.

The emission color of the light-emitting element 2170 can be changed to white, red, green, blue, cyan, magenta, yellow, or the like depending on the material that forms the EL layer 2192.

As a color display method, there are a method in which the light-emitting element 2170 whose emission color is white is combined with a coloring layer and a method in which the light-emitting element 2170 with a different emission color is provided in each subpixel. The former method is more productive than the latter method. On the other hand, the latter method, which requires separate formation of the EL layer 2192 subpixel by subpixel, is less productive than the former method. However, the latter method can produce the emission color with higher color purity than that of the emission color produced by the former method. When the light-emitting element 2170 has a microcavity structure in the latter method, the color purity can be further increased.

For the EL layer 2192, either a low molecular compound or a high molecular compound can be used, and an inorganic compound may also be contained. The layers included in the EL layer 2192 can be formed separately by any of the following methods: an evaporation method (including a vacuum evaporation method), a transfer method, a printing method, an inkjet method, a coating method, and the like.

The EL layer 2192 may contain an inorganic compound such as quantum dots. For example, when used for the light-emitting layer, the quantum dot can serve as a light-emitting material.

Furthermore, the display device 2000 of one embodiment of the present invention is not provided with a substrate between the light-emitting element 2170 and the liquid crystal element 2180. Thus, a distance between the light-emitting element 2170 and the liquid crystal element 2180 in the thickness direction can be less than 30 μm. preferably less than 10 μm. further preferably 5 μm. Thus, in displaying images using the light-emitting element 2170 and the liquid crystal element 2180 concurrently or alternately, parallax generated between the elements can be suppressed. The weight of the display device 2000 can be reduced. The thickness of the display device 2000 can be reduced. The display device 2000) is easily bendable.

<<Substrate>>

There is no particular limitation on a material used for the substrate 2351 and the substrate 2361. The material is determined according to the purpose in consideration of whether it has a light-transmitting property, heat resistance high enough to withstand heat treatment, or the like. For example, a glass substrate of barium borosilicate glass, aluminosilicate glass, or the like, a ceramic substrate, a quartz substrate, a sapphire substrate, or the like can be used. Alternatively, a semiconductor substrate, a flexible substrate, an attachment film, a base film, or the like may be used.

As the semiconductor substrate, a semiconductor substrate of silicon, germanium, or the like or a compound semiconductor substrate of silicon carbide, silicon germanium, gallium arsenide, indium phosphide, zinc oxide, or gallium oxide, or the like is used, for example. As the semiconductor substrate, a single-crystal semiconductor or a polycrystalline semiconductor may be used.

To increase the flexibility of the display device 2000, a flexible substrate, an attachment film, a base material film, or the like may be used as each of the substrate 2351 and the substrate 2361.

Examples of materials that can be used for the flexible substrate, a bounding film. a base film, or the like include polyester resins such as polyethylene terephthalate (PET) and polyethylene naphthalate (PEN), a polyacrylonitrile resin, an acrylic resin, a polyimide resin, a polymethyl methacrylate resin, a polycarbonate (PC) resin, a polyethersulfone (PES) resin, polyamide resins (such as nylon and aramid), a polysiloxane resin, a cycloolefin resin, a polystyrene resin, a polyamide-imide resin, a polyurethane resin, a polyvinyl chloride resin, a polyvinylidene chloride resin, a polypropylene resin, a polytetrafluoroethylene (PTFE) resin, an ABS resin, and cellulose nanofiber.

When any of the above-described materials is used for the substrates, a lightweight display device can be provided. Furthermore, when any of the above-described materials is used for the substrates, a shock-resistant display device can be provided. Moreover, when any of the above-described materials is used for the substrates, a non-breakable display device can be provided.

The flexible substrate used as substrate 2351 or the substrate 2361 preferably has a lower coefficient of linear expansion because deformation due to an environment is suppressed. The flexible substrate used as the substrate 2351 or the substrate 2361 is formed using, for example, a material whose coefficient of linear expansion is lower than or equal to 1×10⁻³/K, lower than or equal to 5×10⁻⁵/K, or lower than or equal to 1×10⁻⁵/K. In particular, aramid is preferably used for the flexible substrate because of its low coefficient of linear expansion.

<<Conductive Layer>>

As materials for a gate, a source, and a drain of a transistor, and a conductive layer such as a wiring or an electrode included in a display device, any of metals such as aluminum, titanium, chromium, nickel, copper, yttrium, zirconium, molybdenum, silver, tantalum, and tungsten, or an alloy containing any of these metals as its main component can be used. A single-layer structure or stacked structure including a film containing any of these materials can be used.

As a light-transmitting conductive material, an oxide conductive such as indium oxide, indium tin oxide, indium zinc oxide, zinc oxide, or zinc oxide to which gallium is added, or graphene can be used. It is also possible to use a metal material such as gold, silver, platinum, magnesium. nickel, tungsten, chromium, molybdenum, iron, cobalt, copper, palladium, or titanium: an alloy material containing any of these metal materials; or a nitride of the metal material (e.g., titanium nitride). In the case of using the metal material or the alloy material (or the nitride thereof), the film thickness is set small enough to transmit light. Alternatively, a stacked film of any of the above materials can be used for the conductive layers. For example, a stacked film of indium tin oxide and an alloy of silver and magnesium is preferably used because the conductivity can be increased. They can also be used for conductive layers such as a variety of wirings and electrodes included in a display device, and conductive layers (e.g., conductive layers serving as a pixel electrode or a common electrode) included in a display element.

Here, an oxide conductor is described. In this specification and the like, an oxide conductor may be referred to as OC. For example, oxygen vacancies are formed in a metal oxide, and then hydrogen is added to the oxygen vacancies, so that a donor level is formed in the vicinity of the conduction band. As a result, the conductivity of the metal oxide is increased, so that the metal oxide becomes a conductor. The metal oxide having become a conductor can be referred to as an oxide conductor. Oxide semiconductors generally transmit visible light because of their large energy gap. An oxide conductor is a metal oxide having a donor level in the vicinity of the conduction band. Therefore, the influence of absorption due to the donor level is small in an oxide conductor, and an oxide conductor has a visible light transmitting property comparable to that of an oxide semiconductor.

<<Insulating Layer>>

Examples of an insulating material that can be used for the insulating layers include a resin material such as acrylic or an epoxy resin, and an inorganic insulating material such as silicon oxide, silicon oxynitride, silicon nitride oxide, silicon nitride, or aluminum oxide.

<<Coloring Layer>>

As examples of a material that can be used for the coloring layers, a metal material, a resin material, and a resin material containing a pigment or dye can be given.

<<Light-Blocking Layer>>

Examples of a material that can be used for the light-blocking layer include carbon black, titanium black, a metal, a metal oxide, and a composite oxide containing a solid solution of a plurality of metal oxides. The light-blocking layer may be a film containing a resin material or a thin film of an inorganic material such as a metal. Stacked films containing the material of the coloring layer can also be used for the light-blocking layer. For example, a stacked-layer structure of a film containing a material of a coloring layer which transmits light of a certain color and a film containing a material of a coloring layer which transmits light of another color can be employed. It is preferable that the coloring layer and the light-blocking layer be formed using the same material because the same manufacturing apparatus can be used and the process can be simplified.

<Cross-Sectional Structure Example 2>

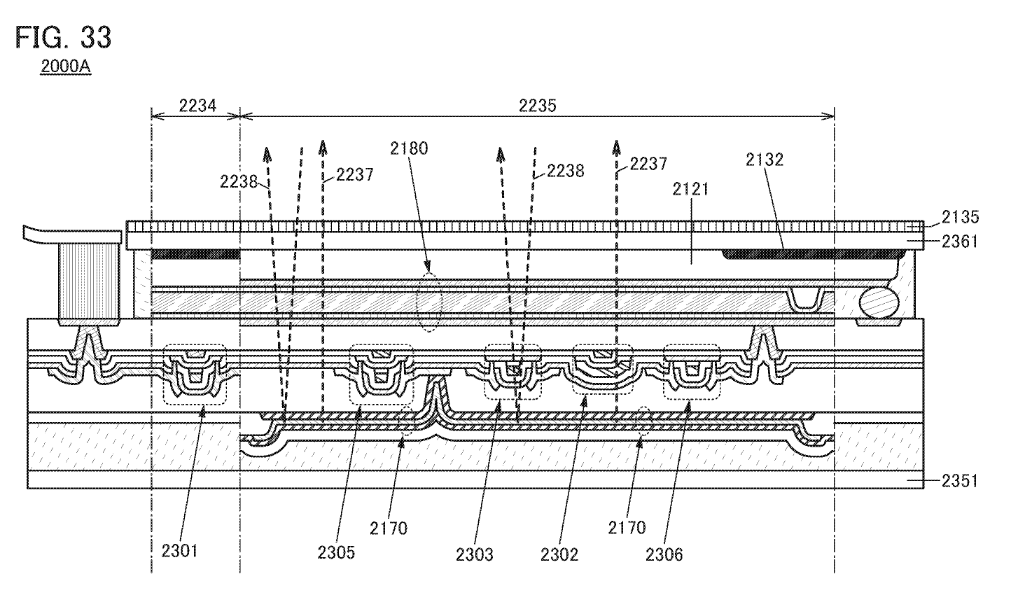

FIG. 33 illustrates a cross section of a display device 2000A that is a modified example of the display device 2000. The display device 2000A is different from the display device 2000 in that the coloring layer 2131 is not provided. Other structures are the same as those of the display device 2000 and thus are not described in detail.

In the display device 2000A, the liquid crystal element 2180 emits white light. Since the coloring layer 2131 is not provided, the display device 2000A can display a black-and-white image or a grayscale image using the liquid crystal element 2180.

<Cross-Sectional Structure Example 3>

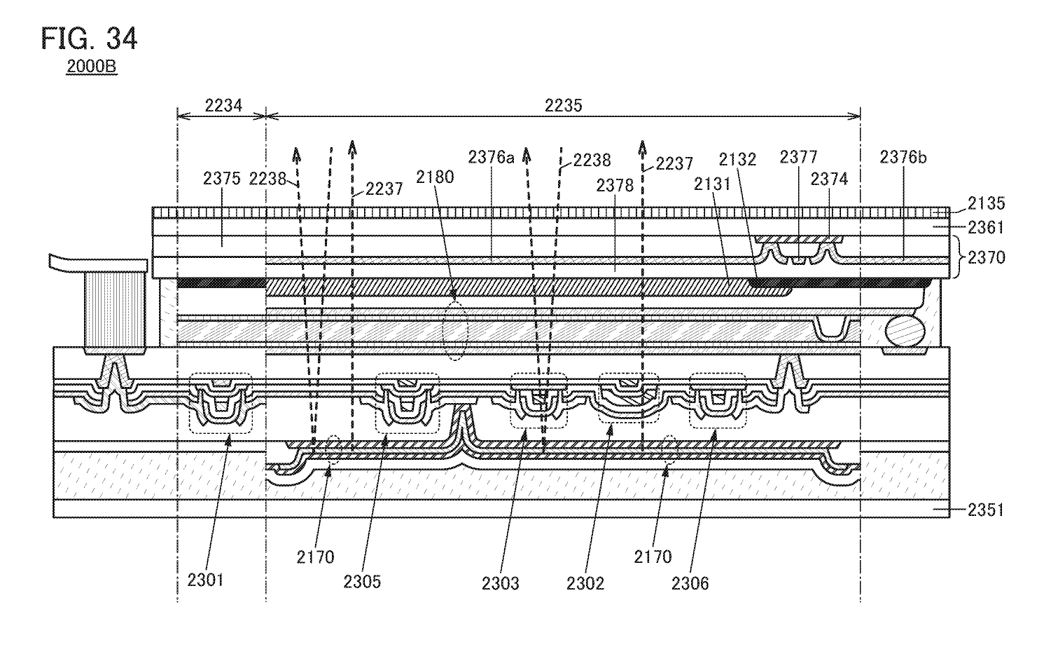

FIG. 34 is a cross-sectional view of a modified example of the display device 2000 (display device 2000B) that is different from the display device 2000A. The display device 2000B includes a touch sensor unit 2370 between the substrate 2361 and the coloring layer 2131. In this embodiment, the touch sensor unit 2370 includes a conductive layer 2374, an insulating layer 2375, a conductive layer 2376a, a conductive layer 2376b, a conductive layer 2377. and an insulating layer 2378.

Each of the conductive layer 2376a, the conductive layer 2376b, and the conductive layer 2377 is preferably formed using a light-transmitting conductive material. The light-transmitting conductive material generally has higher resistance than a non-light-transmitting metal material. Thus, to provide a large-sized touch sensor with high definition, each of the conductive layer 2376a, the conductive layer 2376b, and the conductive layer 2377 is formed using a metal material with low resistance in some cases.

In the case where each of the conductive layer 2376a, the conductive layer 2376b, and the conductive layer 2377 is formed using a metal material, reflection of external light is preferably reduced. A metal material, typically having a high reflectance, can have a dark color and reduce the reflectance through oxidation treatment or the like.

Each of the conductive layer 2376a, the conductive layer 2376b, and the conductive layer 2377 may be a stacked layer of a metal layer and a low-reflectance layer (also referred to as “dark-colored layer”). Examples of dark-colored layers include a layer containing copper chloride or a layer containing copper chloride or tellurium chloride. Alternatively. the dark-colored layer may be formed with a metal particle such as an Ag particle, an Ag fiber, or a Cu particle, a carbon nanoparticle such as a carbon nanotube (CNT) or graphene, or a conductive high molecule such as PEDOT, polyaniline, or polypyrrole, for example.

Other than a resistive touch sensor or a capacitive touch sensor, an optical touch sensor including a photoelectric conversion element may be used as the touch sensor unit 2370. Examples of the capacitive touch sensor are a surface capacitive touch sensor and a projected capacitive touch sensor. Examples of a projected capacitive touch sensor are a self-capacitive touch sensor and a mutual capacitive touch sensor, which differ mainly in the driving method. The use of a mutual capacitive touch sensor is preferable because multiple points can be sensed simultaneously.

Other components are similar to those of the display device 2000 and thus are not described in detail.

In addition, instead of providing the touch sensor unit 2370 between the substrate 2361 and the coloring layer 2131, a touch sensor may be provided to overlap with the substrate 2361 of the display device 2000. For example, a sheet-like touch sensor may be provided so as to overlap with the display region 2235.

There is no particular limitation on the structure of the transistor included in the display device of one embodiment of the present invention. For example, a planar transistor, a staggered transistor, or an inverted staggered transistor may be used. A top-gate transistor or a bottom-gate transistor may be used. Gate electrodes may be provided above and below a channel.

In addition, there is no particular limitation on the crystallinity of a semiconductor material used in a semiconductor layer of the transistor, and an amorphous semiconductor or a semiconductor having crystallinity (a microcrystalline semiconductor, a polycrystalline semiconductor, a single crystal semiconductor, or a semiconductor partly including crystal regions) may be used. It is preferable that a semiconductor having crystallinity be used, in which case deterioration of the transistor characteristics can be suppressed.

For example, as a semiconductor material used for the semiconductor layer in the transistor, silicon, germanium, or the like can be used. Alternatively, a compound semiconductor such as silicon carbide, gallium arsenide, or a nitride semiconductor, an organic semiconductor, or the like can be used.

For example, as a semiconductor material used for the transistor, polycrystalline silicon (polysilicon), amorphous silicon, or the like can be used.

As the transistor, an OS transistor using a metal oxide can be used. When an OS transistor is used. the amount of current flowing between a source and a drain of the transistor that is in an off state can be reduced. Thus, using an OS transistor is preferable. An OS transistor will be described in detail in Embodiment 6.

<Circuit Configuration Example of Pixel>

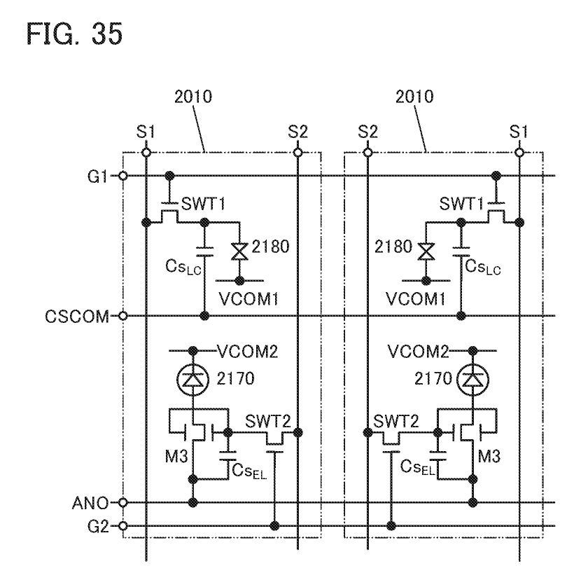

FIG. 35 shows a circuit configuration example of the pixel 2010. In FIG. 35, two pixels 2010 adjacent to each other are illustrated.

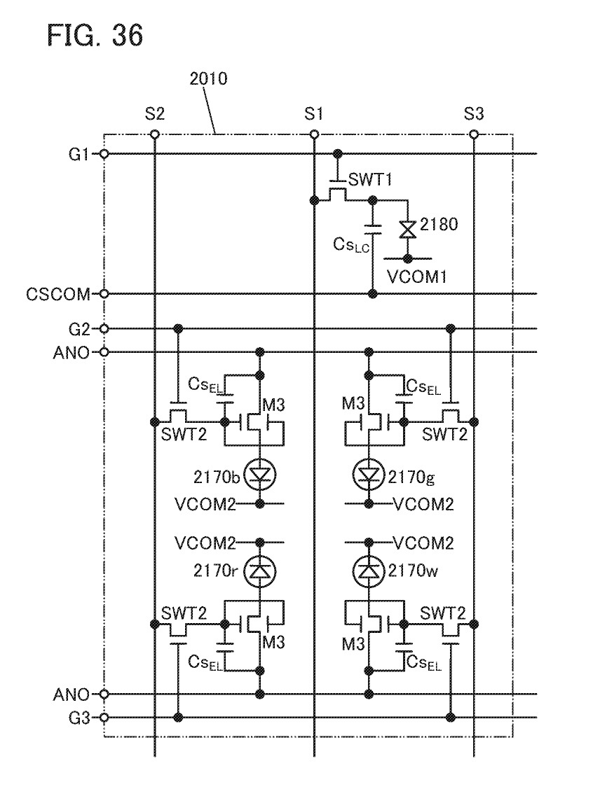

The pixel 2010 includes a switch SWT1, a capacitor C_{SLC}, the liquid crystal element 2180, a switch SWT2, a transistor M3, a capacitor C_{SEL}, the light-emitting element 2170, and the like. The pixel 2010 is electrically connected to a gate line G1, a gate line G2, a current supply line ANO, a wiring CSCOM, a signal line S1, and a signal line S2. FIG. 36 illustrates a wiring VCOM1 electrically connected to the liquid crystal element 2180 and a wiring VCOM2 electrically connected to the light-emitting element 2170.

FIG. 35 shows an example in which transistors are used as the switches SWT1 and SWT2. The switch SWT1 corresponds to the transistor 2271 (transistor M1 in FIG. 29A). The switch SWT2 corresponds to the transistor 2281 (transistor M2 in FIG. 29D). The transistor M3 corresponds to the transistor 2283. The capacitor C_{SLC} corresponds to the capacitor 2272. The capacitor C_{SEL} corresponds to the capacitor 2282 (see FIG. 35 and FIG. 31A).

A gate of the switch SWT1 is connected to the gate line G1. One of a source and a drain of the switch SWT1 is connected to the signal line S1, and the other of the source and the drain is connected to one electrode of the capacitor C_{SLC} and one electrode of the liquid crystal element 2180. The other electrode of the capacitor C_{SLC} is connected to the wiring CSCOM. The other electrode of the liquid crystal element 2180 is connected to the wiring VCOM1.

A gate of the is connected to the gate line G2. One of a source and a drain of the switch SWT2 is connected to the signal line S2, and the other of the source and the drain is connected to one electrode of the capacitor C_{SEL} and a gate of the transistor M3. The other electrode of the capacitor C_{SEL} is connected to one of a source and a drain of the transistor M3 and the current supply line ANO. The other of the source and the drain of the transistor M3 is connected to one electrode of the light-emitting element 2170. The other electrode of the light-emitting element 2170 is connected to the wiring VCOM2.

FIG. 35 illustrates an example where the transistor M3 includes two gates between which a semiconductor is provided and which are connected to each other. This structure can increase the amount of current flowing through the transistor M3.

The gate line G1 can be supplied with a signal for changing the on/off state of the switch SWT1. A predetermined potential can be supplied to the wiring VCOM1. The signal line S1 can be supplied with a signal for changing the orientation of liquid crystals of the liquid crystal element 2180. A predetermined potential can be supplied to the wiring CSCOM.

The gate line G2 can be supplied with a signal for changing the on/off state of the switch SWT2. The wiring VCOM2 and the current supply line ANO can be supplied with potentials having a difference large enough to make the light-emitting element 2170 emit light. The signal line S2 can be supplied with a signal for changing the conduction state of the transistor M3.

In the pixel 2010 of FIG. 35, for example, an image can be displayed in the reflective mode by driving the pixel with the signals supplied to the gate line G1 and the signal line S1 and utilizing the optical modulation of the liquid crystal element 2180. In the light-emitting mode, the pixel can be driven with the signals supplied to the gate lines G2 and S2 to display an image with use of emission by the light-emitting element 2170. In the case where both modes are performed at the same time, the pixel can be driven with the signals supplied to the gate line G1, the gate line G2, the signal line S1, and the signal line S2.

Although FIG. 35 illustrates an example in which one liquid crystal element 2180 and one light-emitting element 2170 are provided in one pixel 2010, one embodiment of the present invention is not limited thereto. FIG. 36 illustrates an example in which one pixel 2010 includes one liquid crystal element 2180 and four light-emitting elements 2170 (a light-emitting element 2170r, a light-emitting element 2170g8, a light-emitting element 2170b, and a light-emitting element 2170w). The pixel 2010 illustrated in FIG. 36 differs from that in FIG. 35 in being capable of performing full-color display by one pixel.

In FIG. 36, in addition to the wirings in FIG. 35, a gate wiring G3 and a signal line S3 are connected to the pixel 2010.

In the structure shown in FIG. 36, for example, the four light-emitting elements 2170 can be used to emit red (R) light, green (G) light, blue (B) light, and white (W) light, separately. A reflective liquid crystal element which emits white light can be used as the liquid crystal element 2180. In the case of performing display in the reflective mode, white display with high reflectivity can be performed. In the case of performing display in the light-emitting mode, images can be displayed with a high color rendering property at low power consumption.

Although the hybrid display device used for the video display portion 820 in the electronic device 901 is described, one embodiment of the present invention is not limited. For the video display portion 820 in the electronic device 901, a display device other than the above-described hybrid display device can be employed.

For example, the display device includes at least one of an electroluminescence (EL) element (e.g., an EL element including organic and inorganic materials, an organic EL element, or an inorganic EL element), a light-emitting diode (LED) chip (e.g., a white LED chip, a red LED chip, a green LED chip, or a blue LED chip), a transistor (a transistor that emits light depending on current), a plasma display panel (PDP), an electron emitter, a display element including a carbon nanotube, a liquid crystal element, electronic ink, an electrowetting element, an electrophoretic element, a display element using micro electro mechanical systems (MEMS) (such as a grating light valve (GLV). a digital micromirror device (DMD), a digital micro shutter (DMS), MIRASOL (registered trademark), an interferometric modulation (IMOD) element, a MEMS shutter display element, an optical-interference-type MEMS display element, or a piezoelectric ceramic display), quantum dots, and the like. Other than the above, a display medium whose contrast, luminance, reflectance, transmittance, or the like is changed by electric or magnetic action may be included in the display element, the display device, the light-emitting element, or the light-emitting device. Note that examples of display devices having EL elements include an EL display. Examples of a display device including an electron emitter include a field emission display (FED), an SED-type flat panel display (SED: surface-conduction electron-emitter display), and the like. Examples of display devices including liquid crystal elements include a liquid crystal display (e.g., a transmissive liquid crystal display., a transflective liquid crystal display, a reflective liquid crystal display, a direct-view liquid crystal display, or a projection liquid crystal display). Examples of a display device including electronic ink, Electronic Liquid Powder (registered trademark), or an electrophoretic element include electronic paper. Examples of display devices containing quantum dots in each pixel include a quantum dot display. Note that quantum dots may be provided not as display elements but as part of a backlight. The use of quantum dots enables display with high color purity. In the case of a transflective liquid crystal display or a reflective liquid crystal display. some of or all of pixel electrodes function as reflective electrodes. For example, some or all of pixel electrodes are formed to contain aluminum, silver, or the like. In such a case, a memory circuit such as an SRAM can be provided under the reflective electrodes. Thus, the power consumption can be further reduced. Note that in the case of using an LED chip, graphene or graphite may be provided under an electrode or a nitride semiconductor of the LED chip. Graphene or graphite may be a multilayer film in which a plurality of layers are stacked. As described above, the provision of graphene or graphite enables easy formation of a nitride semiconductor thereover, such as an n-type GaN semiconductor layer including crystals. Furthermore, a p-type GaN semiconductor layer including crystals or the like can be provided thereover, and thus the LED chip can be formed. Note that an AlN layer may be provided between the n-type GaN semiconductor layer including crystals and graphene or graphite. The GaN semiconductor layers included in the LED chip may be formed by MOCVD. Note that when the graphene is provided, the GaN semiconductor layers included in the LED chip can also be formed by a sputtering method. In the case of a display element including microelectromechanical systems (MEMS), a dry agent may be provided in a space where the display element is sealed (e.g., between an element substrate over which the display element is placed and a counter substrate opposed to the element substrate). Providing a dry agent can prevent MEMS and the like from becoming difficult to move or deteriorating easily because of moisture or the like.

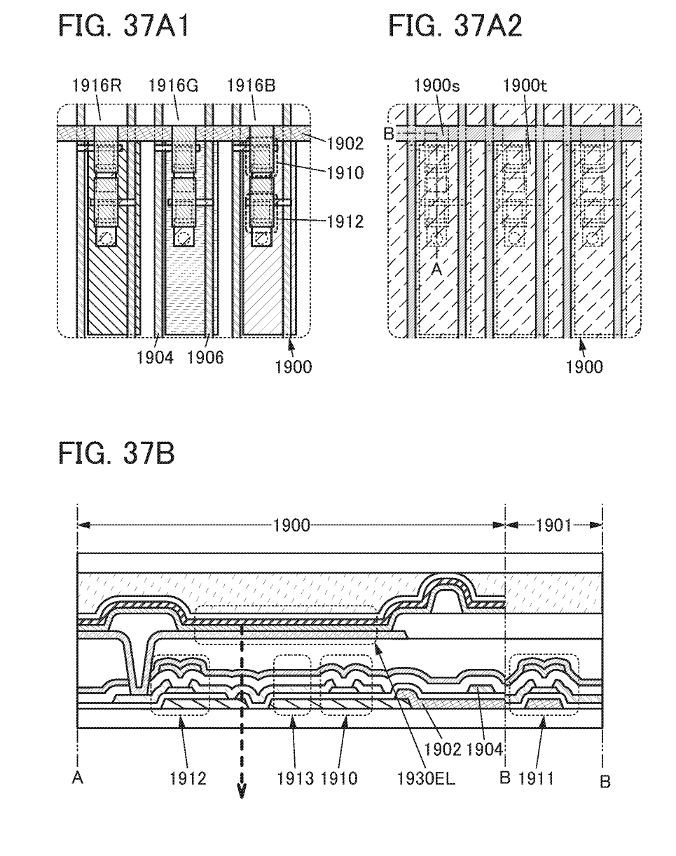

As an example of a display device using the video display portion 820 of the electronic device 901. a display device including an organic EL element can be given. FIGS. 37A1, 37A2, and 37B are top views and a cross-sectional view illustrating a pixel of a display device using an organic EL element.

FIG. 37A1 is a schematic top view of a pixel 1900 seen from the display surface side. The pixel 1900 in FIG. 37A1 includes three subpixels. Each of the subpixels includes a light-emitting element 1930EL (not illustrated in FIGS. 37A1 and 37A2), a transistor 1910, and a transistor 1912. In FIG. 37A1, each of the subpixels has a light-emitting region (a light-emitting region 1916R. a light-emitting region 1916G or a light-emitting region 1916B) of the light-emitting element 1930EL. The light-emitting element 1930EL emits light toward the transistors 1910 and 1912; that is, it is a bottom-emission light-emitting element.

The pixel 1900 includes a wiring 1902, a wiring 1904, a wiring 1906, and the like. The wiring 1902 functions as a scan line, for example. The wiring 1904 functions as a signal line, for example. The wiring 1906 functions as a power source line for supplying a potential to the light-emitting element, for example. The wiring 1902 intersects with the wiring 1904. The wiring 1902 intersects with the wiring 1906. Although the example here shows the structure where the wiring 1902 intersects with the wirings 1904 and 1906, the structure is not limited thereto, and the wiring 1904 may intersect with the wiring 1906.

The transistor 1910 serves as a selection transistor. A gate of the transistor 1910 is electrically connected to the wiring 1902. One of a source and a drain of the transistor 1910 is electrically connected to the wiring 1904.

The transistor 1912 controls a current flowing to the light-emitting element. A gate of the transistor 1912 is electrically connected to the other of the source and the drain of the transistor 1910. One of a source and a drain of the transistor 1912 is electrically connected to the wiring 1906, and the other is electrically connected to one of a pair of electrodes of the light-emitting element 1930EL.

In FIG. 37A1, the light-emitting regions 1916R, 1916G, and 1916B each have a stripe shape long in the vertical direction, and they are arranged in the horizontal direction to form a striped pattern.

The wirings 1902, 1904, and 1906 each have a light-blocking property. Furthermore. layers other than the layers included in the above wirings, that is, layers included in the transistors 1910 and 1912, wirings connected to the transistors, a contact, a capacitor, and the like are each preferably a light-transmitting film. In FIG. 37A2, a transmissive region 1900t that transmits visible light and a light-blocking region 1900s that blocks visible light, which are included in the pixel 1900 of FIG. 37A1, are separately shown. As shown in the drawing, when the transistor is formed with a light-transmitting film, a portion other than the area where the wirings are provided can be the transmissive region 1900t.

The higher the proportion of the area of the transmissive region to the area of the pixel is, the higher the light extraction efficiency of the light-emitting element is. The proportion of the area of the transmissive region to the area of the pixel is, for example, greater than or equal to 1% and less than or equal to 95%, preferably greater than or equal to 10% and less than or equal to 90%, further preferably greater than or equal to 20% and less than or equal to 80%. A particularly preferable proportion is greater than or equal to 40% or greater than or equal to 50%, still further preferably greater than or equal to 60% and less than or equal to 80%.

FIG. 37B is a cross-sectional view corresponding to a cross section taken along dashed-dotted line A-B in FIG. 37A2. FIG. 37B illustrates also cross sections of the light-emitting element 1930EL, a capacitor 1913, a driver circuit portion 1901, and the like that are not illustrated in the top views. The driver circuit portion 1901 can be used as a scan line driver circuit portion or a signal line driver circuit portion. The driver circuit portion 1901 includes a transistor 1911.

As shown in FIG. 37B, the light-emitting element 1930EL emits light in the direction of a dashed arrow. The light from the light-emitting element 1930EL goes through the transistor 1910, the transistor 1912, the capacitor 1913, and the like and is extracted to the outside. Thus, a film included in the capacitor 1913 or the like also preferably has a light-transmitting property. The increased area of the light-transmitting region of the capacitor 1913 can decrease attenuation of light emitted from the light-emitting element 1930EL.

The transistor 1911 in the driver circuit portion 1901 may have a light-blocking property. When the transistor 1911 and the like in the driver circuit portion 1901 have light-blocking properties, the reliability of a driver circuit portion and the drive capability can be heightened. Thus, it is preferable to use light-blocking conductive films for a gate electrode, a source electrode, and a drain electrode of the transistor 1911. Wirings connected to them are also preferably formed with light-blocking conductive films.

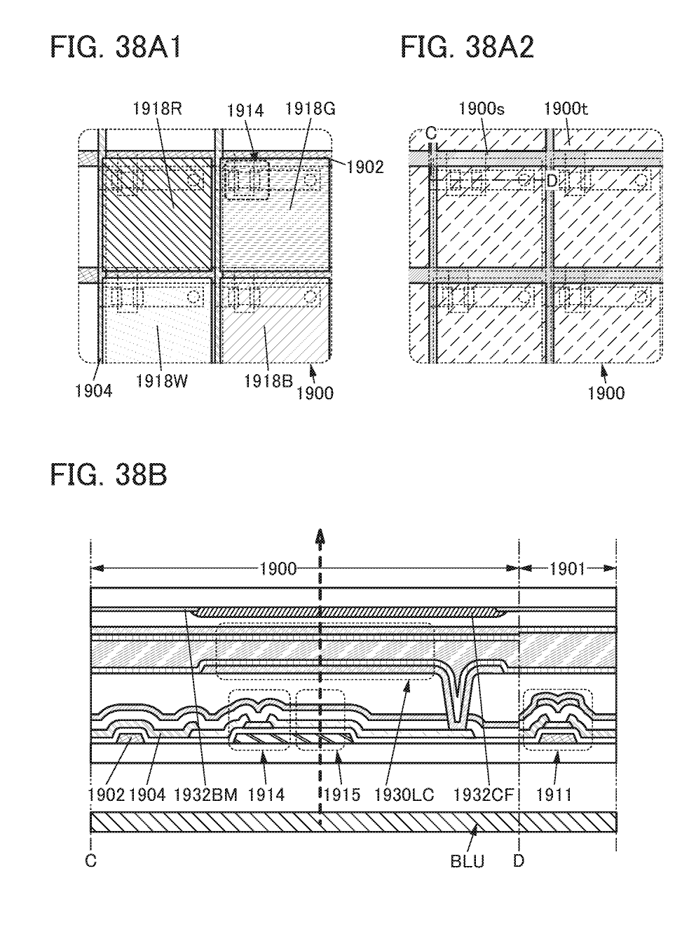

As another example of a display device that can use the video display portion 820 of the electronic device 901, which is different from the display device using the hybrid display device or the organic EL. a display device using a reflective element can be given. FIGS. 38A1, 38A2, and 38B are top views and a cross-sectional view of a pixel of a display device using a liquid crystal element.

FIG. 38A1 is a schematic top view of the pixel 1900. The pixel 1900 in FIG. 38A1 includes four subpixels. In the example of FIG. 38A1, the subpixels in the pixel 1900 are arranged in two rows and two columns. Each of the subpixels includes a transmissive liquid-crystal element 1930LC (not illustrated in FIGS. 38A1 and 38A2), a transistor 1914, and the like. In FIG. 38A1, the two wiring 1902 and the two wirings 1904 are provided in the pixel 1900. In FIG. 38A1, each of the subpixels has a display region (a display region 1918R, a display region 1918G, a display region 1918B, or a display region 1918W) of the liquid crystal element. Light emitted from a backlight unit (BLU) enters the liquid-crystal element 1930LC through the transistor 1914 and the like.

The pixel 1900 includes the wiring 1902, the wiring 1904, and the like. The wiring 1902 functions as a scan line, for example. The wiring 1904 functions as a signal line, for example. The wiring 1902 intersects with the wiring 1904.

The transistor 1914 functions as a selection transistor. A gate of the transistor 1914 is electrically connected to the wiring 1902. One of a source and a drain of the transistor 1914 is electrically connected to the wiring 1904, and the other of the source and the drain of the transistor 1914 is electrically connected to the liquid crystal element 1930LC.

The wiring 1902 and the wiring 1904 each have a light-blocking property. Layers included in the transistor 1914, a wiring connected to the transistor 1914, a contact, a capacitor, and the like, that is, layers other than the layers included in the above wirings, are each preferably a light-transmitting film. In FIG. 38A2, the transmissive region 1900t that transmits visible light and the light-blocking region 1900s that blocks visible light, which are included in the pixel 1900 of FIG. 38A1, are separately shown. As shown in the drawing, when the transistor is formed with a light-transmitting film, a portion other than the area where the wirings are provided can be the transmissive region 1900t. Furthermore, the transmissive region of the liquid crystal element can overlap with the transistor, the wiring connected to the transistor, the contact, the capacitor, and the like, and thus the aperture ratio of the pixel can be increased.

The higher the proportion of the area of the transmissive region to the area of the pixel is, the larger the amount of transmitted light is. The proportion of the area of the transmissive region to the area of the pixel is, for example, greater than or equal to 1% and less than or equal to 95%, preferably greater than or equal to 10% and less than or equal to 90%, further preferably greater than or equal to 20% and less than or equal to 80%. A particularly preferable proportion is greater than or equal to 40% or greater than or equal to 50%, still preferably greater than or equal to 60% and less than or equal to 80%.

FIG. 38B is a cross-sectional view corresponding to a cross section taken along dashed-dotted line C-D in FIG. 38A2. FIG. 38B illustrates also cross sections of the liquid crystal element 1930LC, a coloring film 1932CF a light-blocking film 1932BM, a capacitor 1915, the driver circuit portion 1901, and the like that are not illustrated in the top views. The driver circuit portion 1901 can be used as a scan line driver circuit portion or a signal line driver circuit portion. The driver circuit portion 1901 includes the transistor 1911.

As shown in FIG. 38B, the BLU emits light in the direction of a dashed arrow. The light from the BLU goes through the transistor 1914, the capacitor 1915, and the like, and is extracted to the outside. Thus, films included in the transistor 1914 and the capacitor 1915 also preferably have a light-transmitting property. The increased area of the light-transmitting region of the transistor 1914, the capacitor 1915. and the like enables further efficient use of light from the BLU.

The light from the BLU may be extracted through the coloring film 1932CF to the outside, as shown in FIG. 38B. The light through the coloring film 1932CF can be colored in a desired color. The coloring film 1932CF has a color selected from red (R), green (G), blue (B), cyan (C), magenta (M), yellow (Y), and the like.

Note that this embodiment can be combined with any of the other embodiments in this specification as appropriate.

### Embodiment 6

In this embodiment, structures of the OS transistors used in any of the above embodiments will be described.

<Structure Example 1 of OS Transistor>

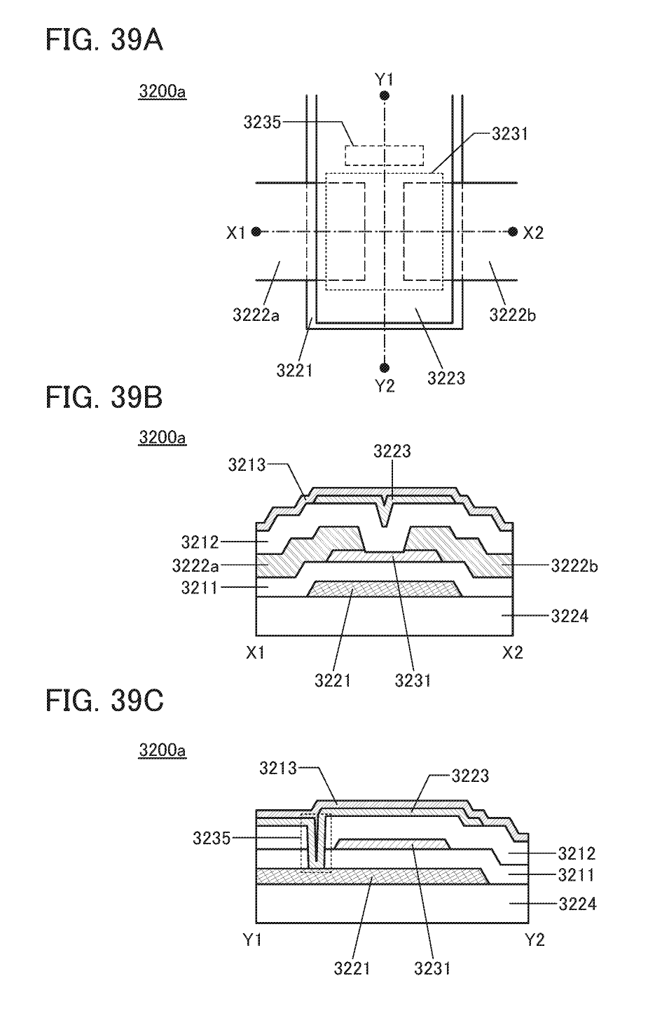

To show a structure example of a transistor, a transistor 3200a is described with reference to FIGS. 39A to 39C. FIG. 39A is a top view of the transistor 3200a. FIG. 39B is a cross-sectional view corresponding to a cross section along dashed-dotted line X1-X2 in FIG. 39A, and FIG. 39C is a cross-sectional view corresponding to a cross section along dashed-dotted line Y1-Y2 in FIG. 39A. Note that in FIG. 39A, some components of the transistor 3200a (e.g., an insulating layer serving as a gate insulating layer) are not illustrated to avoid complexity. Note that hereinafter, the direction of the dashed-dotted line X1-X2 may be called the channel length direction, and the direction of the dashed-dotted line Y1-Y2 may be called the channel width direction. As in FIG. 39A, some components are not illustrated in some cases in top views of transistors described below.

The transistor 3200a includes a conductive layer 3221 over an insulating layer 3224; an insulating layer 3211 over the insulating layer 3224 and the conductive layer 3221; a metal oxide layer 3231 over the insulating layer 3211; a conductive layer 3222a over the metal oxide layer 3231; a conductive layer 3222b over the metal oxide layer 3231: an insulating layer 3212 over the metal oxide layer 3231, the conductive layer 3222a, and the conductive layer 3222b: a conductive layer 3223 over the insulating layer 3212; and an insulating layer 3213 over the insulating layer 3212 and the conductive layer 3223.

The insulating layers 3211 and 3212 have an opening 3235. The conductive layer 3223 is electrically connected to the conductive layer 3221 in the opening 3235.

The insulating layer 3211 serves as a first gate insulating layer of the transistor 3200a. The insulating layer 3212 serves as a second gate insulating layer of the transistor 3200a. The insulating layer 3213 serves as a protective insulating layer of the transistor 3200a. The conductive layer 3221 serves as a first gate of the transistor 3200a. The conductive layer 3222a serves as one of a source and a drain of the transistor 3200a and the conductive layer 3222b serves as the other of the source and the drain. The conductive layer 3223 serves as a second gate of the transistor 3200a.

Note that the transistor 3200a is a channel-etched transistor, and has a dual-gate structure.

The transistor 3200a without the conductive layer 3223 is also available. In that case, the transistor 3200a is a channel-etched transistor, and has a bottom-gate structure.

As shown in FIGS. 39B and 39C, the metal oxide layer 3231 faces to the conductive layer 3221 and the conductive layer 3223. and is between the two conductive layers serving as the gates. The length of the conductive layer 3223 in the channel length direction is longer than the length of the metal oxide layer 3231 in the channel length direction. The length of the conductive layer 3223 in the channel width direction is longer than the length of the metal oxide layer 3231 in the channel width direction. The whole metal oxide layer 3231 is covered with the conductive layer 3223 with the insulating layer 3212 therebetween.

In other words, the conductive layers 3221 and 3223 are connected to each other in the opening 3235 provided in the insulating layers 3211 and 3212, and have a region located outside a side end portion of the metal oxide layer 3231.

With this structure, the metal oxide layer 3231 included in the transistor 3200a can be electrically surrounded by electric fields of the conductive layers 3221 and 3223. A device structure of a transistor in which electric fields of a first gate and a second gate electrically surround a metal oxide layer where a channel region is formed, like in the transistor 3200a, can be referred to as a surrounded channel (S-channel) structure.

Since the transistor 3200a has the S-channel structure, an electric field for inducing a channel can be effectively applied to the metal oxide layer 3231 by the conductive layer 3221 functioning as the first gate; therefore, the current drive capability of the transistor 3200a can be improved and high on-state current characteristics can be obtained. Since the on-state current can be increased, it is possible to reduce the size of the transistor 3200a. In addition, since the transistor 3200a has a structure in which the metal oxide layer 3231 is surrounded by the conductive layer 3221 serving as the first gate and the conductive layer 3223 serving as the second gate, the mechanical strength of the transistor 3200a can be increased.

It is preferable that the metal oxide layer 3231 contain In. M (M is gallium, aluminum, silicon, boron, yttrium, tin, copper, vanadium. beryllium, titanium. iron, nickel, germanium, zirconium, molybdenum, lanthanum, cerium, neodymium. hafnium, tantalum, tungsten, or magnesium), and Zn, for example.

The metal oxide layer 3231 preferably includes a region in which the atomic proportion of In is larger than the atomic proportion of M. For example, the atomic ratio of In to M and Zn in the metal oxide layer 3231 is preferably In-M:Zn=4:2:3 or in the neighborhood thereof. As for the range expressed by the term “neighborhood” here, when In is 4, M ranges from 1.5 to 2.5 inclusive and Zn ranges from 2 to 4 inclusive. Alternatively, the atomic ratio of In to M and Zn in each of the metal oxide layer 3231 is preferably 5:1:6 or in its neighborhood.

The metal oxide layer 3231 is preferably a CAC-OS. When the metal oxide layer 3231 is a CAC-OS and has a region in which the atomic proportion of In is higher than the atomic proportion of M, the transistor 3200a can have high field-effect mobility. Note that the details of the CAC-OS will be described later.

Since the transistor 3200a having the S-channel structure has high field-effect mobility and high driving capability, the use of the transistor 3200a in the driver circuit, a typical example of which is a gate driver that generates a gate signal, allows the display device to have a narrow bezel. The use of the transistor 3200a in a source driver (particularly in a demultiplexer connected to an output terminal of a shift register included in the source driver) that supplies a signal to a signal line included in the display device can reduce the number of wirings connected to the display device.

Furthermore, the transistor 3200a is a channel-etched transistor and thus can be fabricated through a smaller number of steps than a transistor formed using low-temperature polysilicon. In addition, the metal oxide layer is used for the channel of the transistor 3200a; thus, unlike the transistor formed using low-temperature polysilicon, a laser crystallization step is unnecessary. Accordingly, the manufacturing cost can be reduced even for a display device with a large substrate. Transistors having high field-effect mobility like the transistor 3200a are preferably used in a driver circuit and a display portion of a large display device having high resolution such as ultra-high definition (4K resolution, 4K2K, or 4K) or super high definition (8K resolution, 8K4K, or 8K), in which case writing can be performed in a short time and display defects can be reduced.

The insulating layers 3211 and 3212 in contact with the metal oxide layer 3231 are preferably oxide insulating films, and further preferably includes a region containing oxygen in excess of the stoichiometric composition (oxygen-excess region). In other words, the insulating layers 3211 and 3212 are insulating films from which oxygen can be released. In order to provide the oxygen-excess region in the insulating layers 3211 and 3212, the insulating layers 3211 and 3212 are formed in an oxygen atmosphere, or the deposited insulating layers 3211 and 3212 are subjected to heat treatment in an oxygen atmosphere, for example.

An oxide semiconductor, which is a kind of metal oxide, can be used as the metal oxide layer 3231.

In the case where the metal oxide layer 3231 includes an In-M-Zn oxide, it is preferable that the atomic ratio of metal elements of a sputtering target used for forming the In-M-Zn oxide satisfy In >M. The atomic ratio of metal elements in such a sputtering target is, for example, In:M:Zn=2:1:3, In:M:Zn=3:1:2, In:M:Zn=4:2:4.1, In:M:Zn=5:1:6. In:M:Zn=5:1:7. In:M:Zn=5:1:8, In:M:Zn=6:1:6, In:M:Zn=5:2:5. or the like.

In the case where the metal oxide layer 3231 is formed using an In-M-Zn oxide, it is preferable to use a target including a polycrystalline In-M-Zn oxide as the sputtering target. The use of the target including a polycrystalline In-M-Zn oxide facilitates formation of the metal oxide layer 3231 having crystallinity. Note that the atomic ratio of metal elements in the formed metal oxide layer 3231 varies from the above atomic ratios of metal elements of the sputtering targets in a range of ±40%. For example, when a sputtering target with an atomic ratio of In:Ga:Zn=4:2:4.1 is used for forming the metal oxide layer 3231, the atomic ratio of In to Ga and Zn in the formed metal oxide layer 3231 may be 4:2:3 or in the neighborhood of 4:2:3.

The energy gap of the metal oxide layer 3231 is 2 eV or more, preferably 2.5 eV or more. The use of such an oxide semiconductor having a wide energy gap leads to a reduction in off-state current of a transistor.

Furthermore, the metal oxide layer 3231 preferably has a non-single-crystal structure. The non-single-crystal structure includes a c-axis-aligned crystalline (CAAC) structure, a polycystalline structure, a microcrystalline structure, or an amorphous structure, for example. Among the non-single-crystal structures, the amorphous structure has the highest density of defect states, whereas the CAAC structure has the lowest density of defect states.

The metal oxide layer 3231 formed with a metal oxide film with low impurity concentration and low density of defect states can give the transistor excellent electrical characteristics. Thus, the use of such a metal oxide film is preferable. Here, the state in which impurity concentration is low and density of defect states is low (the number of oxygen vacancies is small) is referred to as “highly purified intrinsic” or “substantially highly purified intrinsic.” Note that impurities in a metal oxide film are typically water, hydrogen, and the like. In this specification and the like, reducing or removing water and hydrogen from a metal oxide film is referred to as dehydration or dehydrogenation in some cases. Moreover, adding oxygen to a metal oxide film or an oxide insulating film is referred to as oxygen addition in some cases, and a state in which oxygen in excess of the stoichiometric composition is contained due to the oxygen addition is referred to as an oxygen-excess state in some cases.

A highly purified intrinsic or substantially highly purified intrinsic metal oxide film has few carrier generation sources, and thus has a low carrier density. Thus, a transistor in which a channel region is formed in the metal oxide film rarely has a negative threshold voltage (is rarely normally on). The highly purified intrinsic or substantially highly purified intrinsic metal oxide film has a low density of defect states and accordingly has a low density of trap states in some cases. Furthermore, the highly purified intrinsic or substantially highly purified intrinsic metal oxide film has an extremely low off-state current; even when the element has a channel width of 1×10⁶ μm and a channel length of 10 μm, the off-state current can be lower than or equal to the lower measurement limit of a semiconductor parameter analyzer, i.e., lower than or equal to 1 x 10⁻¹³ A, at a voltage (drain voltage) between a source electrode and a drain electrode of from 1 V to 10V.

The insulating layer 3213 includes one or both of hydrogen and nitrogen. Alternatively, the insulating layer 3213 includes nitrogen and silicon. The insulating layer 3213 has a function of blocking oxygen, hydrogen, water, alkali metal, alkaline earth metal, or the like. The insulating layer 3213 can prevent outward diffusion of oxygen from the metal oxide layer 3231. outward diffusion of oxygen from the insulating layer 3212, and entry of hydrogen, water. or the like into the metal oxide layer 3231 from the outside.

The insulating layer 3213 can be a nitride insulating film. for example. The nitride insulating film is formed of silicon nitride, silicon nitride oxide, aluminum nitride, aluminum nitride oxide, or the like.

<Structure Example 2 of OS Transistor>

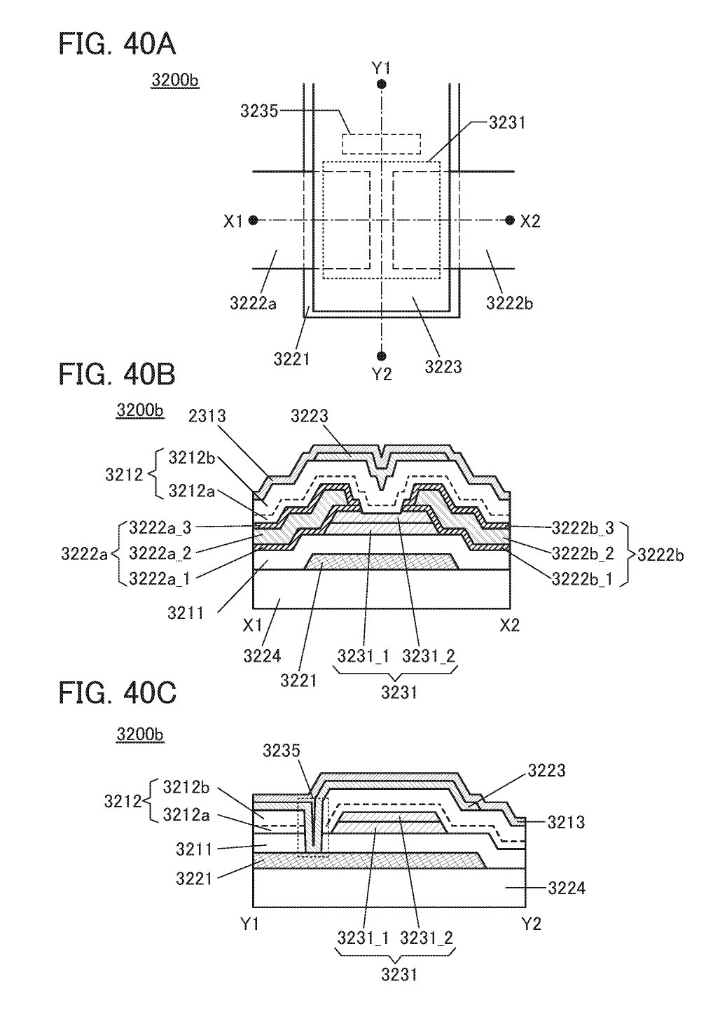

To show a structure example of a transistor, a transistor 3200b is described with reference to FIGS. 40A to 40C. FIG. 40A is a top view of the transistor 3200b. FIG. 40B is a cross-sectional view corresponding to a cross section along dashed-dotted line X1-X2 in FIG. 40A, and FIG. 40C is a cross-sectional view corresponding to a cross section along dashed-dotted line Y1-Y2 in FIG. 40A.

The transistor 3200b is different from the transistor 3200a in that the metal oxide layer 3231, the conductive layer 3222a, the conductive layer 3222b, and the insulating layer 3212 each have a multi-layer structure.

The insulating layer 3212 includes an insulating layer 3212a over the metal oxide layer 3231 and the conductive layers 3222a and 3222b, and an insulating layer 3212b over the insulating layer 3212a. The insulating layer 3212 has a function of supplying oxygen to the metal oxide layer 3231. That is, the insulating layer 3212 contains oxygen. The insulating layer 3212a is an insulating layer that allows oxygen to pass therethrough. Note that the insulating layer 3212a serves also as a film that relieves damage to the metal oxide layer 3231 at the time of forming the insulating layer 3212b.

A silicon oxide, a silicon oxynitride, or the like with a thickness greater than or equal to 5 nm and less than or equal to 150 nm. preferably greater than or equal to 5 nm and less than or equal to 50 nm can be used as the insulating layer 3212a.

Further, it is preferable that the number of defects in the insulating layer 3212a be small and typically, the spin density of a signal that appears at g=2.001 due to a dangling bond of silicon be lower than or equal to 3×10¹⁷ spins/cm³ by electron spin resonance (ESR) measurement. This is because if the density of defects in the insulating layer 3212a is high, oxygen is bonded to the defects and the property of transmitting oxygen of the insulating layer 3212a is lowered.

Note that not all oxygen that has entered the insulating layer 3212a from the outside moves to the outside of the insulating layer 3212a but some oxygen remains in the insulating layer 3212a. In some cases, movement of oxygen occurs in the insulating layer 3212a in such a manner that oxygen included in the insulating layer 3212a moves to the outside of the insulating layer 3212a upon the entry of oxygen into the insulating layer 3212a. When an oxide insulating layer that can transmit oxygen is formed as the insulating layer 3212a, oxygen released from the insulating layer 3212b provided over the insulating layer 3212a can be moved to the metal oxide layer 3231 through the insulating layer 3212a.

The insulating layer 3212a can be formed using an oxide insulating layer having a low density of states due to nitrogen oxide. Note that the density of states due to nitrogen oxide can be formed between the valence band maximum (Ev_os) and the conduction band minimum (Ec_os) of the metal oxide film. A silicon oxynitride film that releases a small amount of nitrogen oxide, an aluminum oxynitride film that releases a small amount of nitrogen oxide, or the like can be used as the above oxide insulating layer.

Note that a silicon oxynitride film that releases a small amount of nitrogen oxide is a film which releases ammonia more than nitrogen oxide in thermal desorption spectroscopy (TDS) analysis: the amount of released ammonia is typically greater than or equal to 1×10¹⁸/cm³ and less than or equal to 5×10¹⁹/cm³. Note that the amount of released ammonia is the amount of ammonia released by heat treatment with which the surface temperature of the film becomes higher than or equal to 50° C. and lower than or equal to 650° C., preferably higher than or equal to 50° C. and lower than or equal to 550° C.

Nitrogen oxide (NOₓ; x is greater than 0 and less than or equal to 2, preferably greater than or equal to 1 and less than or equal to 2), typically NO₂ or NO, forms levels in the insulating layer 3212a. for example. The level is positioned in the energy gap of the metal oxide layer 3231. Therefore, when nitrogen oxide is diffused to the interface between the insulating layer 3212a and the metal oxide layer 3231, an electron is in some cases trapped by the level on the insulating layer 3212a side. As a result, the trapped electron remains in the vicinity of the interface between the insulating layer 3212a and the metal oxide layer 3231; thus, the threshold voltage of the transistor is shifted in the positive direction.

Nitrogen oxide reacts with ammonia and oxygen in heat treatment. Since nitrogen oxide contained in the insulating layer 3212a reacts with ammonia contained in the insulating layer 3212b in heat treatment, nitrogen oxide contained in the insulating layer 3212a is reduced. Therefore, an electron is hardly trapped at the interface between the insulating layer 3212a and the metal oxide layer 3231.

By using the above oxide insulating layer for the insulating layer 3212a, a shift in the threshold voltage of the transistor can be reduced, which leads to reduced fluctuations in the electrical characteristics of the transistor.

The concentration of nitrogen in the above oxide insulating layer measured by SIMS is lower than or equal to 6×10²⁰ atoms/cm³.

The above oxide insulating layer is formed by a PECVD method at a substrate temperature higher than or equal to 220° C. and lower than or equal to 350° C. using silane and dinitrogen monoxide, whereby a dense and hard film can be formed.

The insulating layer 3212b is an oxide insulating layer that contains oxygen at a higher proportion than the stoichiometric composition. Part of oxygen is released from the above oxide insulating layer by heating. The amount of oxygen released from the oxide insulating layer in TDS is more than or equal to 1.0×10¹⁹ atoms/cm³, preferably more than or equal to 3.0×10²⁰ atoms/cm³. Note that the amount of released oxygen is the total amount of oxygen released by heat treatment in a temperature range of 50° C. to 650° C. or 50° C. to 550° C. in TDS. In addition, the amount of released oxygen is the total amount of released oxygen converted into oxygen atoms in TDS.

A silicon oxide film, a silicon oxynitride film, or the like with a thickness greater than or equal to 30 nm and less than or equal to 500 nm, preferably greater than or equal to 50 nm and less than or equal to 400 nm can be used for the insulating layer 3212b.

It is preferable that the number of defects in the insulating layer 3212b be small and typically, the spin density corresponding to a signal that appears at g=2.001 due to a dangling bond of silicon be lower than 1.5×10¹⁸ spins/cm³. preferably lower than or equal to 1×10¹⁸ spins/cm³ by ESR measurement. Note that the insulating layer 3212b is provided more apart from the metal oxide layer 3231 than the insulating layer 3212a is; thus, the insulating layer 3212b may have higher density of defects than the insulating layer 3212a.

Furthermore, the insulating layer 3212 can include insulating layers including the same kind of material; thus, a boundary between the insulating layer 3212a and the insulating layer 3212b cannot be clearly observed in some cases. Thus, in this embodiment, the boundary between the insulating layer 3212a and the insulating layer 3212b is shown by a dashed line. Although a two-layer structure including the insulating layers 3212a and 3212b is described in this embodiment, the present invention is not limited to this. For example, a single-layer structure including only the insulating layer 3212a or a multi-layer structure including three or more layers may be employed.

The metal oxide layer 3231 in the transistor 3200b includes a metal oxide layer 3231_1 over the insulating layer 3211 and a metal oxide layer 3231_2 over the metal oxide layer 3231_1. The metal oxide layers 3231_1 and 3231_2 contain the same kind of element. For example, it is preferable that the metal oxide layers 3231_1 and 3231_2 each independently contain the same element as the element in the metal oxide layer 3231 that is described above.

Each of the metal oxide layers 3231_1 and 3231_2 preferably contains a region in which the atomic proportion of In is higher than the atomic proportion of M. For example, the atomic ratio of In to M and Zn in each of the metal oxide layers 3231_1 and 3231_2 is preferably In:M:Zn=4:2:3 or in the neighborhood of 4:2:3. As for the range expressed by the term “neighborhood” here, when In is 4, M ranges from 1.5 to 2.5 inclusive and Zn ranges from 2 to 4 inclusive. Alternatively, the atomic ratio of In to M and Zn in each of the metal oxide layers 3231_1 and 3231_2 is preferably In:M:Zn=5:1:6 or in the neighborhood of 5:1:6. The metal oxide layers 3231_1 and 3231_2 having substantially the same composition as described above can be formed using the same sputtering target; thus, the manufacturing cost can be reduced. When the same sputtering target is used, the metal oxide layers 3231_1 and 3231_2 can be formed successively in the same vacuum chamber. This can suppress entry of impurities into the interface between the metal oxide layers 3231_1 and 3231_2.

Here, the metal oxide layer 3231_1 may include a region whose crystallinity is lower than that of the metal oxide layer 3231_2. Note that the crystallinity of the metal oxide layers 3231_1 and 3231_2 can be determined by analysis by X-ray diffraction (XRD) or with a transmission electron microscope (TEM), for example.

The region with low crystallinity in the metal oxide layer 3231_1 serves as a diffusion path of excess oxygen, through which excess oxygen can be diffused into the metal oxide layer 3231_2 having higher crystallinity than the metal oxide layer 3231_1. When a multi-layer structure including the metal oxide layers having different crystal structures is employed and the region with low crystallinity is used as a diffusion path of excess oxygen as described above, the transistor can be highly reliable.

The metal oxide layer 3231_2 having a region with higher crystallinity than the metal oxide layer 3231_1 can prevent impurities from entering the metal oxide layer 3231. In particular, the increased crystallinity of the metal oxide layer 3231_2 can reduce damage at the time of processing the conductive layers 3222a and 3222b. The surface of the metal oxide layer 3231, i.e., the surface of the metal oxide layer 3231_2 is exposed to an etchant or an etching gas at the time of processing the conductive layers 3222a and 3222b. However, when the metal oxide layer 3231_2 has a region with high crystallinity, the metal oxide layer 3231_2 has higher etching resistance than the metal oxide layer 3231_1. Thus, the metal oxide layer 3231_2 serves as an etching stopper.

By including a region having lower crystallinity than the metal oxide layer 3231_2, the metal oxide layer 3231_1 sometimes has a high carrier density.

When the metal oxide layer 3231_1 has a high carrier density, the Fermi level is sometimes high relative to the conduction band of the metal oxide layer 3231_1. This lowers the conduction band minimum of the metal oxide layer 3231_1. so that the energy difference between the conduction band minimum of the metal oxide layer 3231_1 and the trap level, which might be formed in a gate insulating film (here, the insulating layer 3211), is increased in some cases. The increase of the energy difference can reduce trap of charges in the gate insulating film and reduce variation in the threshold voltage of the transistor, in some cases. In addition, when the metal oxide layer 3231_1 has a high carrier density, the metal oxide layer 3231 can have high field-effect mobility.

Although the metal oxide layer 3231 in the transistor 3200b has a multi-layer structure including two layers in this example, the structure is not limited thereto, and the metal oxide layer 3231 may have a multi-layer structure including three or more layers.

The conductive layer 3222a in the transistor 3200b includes a conductive layer 3222a_1, a conductive layer 3222a_2 over the conductive layer 3222a_1, and a conductive layer 3222a_3 over the conductive layer 3222a_2. The conductive layer 3222b in the transistor 3200b includes a conductive layer 3222b_1, a conductive layer 3222b_2 over the conductive layer 3222b_1, and a conductive layer 3222b_3 over the conductive layer 3222b_2.

It is preferable that the conductive layers 3222a_1, 3222b_1, 3222a_3, and 3222b_3 contain one or more elements selected from titanium, tungsten, tantalum, molybdenum, indium, gallium, tin, and zinc, for example. Furthermore, it is preferable that the conductive layers 3222a_2 and 3222b_2 contain one or more elements selected from copper, aluminum, and silver.

More specifically, the conductive layers 3222a_1, 3222b_1, 3222a_3, and 3222b_3 can contain an In-Sn oxide or an In-Zn oxide and the conductive layers 3222a_2 and 3222b_2 can contain copper.

An end portion of the conductive layer 3222a_1 has a region located outside an end portion of the conductive layer 3222a_2. The conductive layer 3222a_3 covers a top surface and a side surface of the conductive layer 3222a_2 and has a region that is in contact with the conductive layer 3222a_1. An end portion of the conductive layer 3222b_1 has a region located outside an end portion of the conductive layer 3222b_2. The conductive layer 3222b_3 covers a top surface and a side surface of the conductive layer 3222b_2 and has a region that is in contact with the conductive layer 3222b_1.

The above structure is preferred because the structure can reduce the wiring resistance of the conductive layers 3222a and 3222b and inhibit diffusion of copper to the metal oxide layer 3231.

<Structure Example 3 of OS Transistor>

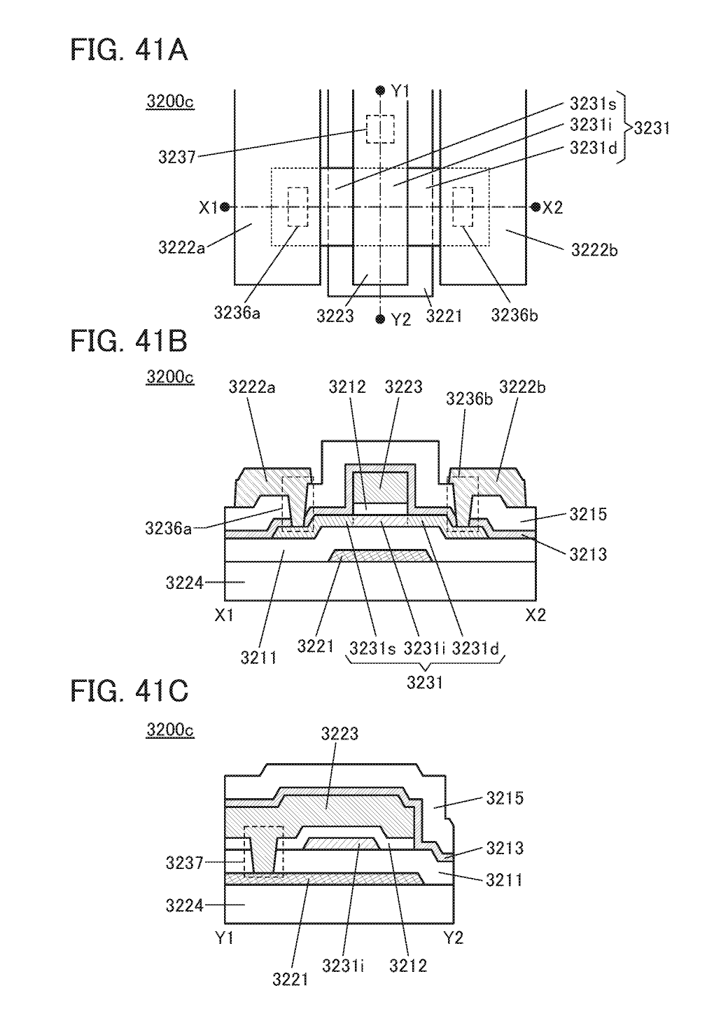

To show a structure example of a transistor, a transistor 3200c is described with reference to FIGS. 41A to 41C. FIG. 41A is a top view of the transistor 3200c. FIG. 41B is a cross-sectional view corresponding to a cross section along dashed-dotted line X1-X2 in FIG. 41A, and FIG. 41C is a cross-sectional view corresponding to a cross section along dashed-dotted line Y1-Y2 in FIG. 41A.

The transistor 3200c shown in FIGS. 41A to 41C includes the conductive layer 3221 over the insulating layer 3224: the insulating layer 3211 over the conductive layer 3221: the metal oxide layer 3231 over the insulating layer 3211; the insulating layer 3212 over the metal oxide layer 3231: the conductive layer 3223 over the insulating layer 3212; and the insulating layer 3213 over the insulating layer 3211. the metal oxide layer 3231, and the conductive layer 3223. The metal oxide layer 3231 includes a channel region 3231i overlapping with the conductive layer 3223. a source region 3231s in contact with the insulating layer 3213, and a drain region 3231d in contact with the insulating layer 3213.

The insulating layer 3213 contains nitrogen or hydrogen. The insulating layer 3213 is in contact with the source region 3231s and the drain region 3231d, so that nitrogen or hydrogen that is contained in the insulating layer 3213 is added to the source region 3231s and the drain region 3231d. The source region 3231s and the drain region 3231d each have a high carrier density when nitrogen or hydrogen is added thereto.

The transistor 3200c may further include an insulating layer 3215 over the insulating layer 3213, the conductive layer 3222a electrically connected to the source region 3231s through an opening 3236a provided in the insulating layers 3213 and 3215, and the conductive layer 3222b electrically connected to the drain region 3231d through an opening 3236b provided in the insulating layers 3213 and 3215.

The insulating layer 3215 can be an oxide insulating film, for example. Alternatively, a multi-layer film including an oxide insulating film and a nitride insulating film can be used as the insulating layer 3215. The insulating layer 3215 can include, for example, silicon oxide, silicon oxynitride, silicon nitride oxide, aluminum oxide, hafnium oxide, gallium oxide, or Ga-Zn oxide. Furthermore, the insulating layer 3215 preferably functions as a barrier film against hydrogen, water, and the like from the outside.

The insulating layer 3211 serves as a first gate insulating film, and the insulating layer 3212 serves as a second gate insulating film. The insulating layers 3213 and 3215 serve as a protective insulating film.

The insulating layer 3212 includes an excess oxygen region. Since the insulating layer 3212 includes the excess oxygen region, excess oxygen can be supplied to the channel region 3231i included in the metal oxide layer 3231. As a result, oxygen vacancies that might be formed in the channel region 3231i can be filled with excess oxygen, which can provide a highly reliable semiconductor device.

To supply excess oxygen to the metal oxide layer 3231. excess oxygen may be supplied to the insulating layer 3211 that is formed below the metal oxide layer 3231. However, in that case, excess oxygen contained in the insulating layer 3211 might also be supplied to the source region 3231s and the drain region 3231d included in the metal oxide layer 3231. When excess oxygen is supplied to the source region 3231s and the drain region 3231d, the resistance of the source region 3231s and the drain region 3231d might be increased.

By contrast, in the structure in which the insulating layer 3212 formed over the metal oxide layer 3231 contains excess oxygen, excess oxygen can be selectively supplied only to the channel region 3231i. Alternatively, the carrier density of the source and drain regions 3231s and 3231d can be selectively increased after excess oxygen is supplied to the channel region 3231i and the source and drain regions 3231s and 3231d, in which case an increase in the resistance of the source and drain regions 3231s and 3231d can be prevented.

Furthermore, each of the source region 3231s and the drain region 3231d included in the metal oxide layer 3231 preferably contains an element that forms an oxygen vacancy or an element that is bonded to an oxygen vacancy. Typical examples of the element that forms an oxygen vacancy or the element that is bonded to an oxygen vacancy include hydrogen, boron, carbon, nitrogen, fluorine, phosphorus, sulfur, chlorine, titanium, and a rare gas. Typical examples of the rare gas element include helium, neon, argon, krypton, and xenon. In the case where one or more of the elements that form oxygen vacancies are contained in the insulating layer 3213, the one or more of the elements are diffused from the insulating layer 3213 to the source region 3231s and the drain region 3231d. Alternatively, one or more of the elements that form oxygen vacancies may be added to the source region 3231s and the drain region 3231d by impurity addition treatment. One or more of the elements that form oxygen vacancies may be introduced in the source region 3231s and the drain region 3231d by both diffusion from the insulating layer 3213 and impurity addition treatment.

An impurity element added to the oxide semiconductor film cuts a bond between a metal element and oxygen in the oxide semiconductor film, so that an oxygen vacancy is formed. Alternatively, when the impurity element is added to the oxide semiconductor film, oxygen bonded to a metal element in the oxide semiconductor film is bonded to the impurity element, and the oxygen is released from the metal element, whereby an oxygen vacancy is formed. As a result, the oxide semiconductor film has a higher carrier density and thus the conductivity thereof becomes higher.

The conductive layer 3221 functions as a first gate electrode and the conductive layer 3223 functions as a second gate electrode. The conductive layer 3222a functions as a source electrode and the conductive layer 3222b functions as a drain electrode.

As shown in FIG. 41C, an opening 3237 is formed in the insulating layers 3211 and 3212. The conductive layer 3221 is electrically connected to the conductive layer 3223 in the opening 3237. Thus, the conductive layers 3221 and 3223 are supplied with the same potential. Note that different potentials may be applied to the conductive layers 3221 and 3223 without providing the opening 3237. Alternatively, the conductive layer 3221 may be used as a light-blocking film without providing the opening 3237. For example, light irradiating the channel region 3231i from the bottom can be prevented by the conductive layer 3221 formed with a light-blocking material.

As illustrated in FIGS. 41B and 41C, the metal oxide layer 3231 faces the conductive layer 3221 functioning as a first gate electrode and the conductive layer 3223 functioning as a second gate electrode and is positioned between the two conductive films functioning as the gate electrodes.

As with the transistors 3200a and 3200b. the transistor 3200c has the S-channel structure. Such a structure enables the metal oxide layer 3231 included in the transistor 3200c to be electrically surrounded by electric fields of the conductive layer 3221 functioning as the first gate electrode and the conductive layer 3223 functioning as the second gate electrode.

Since the transistor 3200c has the S-channel structure, an electric field for inducing a channel can be effectively applied to the metal oxide layer 3231 by the conductive layer 3221 or 3223; thus, the current drive capability of the transistor 3200c can be improved and high on-state current characteristics can be obtained. As a result of the high on-state current, it is possible to reduce the size of the transistor 3200c. Furthermore, since the transistor 3200c has a structure in which the metal oxide layer 3231 is surrounded by the conductive layers 3221 and 3223, the mechanical strength of the transistor 3200c can be increased.

The transistor 3200c may be called a top-gate self-aligned (TGSA) FET from the position of the conductive layer 3223 relative to the metal oxide layer 3231 or the formation method of the conductive layer 3223.

The metal oxide layer 3231 in the transistor 3200c may have a multi-layer structure including two or more layers, as in the transistor 3200b.

Although the insulating layer 3212 is present only in a portion overlapping with the conductive layer 3223 in the transistor 3200c, the structure is not limited thereto, and the insulating layer 3212 may cover the metal oxide layer 3231. Furthermore, the conductive layer 3221 may be omitted.

Note that this embodiment can be combined with any of the other embodiments in this specification as appropriate.

### Embodiment 7

In this embodiment, a metal oxide that can be used for the transistor described in Embodiment 6 will be described. In particular, the details of a metal oxide and a cloud-aligned composite (CAC)-OS are described below.

A CAC-OS or a CAC metal oxide has a conducting function in a part of the material and has an insulating function in another part of the material: as a whole, the CAC-OS or the CAC metal oxide has a function of a semiconductor. In the case where the CAC-OS or the CAC metal oxide is used in a channel formation region of a transistor, the conducting function is to allow electrons (or holes) serving as carriers to flow, and the insulating function is to not allow electrons serving as carriers to flow. By the complementary action of the conducting function and the insulating function, the CAC-OS or the CAC metal oxide can have a switching function (on/off function). In the CAC-OS or CAC-metal oxide, separation of the functions can maximize each function.

The CAC-OS or the CAC metal oxide includes conductive regions and insulating regions. The conductive regions have the above-described conducting function, and the insulating regions have the above-described insulating function. In some cases, the conductive regions and the insulating regions in the material are separated at the nanoparticle level. In some cases, the conductive regions and the insulating regions are unevenly distributed in the material. The conductive regions are observed to be coupled in a cloud-like manner with their boundaries blurred, in some cases.

Furthermore, in the CAC-OS or the CAC metal oxide, the conductive regions and the insulating regions each have a size more than or equal to 0.5 nm and less than or equal to 10 nm, preferably more than or equal to 0.5 nm and less than or equal to 3 nm and are dispersed in the material, in some cases.

The CAC-OS or the CAC metal oxide includes components having different bandgaps. For example, the CAC-OS or the CAC metal oxide includes a component having a wide gap due to the insulating region and a component having a narrow gap due to the conductive region. In the case of such a composition, carriers mainly flow in the component having a narrow gap. The component having a narrow gap complements the component having a wide gap, and carriers also flow in the component having a wide gap in conjunction with the component having a narrow gap. Therefore, in the case where the above-described CAC-OS or the CAC metal oxide is used in a channel formation region of a transistor, high current drive capability in the on state of the transistor, that is, a high on-state current and high field-effect mobility, can be obtained.

In other words, CAC-OS or CAC-metal oxide can be called a matrix composite or a metal matrix composite. Thus, CAC-OS may be called a cloud-aligned composite OS.

The CAC-OS has, for example, a composition in which elements included in a metal oxide are unevenly distributed. Materials including unevenly distributed elements each have a size greater than or equal to 0.5 nm and less than or equal to 10 nm, preferably greater than or equal to 1 nm and less than or equal to 2 nm, or a similar size. Note that in the following description of a metal oxide, a state in which one or more metal elements are unevenly distributed and regions including the metal element(s) are mixed is referred to as a mosaic pattern or a patch-like pattern. The regions each have a size greater than or equal to 0.5 nm and less than or equal to 10 nm. preferably greater than or equal to 1 nm and less than or equal to 2 nm, or a similar size.

Note that a metal oxide preferably contains at least indium. In particular, indium and zinc are preferably contained. In addition, aluminum, gallium, yttrium, copper, vanadium, beryllium, boron, silicon, titanium, iron, nickel, germanium, zirconium, molybdenum, lanthanum. cerium, neodymium, hafnium, tantalum, tungsten, magnesium, and the like may be contained.

For example, of the CAC-OS, an In-Ga-Zn oxide with the CAC composition (such an In-Ga-Zn oxide may be particularly referred to as CAC-IGZO) has a composition in which materials are separated into indium oxide (InO_{X1}, where X1 is a real number greater than 0) or indium zinc oxide (In_{X2}Zn_{Y2}O_{Z2}, where X2, Y2, and Z2 are real numbers greater than 0), and gallium oxide (GaO_{X3}, where X3 is a real number greater than 0), or gallium zinc oxide (Ga_{X4}Zn_{Y4}O_{Z4}, where X4, Y4, and Z4 are real numbers greater than 0), and a mosaic pattern is formed. Then, InO_{X1} or In_{X2}Zn_{Y2}O_{Z2} forming the mosaic pattern is evenly distributed in the film. This composition is also referred to as a cloud-like composition.

That is, the CAC-OS is a composite metal oxide with a composition in which a region including GaO_{X3} as a main component and a region including In_{X2}Zn_{Y2}O_{Z2} or InO_{X1} as a main component are mixed. Note that in this specification, for example, when the atomic ratio of In to an element M in a first region is greater than the atomic ratio of In to an element M in a second region, the first region has higher In concentration than the second region.

Note that a compound including In, Ga, Zn, and O is also known as IGZO. Typical examples of IGZO include a crystalline compound represented by InGaO₃(ZnO)ₘ₁ (m1 is a natural number) and a crystalline compound represented by In₍₁₊ₓ₀₎Ga₍₁₋ₓ₀₎O₃(ZnO)ₘ₀ (−1≤x0≤1; m0 is a given number).

The crystalline compound has a single crystal structure, a polycrystalline structure, or a c-axis aligned crystalline (CAAC) structure. Note that the CAAC structure is a crystal structure in which a plurality of IGZO nanocrystals have c-axis alignment and are connected in the a-b plane direction without alignment.

On the other hand, the CAC-OS relates to the material composition of a metal oxide.

In part of the material composition of a CAC-OS containing In, Ga. Zn, and O. nanoparticle regions including Ga as a main component and nanoparticle regions including In as a main component are observed. These nanoparticle regions are randomly dispersed to form a mosaic pattern. Therefore, the crystal structure is a secondary element for the CAC-OS.

Note that in the CAC-OS, a stacked-layer structure including two or more films with different atomic ratios is not included. For example, a two-layer structure of a film including In as a main component and a film including Ga as a main component is not included.

A boundary between the region including GaO_{X3} as a main component and the region including In_{X2}Zn_{Y2}O_{Z2} or InO_{X1} as a main component is not clearly observed in some cases.

In the case where one or more of aluminum, yttrium, copper, vanadium, beryllium, boron, silicon, titanium, iron, nickel, germanium, zirconium, molybdenum, lanthanum, cerium, neodymium, hafnium, tantalum, tungsten, magnesium, and the like are contained instead of gallium in a CAC-OS, nanoparticle regions including the selected metal element(s) as a main component(s) are observed in part of the CAC-OS and nanoparticle regions including In as a main component are observed in part thereof, and these nanoparticle regions are randomly dispersed to form a mosaic pattern in the CAC-OS.

The CAC-OS can be formed by a sputtering method under conditions where intentional substrate heating is not performed, for example. In the case of forming the CAC-OS by a sputtering method, one or more selected from an inert gas (typically, argon), an oxygen gas, and a nitrogen gas may be used as a deposition gas. The ratio of the flow rate of an oxygen gas to the total flow rate of the deposition gas at the time of deposition is preferably as low as possible, and for example, the flow ratio of an oxygen gas is preferably higher than or equal to 0% and lower than 30%, further preferably higher than or equal to 0% and lower than or equal to 10%.

The CAC-OS is characterized in that no clear peak is observed in measurement using θ/2θ scan by an out-of-plane method, which is an X-ray diffraction (XRD) measurement method. That is, X-ray diffraction shows no alignment in the a-b plane direction and the c-axis direction in a measured region.

In an electron diffraction pattern of the CAC-OS which is obtained by irradiation with an electron beam with a probe diameter of 1 nm (also referred to as a nanometer-sized electron beam), a ring-like region with high luminance and a plurality of bright spots in the ring-like region are observed. Therefore, the electron diffraction pattern indicates that the crystal structure of the CAC-OS includes a nanocrystal (nc) structure with no alignment in plan-view and cross-sectional directions.

For example, an energy dispersive X-ray spectroscopy (EDX) mapping image confirms that an In-Ga-Zn oxide with the CAC composition has a structure in which a region including GaO_{X3} as a main component and a region including In_{X2}Zn_{Y2}O_{Z2} or InO_{X1} as a main component are unevenly distributed and mixed.

The CAC-OS has a structure different from that of an IGZO compound in which metal elements are evenly distributed, and has characteristics different from those of the IGZO compound. That is, in the CAC-OS, regions including GaO_{X3} or the like as a main component and regions including In_{X2}Zn_{Y2}O_{Z2} or InO_{X1} as a main component are separated to form a mosaic pattern.

The conductivity of a region including In_{X2}Zn_{Y2}O_{Z2} or InO_{X1} as a main component is higher than that of a region including GaO_{X3} or the like as a main component. In other words, when carriers flow through regions including In_{X2}Zn_{Y2}O_{Z2} or InO_{X1} as a main component, the conductivity of an oxide semiconductor is generated. Accordingly, when regions including In_{X2}Zn_{Y2}O_{Z2} or InO_{X1} as a main component are distributed in an oxide semiconductor like a cloud, high field-effect mobility (μ) can be achieved.

In contrast, the insulating property of a region including GaO_{X3} or the like as a main component is higher than that of a region including In_{X2}Zn_{Y2}O_{Z2} or InO_{X1} as a main component. In other words, when regions including GaO_{X3} or the like as a main component are distributed in an oxide semiconductor, leakage current can be suppressed and favorable switching operation can be achieved.

Accordingly, when a CAC-OS is used for a semiconductor element, the insulating property derived from GaO_{X3} or the like and the conductivity derived from In_{X2}Zn_{Y2}O_{Z2} or InO_{X1} complement each other, whereby high on-state current (Iₒₙ) and high field-effect mobility (μ) can be achieved.

A semiconductor element including a CAC-OS has high reliability. Thus, the CAC-OS is suitably used in a variety of semiconductor devices typified by a display.

This embodiment can be combined with any of the other embodiments in this specification as appropriate.

### Embodiment 8

In this embodiment, a touch sensor unit that can be provided in an electronic device will be described as an example of an input interface.

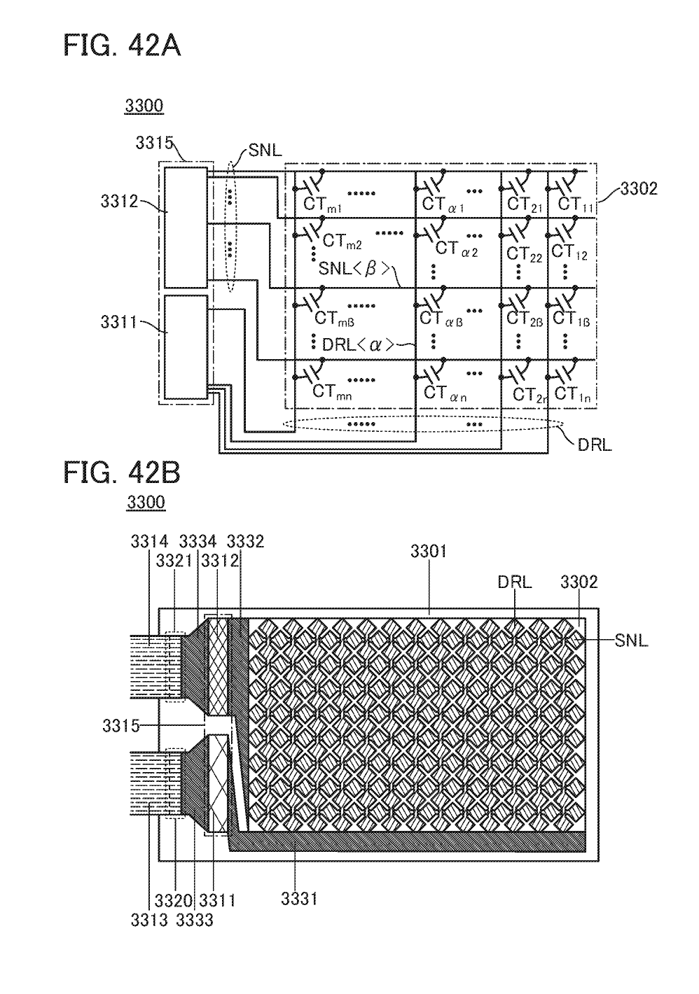

FIG. 42A illustrates a circuit configuration example of a touch sensor unit that can be provided in the hybrid display device or the display device described in another embodiment. A touch sensor unit 3300 includes a sensor array 3302, a touch sensor (TS) driver IC 3311, and a sensing circuit 3312. In FIG. 42A, the TS driver IC 3311 and the sensing circuit 3312 are collectively illustrated as the peripheral circuit 3315.

Here, the touch sensor unit 3300 is a mutual capacitive touch sensor unit as an example. The sensor array 3302 includes m wirings DRL (here, m is an integer larger than 1) and n wirings SNL (here, n is an integer larger than 1). The wiring DRL is a driving line, and the wiring SNL is a sensing line. Here, the α-th wiring DRL is referred to as a wiring DRL<α>, and the β-th wiring SNL is referred to as a wiring SNL<β>. A capacitor CT_{αβ} refers to a capacitor formed between the wiring DRL<α> and the wiring SNL<β>.

The m wirings DRL are electrically connected to the TS driver IC 3311. The TS driver IC 3311 has a function of driving the wirings DRL. The n wirings SNL are electrically connected to the sensing circuit 3312. The sensing circuit 3312 has a function of sensing signals of the wirings SNL. A signal of the wiring SNL<β> at the time when the wiring DRL<α> is driven by the TS driver IC 3311 has information about the change amount of capacitance of the capacitor CT_{αβ}. By analyzing signals of n wirings SNL, information on the presence or absence of touch, the touch position, and the like can be obtained.

FIG. 42B is a top view illustrating an example of a schematic view of the touch sensor unit 3300. The touch sensor unit 3300 in FIG. 42B includes the sensor array 3302 over a base 3301, a TS driver IC 3311, and the sensing circuit 3312. In FIG. 42B, the TS driver IC 3311 and the sensing circuit 3312 are collectively illustrated as the peripheral circuit 3315 as in FIG. 42A.

The sensor array 3302 is formed over the base 3301. The TS driver IC 3311 and the sensing circuit 3312 are mounted as components of an IC chip or the like, over the base 3301, using an anisotropic conductive adhesive or an anisotropic conductive film by a COG method. The touch sensor unit 3300 is electrically connected to an FPC 3313 and an FPC 3314 as units for inputting and outputting a signal or the like from the outside.

In addition, wirings 3331 to 3334 are formed over the base 3301 so that the circuits are electrically connected to each other. In the touch sensor unit 3300, the TS driver IC3311 is electrically connected to the sensor array 3302 through the wiring 3331, and the TS driver IC 3311 is electrically connected to the FPC 3313 through the wiring 3333. The sensing circuit 3312 is electrically connected to the sensor array 3302 through the wiring 3332, and the TS driver IC 3311 is electrically connected to the FPC 3314 through the wiring 3334.

A connection portion 3320 between the wiring 3333 and the FPC 3313 has an anisotropic conductive adhesive or the like, whereby electrical conduction between the FPC 3313 and the wiring 3333 can be obtained. Also, a connection portion 3321 between the wiring 3334 and the FPC 3314 has an anisotropic conductive adhesive or the like, whereby electrical conduction between the FPC 3314 and the wiring 3334 can be obtained.

This embodiment can be combined with any of the other embodiments in this specification as appropriate.

(Notes on the Description in this Specification and the Like)

The following are notes on the structures in the above embodiments.

### Notes on One Embodiment of the Present Invention Described in Embodiments

One embodiment of the present invention can be constituted by appropriately combining the structure described in an embodiment with any of the structures described in the other embodiments. In addition, in the case where a plurality of structure examples are described in one embodiment, some of the structure examples can be combined as appropriate.

Note that what is described (or part thereof) in an embodiment can be applied to, combined with, or replaced with another content in the same embodiment and/or what is described (or part thereof) in another embodiment or other embodiments.

Note that in each embodiment, a content described in the embodiment is a content described with reference to a variety of diagrams or a content described with text disclosed in this specification.

Note that by combining a diagram (or part thereof) described in one embodiment with another part of the diagram, a different diagram (or part thereof) described in the embodiment, and/or a diagram (or part thereof) described in another embodiment or other embodiments, much more diagrams can be formed.

<Notes on Ordinal Numbers>

In this specification and the like, ordinal numbers such as first, second, and third are used in order to avoid confusion among components. Thus, the terms do not limit the number or order of components. In the present specification and the like, a “first” component in one embodiment can be referred to as a “second” component in other embodiments or claims. Furthermore, in the present specification and the like, for example, a “first” component in one embodiment can be omitted in other embodiments or claims.

<Notes on the Description for Drawings>

However, the embodiments can be implemented with various modes. It will be readily appreciated by those skilled in the art that modes and details can be changed in various ways without departing from the spirit and scope of the present invention. Thus, the present invention should not be interpreted as being limited to the description of the embodiments. Note that in the structures of the embodiments, the same portions or portions having similar functions are denoted by the same reference numerals in different drawings, and the description of such portions is not repeated.

In this specification and the like, the terms for explaining arrangement, such as “over” and “under”. are used for convenience to describe the positional relation between components with reference to drawings. Furthermore, the positional relation between components is changed as appropriate in accordance with a direction in which the components are described. Therefore, the terms for explaining arrangement are not limited to those used in this specification and may be changed to other terms as appropriate depending on the situation.

The term “over” or “under” does not necessarily mean that a component is placed directly over or directly under and directly in contact with another component. For example, the expression “electrode B over insulating layer A” does not necessarily mean that the electrode B is on and in direct contact with the insulating layer A and can mean the case where another component is provided between the insulating layer A and the electrode B.

In drawings, the size, the layer thickness, or the region is determined arbitrarily for description convenience. Therefore, the size, the layer thickness, or the region is not limited to the illustrated scale. Note that the drawings are schematically shown for clarity, and embodiments of the present invention are not limited to shapes or values shown in the drawings. For example, the following can be included: variation in signal, voltage, or current due to noise or difference in timing.

In drawings such as a perspective view, some components might not be illustrated for clarity of the drawings.

In the drawings, the same components, components having similar functions, components formed of the same material, or components formed at the same time are denoted by the same reference numerals in some cases, and the description thereof is not repeated in some cases.

<Notes on Expressions that can be Rephrased>

In this specification or the like, the terms “one of a source and a drain” (or a first electrode or a first terminal) and “the other of the source and the drain” (or a second electrode or a second terminal) are used to describe the connection relation of a transistor. This is because a source and a drain of a transistor are interchangeable depending on the structure, operation conditions, or the like of the transistor. Note that the source or the drain of the transistor can also be referred to as a source (or drain) terminal, a source (or drain) electrode, or the like as appropriate depending on the situation. In this specification and the like, two terminals except a gate are sometimes referred to as a first terminal and a second terminal or as a third terminal and a fourth terminal. In this specification and the like, in the case where a transistor has two or more gates (such a structure is referred to as a dual-gate structure in some cases), these gates are referred to as a first gate and a second gate or a front gate and a back gate in some cases. In particular, the term “front gate” can be replaced with a simple term “gate”. The term “back gate” can be replaced with a simple term “gate”. Note that a “bottom gate” is a terminal which is formed before a channel formation region in manufacture of a transistor, and a “top gate” is a terminal which is formed after a channel formation region in manufacture of a transistor.

A transistor is an element having three terminals: a gate, a source, and a drain. A gate is a terminal which functions as a control terminal for controlling the conduction state of a transistor. Functions of input/output terminals of the transistor depend on the type and the levels of potentials applied to the terminals, and one of the two terminals serves as a source and the other serves as a drain. Therefore, the terms “source” and “drain” can be switched in this specification and the like. In this specification and the like, two terminals except a gate are sometimes referred to as a first terminal and a second terminal or as a third terminal and a fourth terminal.

In addition, in this specification and the like, the term such as an “electrode” or a “wiring” does not limit a function of the component. For example, an “electrode” is used as part of a “wiring” in some cases, and vice versa. Further, the term “electrode” or “wiring” can also mean a combination of a plurality of “electrodes” and “wirings” formed in an integrated manner.

In this specification and the like, “voltage” and “potential” can be replaced with each other. The term “voltage” refers to a potential difference from a reference potential. When the reference potential is a ground potential, for example, “voltage” can be replaced with “potential”. The ground potential does not necessarily mean 0 V. Potentials are relative values, and the potential applied to a wiring or the like is changed depending on the reference potential, in some cases.

In this specification and the like, the terms “film” and “layer” can be interchanged with each other depending on the case or circumstances. For example, the term “conductive layer” can be changed into the term “conductive film” in some cases. Also, the term “insulating film” can be changed into the term “insulating layer” in some cases. Moreover, the term “insulating film” can be changed into the term “insulating layer” in some cases, or can be replaced with a word not including the term “film” or “layer” depending on the case or circumstances. For example, the term “conductive layer” or “conductive film” can be changed into the term “conductor” in some cases. Furthermore, for example, the term “insulating layer” or “insulating film” can be changed into the term “insulator” in some cases.

In this specification and the like, the terms “wiring,” “signal line,” “power supply line,” and the like can be interchanged with each other depending on circumstances or conditions. For example, the term “wiring” can be changed into the term such as “signal line” or “power source line” in some cases. The term such as “signal line” or “power source line” can be changed into the term “wiring” in some cases. The term such as “power source line” can be changed into the term such as “signal line” in some cases. The term such as “signal line” can be changed into the term such as “power source line” in some cases. The term “potential” that is applied to a wiring can be changed into the term “signal” or the like depending on circumstances or conditions. Inversely, the term “signal” or the like can be changed into the term “potential” in some cases.

### Notes on Definitions of Terms

The following are definitions of the terms mentioned in the above embodiments.

<<Impurity in Semiconductor>>

Note that an impurity in a semiconductor refers to, for example, elements other than the main components of a semiconductor layer. For example, an element with a concentration lower than 0.1 atomic % is an impurity. When an impurity is contained, the density of states (DOS) may be formed in a semiconductor, the carrier mobility may be decreased, or the crystallinity may be decreased. In the case where the semiconductor is an oxide semiconductor, examples of an impurity which changes characteristics of the semiconductor include Group 1 elements, Group 2 elements, Group 13 elements, Group 14 elements, Group 15 elements, and transition metals other than the main components of the semiconductor; specifically, there are hydrogen (included in water), lithium, sodium, silicon, boron, phosphorus, carbon, and nitrogen, for example. When the semiconductor is an oxide semiconductor, oxygen vacancies may be formed by entry of impurities such as hydrogen, for example. Furthermore, when the semiconductor layer is silicon, examples of an impurity which changes the characteristics of the semiconductor include oxygen, Group 1 elements except hydrogen, Group 2 elements, Group 13 elements, and Group 15 elements.

<<Transistor>>

In this specification, a transistor is an element having at least three terminals of a gate, a drain, and a source. The transistor has a channel formation region between the drain (a drain terminal, a drain region, or a drain electrode) and the source (a source terminal, a source region, or a source electrode), and current can flow between the source and the drain through the channel formation region. Note that in this specification and the like, a channel formation region refers to a region through which current flows by application of a voltage between the gate and the source.

Furthermore, functions of a source and a drain might be switched when a transistor of opposite polarity is employed or a direction of current flow is changed in circuit operation, for example. Therefore, the terms “source” and “drain” can be switched in this specification and the like.

<<Switch>>

In this specification and the like, a switch is conducting (on state) or not conducting (off state) to determine whether current flows therethrough or not. Alternatively, a switch has a function of selecting and changing a current path.

Examples of a switch are an electrical switch, a mechanical switch, and the like. That is, any element can be used as a switch as long as it can control current, without limitation to a certain element.

Examples of the electrical switch are a transistor (e.g., a bipolar transistor or a MOS transistor), a diode (e.g., a PN diode, a PIN diode, a Schottky diode, a metal-insulator-metal (MIM) diode, a metal-insulator-semiconductor (MIS) diode, or a diode-connected transistor), and a logic circuit in which such elements are combined.

In the case of using a transistor as a switch, an “on state” of the transistor refers to a state in which a source electrode and a drain electrode of the transistor are electrically short-circuited. Furthermore, an “off state” of the transistor refers to a state in which the source electrode and the drain electrode of the transistor are electrically cut off. In the case where a transistor operates just as a switch, the polarity (conductivity type) of the transistor is not particularly limited to a certain type.

An example of a mechanical switch is a switch formed using a micro electro mechanical systems (MEMS) technology, such as a digital micromirror device (DMD). Such a switch includes an electrode which can be moved mechanically, and operates by controlling conduction and non-conduction in accordance with movement of the electrode.

<<Connection>>

In this specification and the like, when it is described that X and Y are connected, the case where X and Y are electrically connected, the case where X and Y are functionally connected, and the case where X and Y are directly connected are included therein. Accordingly, another element may be interposed between elements having a connection relation shown in drawings and texts, without limiting to a predetermined connection relation, for example, the connection relation shown in the drawings and the texts.

Here, X, Y, and the like each denote an object (e.g., a device, an element, a circuit, a wiring, an electrode, a terminal, a conductive film, a layer, or the like).

For example, in the case where X and Y are electrically connected, one or more elements that enable an electrical connection between X and Y (e.g., a switch, a transistor, a capacitor, an inductor, a resistor, a diode, a display element, a light-emitting element, or a load) can be connected between X and Y. Note that the switch is controlled to be turned on or off. That is, a switch is conducting or not conducting (is turned on or off) to determine whether current flows therethrough.

For example, in the case where X and Y are functionally connected, one or more circuits that enable functional connection between X and Y (e.g., a logic circuit such as an inverter, a NAND circuit, or a NOR circuit; a signal converter circuit such as a DA converter circuit, an AD converter circuit, or a gamma correction circuit: a potential level converter circuit such as a power source circuit (e.g., a step-up converter or a step-down converter) or a level shifter circuit for changing the potential level of a signal; a voltage source; a current source; a switching circuit: an amplifier circuit such as a circuit that can increase signal amplitude, the amount of current, or the like, an operational amplifier, a differential amplifier circuit, a source follower circuit, or a buffer circuit; a signal generation circuit; a memory circuit; and/or a control circuit) can be connected between X and Y. For example, even when another circuit is interposed between X and Y, X and Y are functionally connected if a signal output from X is transmitted to Y.

Note that when it is explicitly described that X and Y are connected, the case where X and Y are electrically connected (i.e., the case where X and Y are connected with another element or another circuit provided therebetween), the case where X and Y are functionally connected (i.e., the case where X and Y are functionally connected with another circuit provided therebetween), and the case where X and Y are directly connected (i.e., the case where X and Y are connected without another element or another circuit provided therebetween) are included therein. That is, the explicit expression “X and Y are electrically connected” is the same as the explicit simple expression “X and Y are connected”.

For example, any of the following expressions can be used for the case where a source (or a first terminal or the like) of a transistor is electrically connected to X through (or not through) Z1 and a drain (or a second terminal or the like) of the transistor is electrically connected to Y through (or not through) Z2, or the case where a source (or a first terminal or the like) of a transistor is directly connected to one part of Z1 and another part of Z1 is directly connected to X while a drain (or a second terminal or the like) of the transistor is directly connected to one part of Z2 and another part of Z2 is directly connected to Y.

The expressions include, for example. “X, Y, a source (or a first terminal or the like) of a transistor, and a drain (or a second terminal or the like) of the transistor are electrically connected to each other, and X, the source (or the first terminal or the like) of the transistor, the drain (or the second terminal or the like) of the transistor, and Y are electrically connected to each other in this order”, “a source (or a first terminal or the like) of a transistor is electrically connected to IX a drain (or a second terminal or the like) of the transistor is electrically connected to Y, and X, the source (or the first terminal or the like) of the transistor, the drain (or the second terminal or the like) of the transistor, and Y are electrically connected to each other in this order”, and “X is electrically connected to Y through a source (or a first terminal or the like) and a drain (or a second terminal or the like) of a transistor, and X, the source (or the first terminal or the like) of the transistor, the drain (or the second terminal or the like) of the transistor, and Y are provided to be connected in this order”. When the connection order in a circuit configuration is defined by an expression similar to the above examples, a source (or a first terminal or the like) and a drain (or a second terminal or the like) of a transistor can be distinguished from each other to specify the technical scope. Note that these expressions are examples and there is no limitation on the expressions. Here, X, Y, Z1. and Z2 each denote an object (e.g., a device, an element, a circuit. a wiring, an electrode, a terminal, a conductive film. and a layer).

Even when independent components are electrically connected to each other in a circuit diagram, one component has functions of a plurality of components in some cases. For example, when part of a wiring also functions as an electrode, one conductive film functions as the wiring and the electrode. Thus, “electrical connection” in this specification includes in its category such a case where one conductive film has functions of a plurality of components.

<<Parallel and Perpendicular>>

In this specification, the term “parallel” indicates that the angle formed between two straight lines is greater than or equal to −10° and less than or equal to 10°, and accordingly also includes the case where the angle is greater than or equal to −5° and less than or equal to 5°. In addition, the term “substantially parallel” indicates that the angle formed between two straight lines is greater than or equal to −30° and less than or equal to 30°. The term “perpendicular” indicates that the angle formed between two straight lines is greater than or equal to 80° and less than or equal to 100°. Thus, the case where the angle is greater than or equal to 85° and less than or equal to 95° is also included. In addition, the term “substantially perpendicular” indicates that the angle formed between two straight lines is greater than or equal to 60° and less than or equal to 120°.

### REFERENCE NUMERALS

SW1: switch, SW2: switch, SW3: switch, SW4: switch, SW5: switch, LDP: local decoding processing, PRC11: block division, PRC12: DCT/DST/quantization, PRC13: inverse DCT/inverse DST/inverse quantization, PRC 14: intra-picture prediction, PRC15: in-loop filter, PRC16: motion detection, PRC17: motion-compensated prediction, PRC21: entropy decoding, PRC22: inverse DCT/inverse DST/inverse quantization, PRC23: intra-picture prediction, PRC24: motion-compensated prediction, PRC25: in-loop filter, V0: potential, V00: potential, VDD: potential, GND: ground potential, Vref: reference potential, CK: clock signal, CTL1: control signal, CTL2: control signal, CTL3: control signal, DIN: external input signal, DIN[1]: external input signal, DIN[2]: external input signal, DIN[3]: external input signal, DIN[4]: external input signal, DIN[5]: external input signal, DIN[k]: external input signal, DIN[n−1]: external input signal, DIN[n]: external input signal, DOUT[1]: external output signal, DOUT[2]: external output signal, DOUT[3]: external output signal, DOUT[4]: external output signal, DOUT[5]: external output signal, DOUT[k]: external output signal, DOUT[n−1]: external output signal, DOUT[n]: external output signal, S[1]: signal, S[2]: signal, S[k]: signal, S[n−1]: signal, S[n]: signal, S[i]: signal, S[j]: signal, Aᵢₙ₁: internal input terminal, Aᵢₙ₂: internal input terminal, Aₒᵤₜ: internal output terminal, Bᵢₙ: internal input terminal, Bₒᵤₜ: internal output terminal, Cᵢₙ₁: internal input terminal, Cᵢₙ₂: internal input terminal, Cₒᵤₜ₁: internal output terminal, Cₒᵤₜ₂: internal output terminal, D: input terminal, Q: output terminal, RESET: wiring, BG5: wiring, BG6: wiring, BG7: wiring, BG8: wiring, WR: wiring, WR[1]: wiring, WR[m]: wiring, WR[i]: wiring, WW: wiring, WW[1]: wiring, WW[m]: wiring, WW[i]: wiring, BL: wiring, BL[1]: wiring, BL[n]: wiring, BL[j]: wiring, D[1, 1]: wiring, D[1, s]: wiring, D[n, l]: wiring, D[n, s]: wiring, D[j, 1]: wiring, D[j, s]: wiring, D[1]: wiring, D[2]: wiring, D[3]: wiring, D[k]: wiring, D[s]: wiring, WA: wiring, RA: wiring, WE: wiring, RE: wiring, CA: wiring, CM: wiring, S[+]: wiring, S[−]: wiring, VH: wiring, VL: wiring, VDD1: wiring, VSS: wiring, VSS1: wiring, Vref[+]: wiring, Vref[−]: wiring, BIAS: wiring, Tr1: transistor, Tr2: transistor, Tr3: transistor, Tr4: transistor, Tr5: transistor, Tr6: transistor, Tr7: transistor, Tr8: transistor, Tr9: transistor, Tr10: transistor, Tr11: transistor, Tr12: transistor, Tr13: transistor, Tr14[1]: transistor, Tr14[2]: transistor, Tr14[3]: transistor, Tr14[4]: transistor, Tr14[5]: transistor, Tr14[6]: transistor, Tr14[7]: transistor, Tr14[k]: transistor, Tr14[s]: transistor, Tr14[2^{s-1}]: transistor, Tr14[2^{s}−1]: transistor, Tr15: transistor, Tr16: transistor, C1: capacitor, C2: capacitor, CW: capacitor, R: resistor, LAC1: AND circuit, LAC2: AND circuit, LAC3: AND circuit, LG: logic circuit, CMP: comparator, CMP[+]: comparator, CMP[−]: comparator, CMC1: current mirror circuit, CMC2: current mirror circuit, FF: flip-flop circuit, SLCT: selector, CP1: charge pump circuit, CP2: charge pump circuit, NA: node, AM: analog memory, RC: reset circuit, WCTL: writing control circuit, INV: inverter, WGT[i, j]: weighting circuit, WGT[j, i]: weighting circuit, NU: neuron circuit, NU[1]: neuron circuit, NU[2]: neuron circuit, NU[3]: neuron circuit, NU[4]: neuron circuit, NU[5]: neuron circuit, NU[k]: neuron circuit, NU[n−1]: neuron circuit, NU[n]: neuron circuit, NU-I: input neuron circuit portion, NU-H: hidden neuron circuit portion, NU-O: output neuron circuit portion, CRCT: circuit, SU: synapse circuit, SU[2, 1]: synapse circuit, SU[k, 1]: synapse circuit, SU[n−1, 1]: synapse circuit, SU[n, 1]: synapse circuit, SU[1, 2]: synapse circuit, SU[k, 2]: synapse circuit, SU[n−1, 2]: synapse circuit, SU[n, 2]: synapse circuit, SU[1, k]: synapse circuit, SU[2, k]: synapse circuit, SU[n−1, k]: synapse circuit, SU[n, k]: synapse circuit, SU[1, n−1]: synapse circuit, SU[2, n−1]: synapse circuit, SU[k, n−1]: synapse circuit, SU[n, n−1]: synapse circuit, SU[1, n]: synapse circuit, SU[2, n]: synapse circuit, SU[k, n]: synapse circuit, SU[n−1, n]: synapse circuit, SU[1, 3]: synapse circuit, SU[2, 3]: synapse circuit, SU[2, 4]: synapse circuit, SU[3, 4]: synapse circuit, SU[3, 5]: synapse circuit, SU[4, 1]: synapse circuit, SU[4, 5]: synapse circuit, SU[5, 1]: synapse circuit, SU[5, 2]: synapse circuit, 1S: step, 2S: step, 3S: step, 4S: step, S1-1: step, S1-2: step, S1-3: step, S1-4: step, S1-5: step, S1-6: step, S1-7: step, S1-8: step, S1-9: step, S2-1: step, S2-2: step, S2-3: step, S3-1: step, S3-2: step, S3-3: step, S3-4: step, S3-5: step, CD1: state, CD2: state, CD3: state, S1: signal line, S2: signal line, S3: signal line, G1: gate line, G2: gate line, G3: gate line, ANO: current supply line, CSCOM: wiring, VCOM1: wiring, VCOM2: wiring, DRL: wiring, SNL: wiring, SWT1: switch, SWT2: switch, M1: transistor, M2: transistor, M3: transistor, C_{SLC}: capacitor, C_{SEL}: capacitor, CT_{αβ}: capacitor, 10: image data, 11: triangle, 12: circle, 20: image data, 30: image data, 31: region, 31[j]: pixel column, 40: image data, 41: region, 41[j]: pixel column, 100: memory cell array, 101: memory cell, 101[1, 1]: memory cell, 101[m, 1]: memory cell, 101[i, j]: memory cell, 101[1, n]: memory cell, 101[m, n]: memory cell, 200: analog processing circuit, 201: rectifier circuit, 201111: rectifier circuit, 201[j]: rectifier circuit, 201[n]: rectifier circuit, 202: comparison circuit, 203: comparison circuit, 300: writing circuit, 301: current supply circuit, 301[1]: current supply circuit, 301 [j]: current supply circuit, 301[n]: current supply circuit, 302: current supply circuit, 400: row driver, 500: semiconductor device, 510: semiconductor device, 800: electronic device, 801: signal input portion, 802: audiovisual output portion, 803: receive portion, 804: I/F, 805: control portion, 806: encoder, 807: decoder, 808: memory device, 809: reproduction portion, 810: remote controller, 820: video display portion, 821: first display region, 822: second display region, 823: region, 824: region, 831: antenna, 832: tuner, 833: STB, 850: external input, 861: image signal, 862: encoded signal, 863: local decoding data, 864: decoded image signal, 871: receiver, 872: receiver, 873: receiver, 899: electronic device, 900: electronic device, 901: electronic device, 1000: semiconductor device, 1564: antenna, 1565: antenna, 1900: pixel, 1900t: transmissive region, 1900s: light-blocking region, 1901: driver circuit portion, 1902: wiring, 1904: wiring, 1906: wiring, 1910: transistor, 1911: transistor, 1912: transistor, 1913: capacitor, 1914: transistor, 1915: capacitor, 1916R: light-emitting region, 1916G: light-emitting region, 1916B: light-emitting region, 1918R: display region, 1918G: display region, 1918B: display region, 1918W: display region, 1930EL: light-emitting element, 1930LC: liquid crystal element, 1932CF: coloring film, 1932BM: light-blocking film, 2000: display device, 2000A: display device, 2000B: display device, 2010: pixel, 2064: source driver IC, 2113: electrode, 2117: insulating layer, 2121: insulating layer, 2131: coloring layer, 2132: light-blocking layer, 2133a: alignment film, 2133b: alignment film, 2135: functional member, 2141: adhesive layer, 2142: adhesive layer, 2170: light-emitting element, 2170r: light-emitting element, 2170g: light-emitting element, 2170b: light-emitting element, 2170w: light-emitting element, 2180: liquid crystal element, 2191: conductive layer, 2192: EL layer, 2193: conductive layer, 2194: insulating layer, 2201: first display element, 2202: second display element, 2203: pixel circuit, 2203a: pixel circuit, 2203b: pixel circuit, 2204: reflected light, 2205: transmitted light, 2211: insulating layer, 2212: insulating layer, 2213: insulating layer, 2214: insulating layer, 2216: insulating layer, 2217: conductive layer, 2218: conductive layer, 2220: insulating layer, 2221a: conductive layer, 2221b: conductive layer, 2222a: conductive layer, 2222b: conductive layer, 2223: conductive layer, 2224: insulating layer, 2225: conductive layer, 2226: conductive layer, 2231: semiconductor layer, 2234: peripheral circuit region, 2235: display region, 2236: pixel circuit, 2237: light, 2238: light, 2242: connection layer, 2243: connector, 2252: connection portion, 2271: transistor, 2272: capacitor, 2273: scan line, 2274: signal line, 2275: common potential line, 2281: transistor, 2282: capacitor, 2283: transistor, 2284: scan line, 2285: signal line, 2286: power supply line, 2291: transmissive region, 2292: light-blocking region, 2301: transistor, 2302: capacitor, 2303: transistor, 2304: connection portion, 2305: transistor, 2306: transistor, 2307: connection portion, 2311: electrode, 2351: substrate, 2361: substrate, 2365: wiring, 2370: touch sensor unit, 2372: FPC, 2374: conductive layer, 2375: insulating layer, 2376a: conductive layer, 2376b: conductive layer, 2377: conductive layer, 2378: insulating layer, 3200a: transistor, 3200b: transistor, 3200c: transistor, 3211: insulating layer, 3212: insulating layer, 3212a: insulating layer, 3212b: insulating layer, 3213: insulating layer, 3215: insulating layer, 3221: conductive layer, 3222a: conductive layer, 3222a_1: conductive layer, 3222a_2: conductive layer, 3222a_3: conductive layer, 3222b: conductive layer, 3222b_1: conductive layer, 3222b_2: conductive layer, 3222b_3: conductive layer, 3223: conductive layer, 3224: insulating layer, 3231: metal oxide layer, 3231_1: metal oxide layer, 3231_2: metal oxide layer, 3231s: source region, 3231i: channel region, 3231d: drain region, 3235: opening, 3236a: opening, 3236b: opening, 3237: opening, 3300: touch sensor unit, 3301: base, 3302: sensor array, 3311: TS driver IC, 3312: sensing circuit, 3313: FPC, 3314: FPC, 3315: peripheral circuit, 3320: connection portion, 3321: connection portion, 3331: wiring, 3332: wiring, 3333: wiring, 3334: wiring

This application is based on Japanese Patent Application Serial No. 2016-238443 filed with Japan Patent Office on Dec. 8, 2016, and Japanese Patent Application Serial No. 2016-238445 filed with Japan Patent Office on Dec. 8, 2016, the entire contents of which are hereby incorporated by reference.

1. An electronic device comprising:
an encoder configured to receive an image data;
a memory device: and
a decoder electrically connected to the encoder through the memory device,
wherein the image data comprises a first frame image and a second frame image,
wherein the encoder is configured to generate a first current and a second current on the basis of a first region of the first frame image and a second region of the second frame image, respectively,
wherein the encoder is configured to generate a differential current between the first current and the second current and obtain a vector quantity between the first region and the second region,
wherein the encoder is configured to perform a motion-compensated prediction processing on the image data with use of the vector quantity and generate a compressed image data,
wherein the memory device is configured to store the compressed image data, and
wherein the decoder is configured to decompress the compressed image data and is electrically connected to a video display portion.

2. The electronic device according to claim 1,
wherein the encoder comprises a memory cell, a first circuit, a second circuit, and a first wiring,
wherein the memory cell is electrically connected to the first wiring,
wherein the first circuit is electrically connected to the first wiring,
wherein the second circuit is electrically connected to the first wiring,
wherein the first circuit is configured to supply the first current based on the first region to the first wiring and to supply the second current based on the second region to the first wiring,
wherein the memory cell is configured to hold a charge corresponding to the first current and to determine the first current flowing from the first wiring to the memory cell as a constant current on the basis of the amount of the charge held, and
wherein the second circuit is configured to generate the differential current between the constant current and the second current.

3. The electronic device according to claim 2,
wherein the memory cell comprises a first transistor, a second transistor, a third transistor, and a capacitor,
wherein one of a source and a drain of the first transistor is electrically connected to one of a source and a drain of the second transistor and one of a source and a drain of the third transistor,
wherein the other of the source and the drain of the first transistor is electrically connected to a first electrode of the capacitor,
wherein a gate of the first transistor is electrically connected to the other of the source and the drain of the third transistor and a second electrode of the capacitor, and
wherein the other of the source and the drain of the second transistor is electrically connected to the first wiring.

4. The electronic device according to claim 3, wherein at least one of the first to third transistors comprises an oxide semiconductor in a channel formation region.

5. The electronic device according to claim 3,
wherein the second circuit comprises a fourth transistor, a fifth transistor, and a sixth transistor,
wherein one of a source and a drain of the fourth transistor is electrically connected of one of a source and a drain of the fifth transistor, one of a source and a drain of the sixth transistor, and a gate of the sixth transistor,
wherein the other of the source and the drain of the fourth transistor is electrically connected to the first wiring, and
wherein the other of the source and the drain of the fifth transistor is electrically connected to a gate of the fifth transistor.

6. The electronic device according to claim 5,
wherein the second circuit comprises a seventh transistor, an eighth transistor, a ninth transistor, a tenth transistor, an eleventh transistor, a first comparator, a second comparator, and a first current mirror circuit,
wherein a non-inverting input terminal of the first comparator is electrically connected to the other of the source and the drain of the fifth transistor and one of a source and a drain of the seventh transistor,
wherein an output terminal of the first comparator is electrically connected to a gate of the seventh transistor and a gate of the eighth transistor,
wherein one of a source and a drain of the eighth transistor is electrically connected to an output terminal of the first current mirror circuit and one of a source and a drain of the eleventh transistor,
wherein a non-inverting input terminal of the second comparator is electrically connected to the other of the source and the drain of the sixth transistor and one of a source and a drain of the ninth transistor,
wherein an output terminal of the second comparator is electrically connected to a gate of the ninth transistor and a gate of the tenth transistor,
wherein one of a source and a drain of the tenth transistor is electrically connected to an input terminal of the first current mirror circuit,
wherein the seventh transistor and the eighth transistor are p-channel transistors, and
wherein the ninth transistor, the tenth transistor, and the eleventh transistor are n-channel transistors,

7. The electronic device according to claim 5,
wherein the second circuit comprises a seventh transistor, an eighth transistor, a ninth transistor, a tenth transistor, an eleventh transistor, a first comparator, a second comparator, and a first current mirror circuit,
wherein a non-inverting input terminal of the first comparator is electrically connected to the other of the source and the drain of the fifth transistor and one of a source and a drain of the seventh transistor,
wherein an output terminal of the first comparator is electrically connected to a gate of the seventh transistor and a gate of the eighth transistor,
wherein a non-inverting input terminal of the second comparator is electrically connected to the other of the source and the drain of the sixth transistor and one of a source and a drain of the ninth transistor,
wherein an output terminal of the second comparator is electrically connected to a gate of the ninth transistor and a gate of the tenth transistor,
wherein one of a source and a drain of the tenth transistor is electrically connected to an output terminal of the first current mirror circuit and one of a source and a drain of the eleventh transistor,
wherein one of a source and a drain of the eighth transistor is electrically connected to an input terminal of the first current mirror circuit,
wherein the seventh transistor and the eighth transistor are p-channel transistors, and
wherein the ninth transistor, the tenth transistor, and the eleventh transistor are n-channel transistors.

8. The electronic device according to claim 2,
wherein the first current comprises a twelfth transistor, a second current mirror circuit, and a second wiring,
wherein an input terminal of the second current mirror circuit is electrically connected to one of a source and a drain of the twelfth transistor,
wherein an output terminal of the second current mirror circuit is electrically connected to the first wiring,
wherein a gate of the twelfth transistor is electrically connected to the second wiring, and
wherein a potential based on the first region or the second region is inputted to the second wiring.

9. The electronic device according to claim 1, comprising the video display portion.

10. A system, the system comprising the electronic device according to claim 1, comprising:
an antenna;
a tuner; and
a set top box,
wherein the antenna is electrically connected to the tuner,
wherein the tuner is electrically connected to the set top box,
wherein the set top box is electrically connected to the electronic device,
wherein the antenna is configured to receive an airwave and convert the airwave into an electrical signal,
wherein the tuner is configured to demodulate a broadcast signal included in the electrical signal, and
wherein the set top box is configured to decode and decompress the image data included in the broadcast signal and to transmit the image data to the electronic device.

11. An electronic device comprising:
an encoder configured to receive an image data;
a memory device: and
a decoder electrically connected to the encoder through the memory device,
wherein the image data comprises a first frame image and a second frame image,
wherein the encoder comprises a semiconductor device where a neural network is formed,
wherein the neural network is configured to determine whether a first region of the first frame image and a second region of the second frame image match, are similar to, or mismatch each other,
wherein the encoder is configured to obtain a vector quantity between the first region and the second region,
wherein the encoder is configured to perform a motion-compensated prediction processing on the image data with use of the vector quantity and generate a compressed image data;
wherein the memory device is configured to store the compressed image data, and
wherein the decoder is configured to decompress the compressed image data and is electrically connected to a video display portion.

12. The electronic device according to claim 11,
wherein the semiconductor device comprises a first circuit, a second circuit, a third circuit, and a fourth circuit,
wherein the first circuit comprises a first charge pump circuit, a second charge pump circuit, an analog memory, and a logic circuit,
wherein each of the first charge pump circuit and the second charge pump circuit comprises a first transistor,
wherein the first transistor comprises an oxide semiconductor in a channel formation region,
wherein the logic circuit comprises a first input terminal, a second input terminal, a first output terminal, and a second output terminal,
wherein the second circuit comprises a third input terminal and a third output terminal,
wherein the second circuit is configured to output one of a potential corresponding to a current inputted to the third input terminal and a first input potential to the third output terminal,
wherein the third circuit comprises a fourth input terminal and a fourth output terminal,
wherein the third circuit is configured to output one of a potential corresponding to a current inputted to the fourth input terminal and a second input potential to the fourth output terminal,
wherein the fourth circuit comprises a fifth input terminal, a sixth input terminal, and a fifth output terminal,
wherein the fourth circuit is configured to output a current corresponding to a potential inputted to the fifth input terminal and a current corresponding to a potential inputted to the sixth input terminal to the fifth output terminal,
wherein the first input terminal is electrically connected to the fifth input terminal and the third output terminal,
wherein the second input terminal is electrically connected to the fourth output terminal,
wherein the first output terminal is electrically connected to the first charge pump circuit,
wherein the second output terminal is electrically connected to the second charge pump circuit,
wherein the analog memory is electrically connected to the first charge pump circuit, the second charge pump circuit, and the sixth input terminal, and
wherein the fifth output terminal is electrically connected to the fourth input terminal.

13. The electronic device according to claim 12,
wherein the fourth circuit comprises a second transistor, a third transistor, a fourth transistor, a fifth transistor, and an inverter,
wherein a first terminal of the second transistor is electrically connected to a first terminal of the third transistor,
wherein a first terminal of the fourth transistor is electrically connected to a first terminal of the fifth transistor,
wherein a gate of the fifth transistor is electrically connected to an output terminal of the inverter,
wherein a gate of the third transistor is electrically connected to an input terminal of the inverter and the fifth input terminal, and
wherein a gate of the fourth transistor is electrically connected to the sixth input terminal.

14. The electronic device according to claim 12, further comprising a fifth circuit,
wherein the fifth circuit comprises a seventh input terminal, an eighth input terminal, and a sixth output terminal,
wherein the fifth circuit is configured to output a current corresponding to a potential inputted to the seventh input terminal and a current corresponding to a potential inputted to the eighth input terminal to the sixth output terminal,
wherein the seventh input terminal is electrically connected to the second input terminal and the fourth output terminal,
wherein the eighth input terminal is electrically connected to the sixth input terminal and the analog memory, and
wherein the sixth output terminal is electrically connected to the third input terminal.

15. The electronic device according to claim 12,
wherein the second circuit comprises a resistor, a comparator, a flip-flop circuit, and a selector,
wherein an output terminal of the flip-flop circuit is electrically connected to a first terminal of the selector,
wherein a non-inverting input terminal of the comparator is electrically connected to the resistor and the third input terminal,
wherein an output terminal of the comparator is electrically connected to a second terminal of the selector, and
wherein an output terminal of the selector is electrically connected to the third output terminal.

16. The electronic device according to claim 12, wherein the first transistor comprises a back gate.

17. The electronic device according to claim 12, further comprising a sixth transistor,
wherein a first terminal of the sixth transistor is electrically connected to the analog memory.

18. The electronic device according to claim 12, further comprising a video display portion.

19. The electronic device according to claim 18,
wherein the video display portion comprises a first display region and a second display region,
wherein the first display region comprises a reflective element, and
wherein the second display region comprises a light-emitting element.

20. The electronic device according to claim 11, comprising the video display portion.

21. A system, the system comprising the electronic device according to claim 11, comprising:
an antenna;
a tuner; and
a set top box,
wherein the antenna is electrically connected to the tuner,
wherein the tuner is electrically connected to the set top box,
wherein the set top box is electrically connected to the electronic device,
wherein the antenna is configured to receive an airwave and convert the airwave into an electrical signal,
wherein the tuner is configured to demodulate a broadcast signal included in the electrical signal, and
wherein the set top box is configured to decode and decompress the image data included in the broadcast signal and to transmit the image data to the electronic device.
